(19) United States
(12) Patent Application Publication
(10) Pub. No.: US 2024/0201341 A1
(43) Pub. Date: Jun. 20, 2024

(54) AMPLITUDE SHIFT KEYING LIDAR

(71) Applicant: OSRAM GmbH, Muenchen (DE)

(72) Inventors: Bernhard SIESSEGGER, Unterschleissheim (DE); Gerhard MAIERBACHER, Munich (DE)

(21) Appl. No.: 18/556,368

(22) PCT Filed: Mar. 28, 2022
(86) PCT No.: PCT/EP2022/058127

§ 371 Date: Oct. 20, 2023

(30) Foreign Application Priority Data
Apr. 23, 2021 (DE) 10 2021 110 495.5

(51) Int. Cl. G01S 7/484; G01S 7/481

(52) U.S. Cl. CPC G01S 7/484; G01S 7/4815

(57) ABSTRACT

A LIDAR module includes: a light emitting device configured to emit a light signal in accordance with a combination of a plurality of partial signals; and one or more processors configured to: encode a sequence of symbols, wherein each symbol of the sequence of symbols is associated with a respective combination of the plurality of partial signals, and control the light emitting device to combine the plurality of partial signals as a function of the encoded sequence of symbols to emit the light signal.

### RELATED APPLICATION (S)

This application is a US National Stage Application of International Application PCT/EP2022/058127, filed on 28 Mar. 2022, and claims priority under 35 U.S.C. § 119(a) and 35 U.S.C. § 365(b) from German Application 10 2021 110 495.5, filed on 23 Apr. 2021, the contents of which are incorporated herein by reference in their entirety.

### FIELD

Various aspects of the present disclosure are related to a LIDAR (“Light Detection and Ranging”) system and methods thereof (e.g., a method of emitting light in a LIDAR system).

### BACKGROUND AND SUMMARY

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system typically uses the time-of-flight (ToF) of the emitted light to measure the distance to an object. A LIDAR system may be configured as a pulsed LIDAR system, in which light pulses with adjustable amplitude and/or adjustable pulse shape are emitted to enable more sophisticated functionalities, as described for example in WO 2020 182 591 A1.

Various aspects of the present description are related to an approach for modulating light (e.g., a light signal) emitted from a LIDAR module. The modulation strategy described herein may provide a high degree of freedom and a high degree of control over the properties of the emitted light, to enable a simple and cost-efficient implementation of advanced functionalities (e.g., data transmission, etc.) in a LIDAR module. According to various aspects, the modulation may be carried out as a controlled combination of a plurality of partial signals (e.g., of partial electrical signals and/or of partial light signals) that together contribute to providing the emitted light signal. Controlling how the partial signals combine with one another may enable controlling the properties of the emitted light signal. In various aspects, the combination of the partial signal may be carried out as a function of a sequence of symbols to be encoded in the emitted light signal. The combination of the partial signals as a function of a sequence of symbols may enable transmitting information with the emitted light signal, thus providing an optical communication channel for the LIDAR module.

The term “LIDAR module” may be used herein to describe a device configured for LIDAR applications. A “LIDAR module” as used herein may be configured to carry out monitoring of a scene based on a LIDAR approach (e.g., based on the emission and detection of light, for example laser light). A “module” may be understood as an entity including a plurality of parts (e.g., a plurality of components) that together define the function of the module. Illustratively, a module may be understood as an entity configured to carry out a complex function that requires the contribution of a plurality of parts interacting together. A “LIDAR module” may also be referred to herein as “LIDAR system”, “LIDAR sensor”, “LIDAR product”, or simply “system” or “product”.

A “component” of a LIDAR module (also referred to herein as “element” of a LIDAR module) may be understood as a single part that individually contributes to the operation of a larger entity (e.g., of a module). A component may be understood as a single part configured to carry out a simple (e.g., general purpose) function, e.g. with a limited scope. A component may itself include a plurality of components (sub-elements, or sub-components) that provide the simple function of the component. A component including a plurality of sub-components may be understood as a sub-module (also referred to herein as sub-system), e.g. configured to implement a more complex functionality compared to an individual component (via the interaction of the sub-components). As an example, a component may be an array of laser diodes, and the individual laser diodes may be the sub-components of the array. As another example, a laser diode itself may be understood as a component, and the individual parts forming the laser diode (e.g., a semiconductor substrate, the electrical connections, etc.) may be understood as sub-components of the laser diode. In the following, references to a sub-system or sub-module may be understood to apply to a component including a plurality of sub-components.

The term “LIDAR light” may be used herein to describe light emitted by a LIDAR module (e.g., by a light emitting device of the LIDAR module). “LIDAR light” may be understood as the light used for illuminating a field of view of the LIDAR module (and, in some aspects, for implementing additional functionalities, such as data communication). “LIDAR light” may include, as an example, non-coherent light, e.g. emitted by a light emitting diode (e.g., by an array of light emitting diodes). In various aspects, “LIDAR light” may include laser light, e.g. emitted by a laser diode (e.g., by an array of laser diodes). “LIDAR light” may also be referred to herein as “LIDAR signal”. The term “LIDAR pulse” may be used herein to describe a light pulse (e.g., a laser pulse) in the emitted LIDAR light.

The term “modulation” may be used herein to describe an intentional modification of a physical quantity over time (e.g., of a charging voltage, a discharging current, an emitted light intensity, and the like) to provide a modulated signal. A modulated signal may differ with respect to a non-modulated signal in that at least one property of the modulated signal varies over time, e.g. a signal level, a time between pulses, a phase, etc. Illustratively, the term “modulation” may be used herein to describe a controlled variation of at least one property of a signal (e.g., an emitted light signal) over time.

The expression “signal level” may be used herein to describe a parameter associated with a signal (e.g., with a light signal, a current signal, a voltage signal, etc.) or with a portion of a signal (e.g., with a peak). A “signal level” as used herein may include at least one of a power level (PL), a current level, a voltage level, or an amplitude level (also referred to herein as amplitude).

According to various aspects, different approaches are provided to achieve a modulation. Various aspects are related to an “electrical modulation”, which may describe a modulation carried out at the electrical level, e.g. controlling (modulating) the electrical signals (e.g., a current, a voltage, a power) used to drive a light source. Various aspects are related to an “optical modulation”, which may describe a modulation carried out at the optical level, e.g. controlling one or more properties of a light signal by using one or more optical components.

The term “binary-coded modulation” may be used herein to describe a modulation including the encoding of binary symbols (e.g., a logic “0” and a logic “1”) onto a light signal, e.g. onto a light pulse. A “binary-coded modulation” may be carried out as an optical modulation, by modulating the light itself, and/or as an electrical modulation, by modulating an electrical quantity (e.g., a voltage, or a current) that then is used to generate the light (e.g., by means of a laser diode), as described in further detail below.

According to various aspects, the modulation of an emitted light signal (e.g., an adjustment of the amplitude, for example a modulation of laser power) may also properly illuminate the scene to be analyzed (illustratively, the field of view of the LIDAR module). The modulation of the emitted light may ensure that the scene is sufficiently lit, without over-illuminating the scene, an aspect that may be critical, for example, in the context of high-reflectivity objects and the resulting crosstalk between measurements. Avoiding over-illumination may allow preventing a saturation of the receiver of the LIDAR module (e.g., of some of the receiver elements, for example of one or more detector pixels). The saturation could otherwise deteriorate amplitude resolution and, in some cases, receiver dynamics, as it may take some time for a saturated receiver element to return to a normal operating mode. In various aspects, an angle-dependent modulation of the emitted light (e.g., an angle-dependent intensity modulation) may be provided, for example in the case that the LIDAR module includes multiple light sources illuminating different parts of the scene and/or in the case that the LIDAR module includes a scanning system for sequentially illuminating different parts of the scene. The angle-dependent modulation may provide a fine adjustment in the illumination of the scene. An improved illumination of the field of view may thus be provided in the case that the LIDAR module is configured as a FLASH LIDAR module and in the case that the LIDAR module is configured as a scanning LIDAR module.

According to various aspects, the modulation of an emitted light signal may enable communication capabilities in a LIDAR module, e.g. the LIDAR system may be configured to communicate via amplitude modulation. A modulated signal may be used, for example, to convey information. In communication technology such signal may be referred to as a baseband signal. As an example, a modulated signal may include a sequence of symbols over time. Information may be conveyed by choosing a symbol (e.g., from a predefined set of symbols) corresponding to some quantity of data, e.g. a certain number of bits. Generating (or transmitting) a certain number of symbols (each corresponding to a certain number of bits) in a certain amount of time, may be understood as generating (or transmitting) a certain amount of data per time, also referred to as data rate. In various aspects, in the communication scheme provided in the LIDAR module described herein, a symbol (e.g., from a predefined set of symbols) may correspond to a LIDAR pulse (e.g., from a set of possible pulse shapes). An alternative approach for data communication in a vehicle may include a separate system, e.g. a dedicated LiFi or radio communication system, for transmitting data instead of utilizing the LIDAR module. The approach described herein may provide a more compact or a less expensive solution for providing data communication functionalities in a vehicle (e.g., in an autonomous or partially autonomous car).

According to various aspects, the possibility of adjusting the amplitude of the LIDAR signal over time may also include creating pulse sequences (e.g., a sequence comprising one or more light pulses, for example with a time period of inactivity in between the pulses). A pulse sequence may be configured to create a unique pattern that allows LIDAR signals to be distinguished from one another. Illustratively, a pulse sequence may be understood, in some aspects, as a unique signature associated with a LIDAR signal, so that different LIDAR signals including different pulse sequences may be distinguished from one another. For example, a LIDAR signal may be distinguished from the LIDAR signals emitted by other LIDAR systems in close vicinity. As another example, LIDAR signals originating from several LIDAR sensors mounted on a same vehicle (e.g., on the same car) may be distinguished from one another for concurrent operation. As a further example, a signal emitted by a vehicle's own LIDAR sensor may be distinguished from the signal emitted by another LIDAR sensor (e.g., of another vehicle), thus providing alien crosstalk detection and mitigation. A unique pattern may be applied, additionally or alternatively, to individual components, individual sub-components, or even individual pixels of the same LIDAR sensor. The unique patterns of individual components, sub-components, or pixels may allow concurrent operation in case the field of view (and/or field of emission) of the components, sub-components, or pixels have a partial or full overlap. The unique patterns may also allow refining of the detection result of the individual components, sub-components, or pixels.

In the context of LIDAR applications, in particular for use in the automotive field, the aspects of linearity, dynamics, and energy efficiency may play an important role in ensuring a reliable and cost-effective operation of a LIDAR module.

According to various aspects, high linearity between the control signal (illustratively, the set value for the amplitude) and the generated amplitude of the emitted light signal (e.g., of a laser pulse) may be provided. The high linearity may ensure low bit error-rates, in the case of amplitude modulation for communication purposes, and/or control-loop stability. Illustratively, a control loop with non-linear elements may be more difficult to stabilize, for example due to the tendency of such control loops to oscillate and/or to become unstable more easily. High linearity may be typically achieved with sophisticated circuitry and/or calibration, both associated with high cost, thus making such systems expensive (the higher the linearity requirements the more expensive the system). The modulation strategy described herein may provide a cost-effective solution for providing high linearity between a control signal and an emitted light signal of a LIDAR system. High linearity may be understood as the control signal and the emitted light signal having a substantially (e.g., exactly) linear relationship with one another.

According to various aspects, high dynamics of the power stage may be provided, which may enable communication with high data rates, and may provide little amplitude error (e.g., between the set value for the amplitude, e.g. from the amplitude control, and the amplitude of the emitted light). High dynamics of the power stage may allow for short settling times when going from a high amplitude to a low amplitude and vice versa. High dynamics may be understood as the circuit being configured to provide a pulse with a very high amplitude followed by a pulse with a very low amplitude, and vice versa.

According to various aspects, the LIDAR module described herein may provide high energy efficiency (while providing high linearity and high dynamic performance), which may be an important aspect in the context of automotive, in which heating induced by (excessive) power losses may be problematic for the overall performance of a vehicle. In conventional RF circuitry (e.g., RF power amplifier circuitry), as an example, high linearity and high dynamic performance may be achieved by operating transistors in linear mode, using high bias currents/voltages and low amplitudes compared to the quiescent current. This configuration may include arranging multiple power stages, all contributing to poor energy efficiency, expensive circuitry coming with efforts and cost for cooling concepts for heat sinking, and large size unsuited for miniaturization of the overall power stage (and hence of the overall LIDAR system). The modulation strategy described herein may enable emission of a modulated light signal in an energy-efficient manner. The LIDAR system described herein may include, in some aspects, an energy-efficient transmitter with high linearity and high dynamic range. The configuration of the LIDAR system described herein may provide, in some aspects, emitting very fast light pulses, e.g. with a pulse width in the nanosecond range or in the picosecond range.

Robust communication may be an important aspect in applications where a system transmitting light (e.g., laser light) is used for data communication (regardless of whether the light in addition to the data communication is used for ranging). Robust communication may be understood, for example, as low bit-error-rates (BER). Assuming a given communication channel, e.g. the foggy air between two vehicles that want to communicate with each other using the respective LIDAR modules, low bit-error-rates may be achieved by using appropriate transmitters, receivers and coding schemes. The strategy described herein may help addressing some or all of these aspects, while particularly taking into account the aspect of energy efficiency.

According to various aspects, a LIDAR system may include: a light emitting device configured to emit a light signal in accordance with (e.g., as a function of) a combination of a plurality of partial signals; and one or more processors configured to: encode a sequence of symbols, wherein each symbol is associated with a respective combination of the plurality of partial signals, and control the light emitting device to combine the plurality of partial signals in accordance with the encoded sequence of symbols to emit the light signal. The LIDAR module may illustratively be adapted for emitting a sequence of modulated light pulses. The LIDAR module may be configured as a pulsed LIDAR module with dynamically adjustable amplitude, in which the dynamic adjustment of an emitted light signal may be implemented optically and/or electrically. In various aspects, a binary-coded communication scheme may be provided (e.g., a binary power modulation system and a corresponding operating scheme may be implemented in the LIDAR module), e.g. a value-discrete communication scheme utilizing amplitude shift keying. The LIDAR module may be configured to implement coding with built-in redundancy.

According to various aspects, a LIDAR system may include: a light emitting device configured to emit a light signal in accordance with a combination of a plurality of partial light signals; and one or more processors configured to: encode a sequence of symbols, each symbol associated with a respective combination of the plurality of partial light signals, and control the light emitting device to optically combine the plurality of partial light signals in accordance with the encoded sequence of symbols to emit the light signal (illustratively, to optically combine the plurality of partial light signals in accordance with the encoded sequence of symbols to be encoded in the emitted light signal).

According to various aspects, a method of emitting light in a LIDAR system may be provided, the method including: encoding a sequence of symbols, each symbol associated with a respective combination of a plurality of partial signals; and controlling the combination of the plurality of partial signals in accordance with the encoded sequence of symbols to emit the light signal (illustratively, controlling the combination of the plurality of partial light signals in accordance with the encoded sequence of symbols to be encoded in the emitted light signal).

In the context of the present description, reference may be made to implementations for automotive applications (e.g., in case the LIDAR module is installed or to be installed in a vehicle). The approach described herein may provide implementing advanced functionalities of a LIDAR module for use in an at least partially autonomous vehicle. It is however understood that the applications of a LIDAR module are not limited to the automotive context, and a LIDAR module may be applied in other applications and markets such as professional, industrial, consumer, etc.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

Unless explicitly specified, the term “transmit” encompasses both direct and indirect transmission (e.g., via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). The term “calculate” as used herein encompasses both ‘direct’ calculation via a mathematical expression/formula/relationship and ‘indirect’ calculation via lookup or hash tables and other array indexing or searching operations.

As used herein, “memory” or “memory device” is understood as a computer-readable medium (e.g., a non-transitory computer-readable medium) in which data or information can be stored for retrieval. References to “memory” or “memory device” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, may also be embraced herein by the term “memory” or “memory device”. The term “software” refers to any type of executable instruction, including firmware.

In the figures, a notation to indicate various components of a light emitting device is provided, in which components associated with different partial signals (different branches of the light emitting device) are denoted by a corresponding letter associated with the component and a corresponding number associated with the respective branch. Illustratively, the notation X1 may be used to denote the component “X” of the first branch (BR1), the notation X2 may be used to denote the component “X” of the second branch (BR2), etc. As an example, the notation C1 may be used to denote a capacitor of the first branch, the notation D1 may be used to denote a diode of the first branch, the notation B1 may be used to denote a control signal provided at the first branch, etc. Other components with the corresponding notation will be described in further detail below. In the case that a branch includes more than one component of the same type (e.g., more than one capacitor, more than one diode, etc.), the notation may be expanded with a further number denoting the component, e.g. the notation X11 may used to denote the first component “X” of the first branch (BR1), the notation X12 may used to denote the second component “X” of the first branch (BR1), etc.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1A, FIG. 1B, and FIG. 1C each shows a respective light emitting device in a schematic view according to various aspects;

FIG. 2 shows a LIDAR module in a schematic view according to various aspects;

FIG. 3A and FIG. 3B each shows a respective graph representing a respective light signal according to various aspects;

FIG. 3C and FIG. 3D each shows a respective graph representing a respective light pulse according to various aspects;

FIG. 3E shows a graph representing light pulses according to various aspects;

FIG. 4A and FIG. 4B each shows a light emitting device in a schematic view according to various aspects;

FIG. 4C and FIG. 4D each shows a graph illustrating a light signal emitted according to the additive optical approach according to various aspects;

FIG. 4E and FIG. 4F each shows a light emitting device in a schematic view according to various aspects;

FIG. 5A shows a light emitting device in a schematic view according to various aspects;

FIG. 5B, FIG. 5C, FIG. 5D, FIG. 5E each shows a respective light absorbing device in a schematic view according to various aspects;

FIG. 5F shows a light emitting device in a schematic view according to various aspects;

FIG. 5G, FIG. 5H, and FIG. 5I each shows a light absorbing device in a schematic view according to various aspects;

FIG. 5J shows a light emitting device in a schematic view according to various aspects;

FIG. 6A, FIG. 6B, and FIG. 6C each shows a light emitting device in a schematic view according to various aspects;

FIG. 7A, FIG. 7B, FIG. 7C, FIG. 7D, FIG. 7E, FIG. 7F, FIG. 7G, and

FIG. 7H each shows a light emitting device in a schematic view according to various aspects;

FIG. 7I shows a time diagram of a light signal according to various aspects;

FIG. 7J shows a light emitting device in a schematic view according to various aspects;

FIG. 7K shows a time diagram of a light signal according to various aspects;

FIG. 8A shows a light emitting device in a schematic view according to various aspects;

FIG. 8B, FIG. 8C, and FIG. 8D each shows a respective timing diagram of a light signal according to various aspects;

FIG. 8E (represented as FIG. 8EA and FIG. 8EB) shows a light emitting device in a schematic view according to various aspects;

FIG. 8F (represented as FIG. 8FA and FIG. 8FB) shows timing diagrams of a light signal and of a control of a driving circuit according to various aspects;

FIG. 8G and FIG. 8H each shows a respective timing diagram of a light signal according to various aspects;

FIG. 9A, FIG. 9B, and FIG. 9C each shows a light emitting device in a schematic view according to various aspects;

FIG. 10A shows a laser diode drive circuit in a schematic view according to various aspects;

FIG. 10B, FIG. 10C, FIG. 10D, FIG. 10E, FIG. 10F, FIG. 10G, FIG. 10H, FIG. 10I each shows a light emitting device in a schematic view according to various aspects;

FIG. 11 shows a current source in a schematic view according to various aspects;

FIG. 12A shows a fundamental pulse cell in a schematic view according to various aspects;

FIG. 12B and FIG. 12C (represented as FIG. 12CA and FIG. 12CB) each shows a light emitting device in a schematic view according to various aspects;

FIG. 13A shows a LIDAR emitter in a schematic view according to various aspects;

FIG. 13B, FIG. 13C, FIG. 13D, FIG. 13E, and FIG. 13F each shows the mechanical arrangement of an integrated optoelectronic component in a schematic view according to various aspects; and

FIG. 14A, FIG. 14B, FIG. 14C, FIG. 14D, FIG. 14E, FIG. 14F, FIG. 14G, FIG. 14H each shows the mechanical arrangement of a two-dimensional optoelectronic component in a schematic view according to various aspects.

### DETAILED DESCRIPTION

The following detailed description refers to the accompanying drawings that show, by way of illustration, specific details and implementations in which the aspects disclosed herein may be practiced. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with devices (e.g., a LIDAR module, one or more processors, a light emitting device, etc.). However, it is understood that aspects described in connection with methods may similarly apply to the devices, and vice versa.

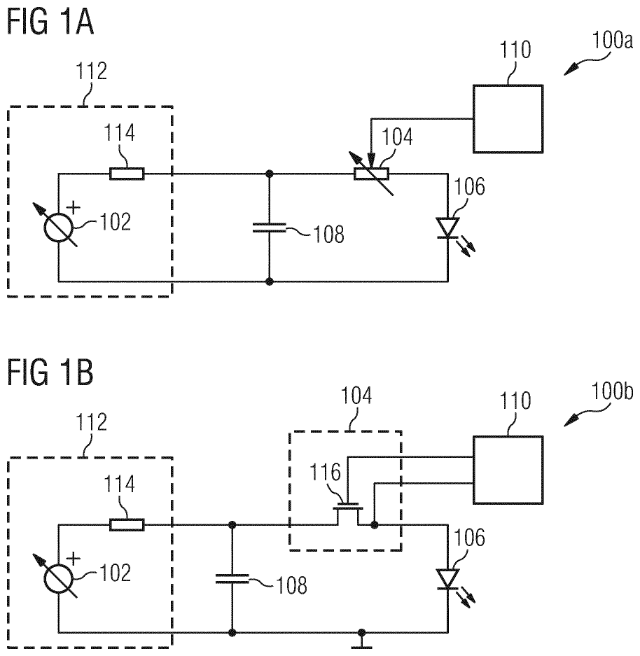

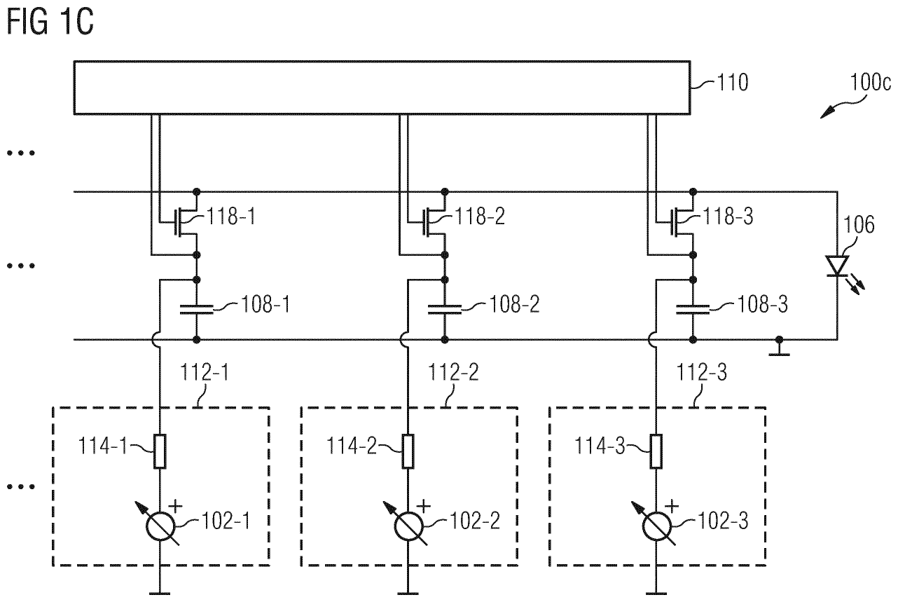

FIG. 1A, FIG. 1B, and FIG. 1C each shows a respective light emitting device 100a, 100b, 100c in a schematic view according to various aspects. FIG. 1A to FIG. 1C illustrate a possible approach for emitting modulated laser pulses.

The emission of laser pulses in the light emitting devices 100a, 100b, 100c may be based on repeatedly discharging one or more capacitors 108 into one or more laser diodes 106. The amplitude of an emitted laser pulse may be varied by modifying the set-value of the voltage up to which the pulse capacitor(s) 108 is/are charged (illustratively, the voltage up to which the capacitor(s) may be charged after the discharge for generating the previous laser pulse). In addition, during the discharge phase, the current flowing from the capacitor 108 through the laser diode 106 may be limited to a certain amplitude or modulated according to a set value.

The light emitting devices 100a, 100b, 100c in FIG. 1A to FIG. 1C may be configured to emit a laser pulse with variable amplitude, and may be configured to provide both a variable capacitor charging voltage (e.g., through a DC source 102) for varying the amplitude, and a variable resistance (e.g., through a controllable resistor 104) to modulate the current flow through the laser diode 106, and thereby modulating the shape of the emitted laser pulse.

In the configuration FIG. 1A and FIG. 1B, the light emitting device 100a, 100b may include a capacitor 108 configured to provide energy to the laser diode 106 (via a discharge of the capacitor 108). The capacitor 108 may be discharged into the laser diode 106 via the controllable resistor 104, which may be controlled (e.g., by a control circuit 110) to adjust the amount of current arriving at the laser diode 106. The control circuit 110 may be configured to modulate a control voltage provided at the controllable resistor 104 to shape the current provided at the laser diode 106, thus shaping an emitted laser pulse.

The light emitting device 100a, 100b may include a charging circuit 112 configured to control the charging of the capacitor 108. In the configuration in FIG. 1A and FIG. 1B, the charging circuit 112 may include the controllable DC source 102 and a charging resistor 114. The voltage of the DC source 102 may be controlled by the control circuit 110, e.g. the control circuit 110 may be configured to set the voltage of the controllable DC source 102 as a function of a desired amplitude of the laser pulse.

In the configuration in FIG. 1B, laser pulses with variable shape may be emitted by varying the capacitor charging voltage and a modulation of an in-series resistance. The light emitting device 100b may include a metal-oxide-semiconductor field-effect transistor (MOSFET) 116 as an exemplary implementation of the controllable resistor 104.

As an additional or alternative approach with respect to varying and/or modulating the charging voltage and a resistance in series with a laser diode, the capacity of the discharge capacitor 108 may be varied and/or modulated to modulate the pulse shape. A possibility, shown in the light emitting device 100c in FIG. 1C may include splitting the capacitor in a plurality of smaller capacitors, a so-called “capacitor bank”. In this configuration, electronic devices, e.g. transistors, may be used to create an “effective capacitor” by switching on and off some of the capacitors of the capacitor bank. Illustratively, in the configuration in FIG. 1C, the effective discharge capacitor may be varied by using a plurality of switches and a capacitor split into a plurality of smaller capacitors (e.g., first to third capacitors 108-1, 108-2, 108-3 in the exemplary configuration in FIG. 1C). The light emitting device 100c may include a transistor for each capacitor, e.g. first to third transistors 118-1, 118-2, 118-3 in the configuration in FIG. 1C, to control the contribution of the individual capacitors 108-1, 108-2, 108-3 to the generation of the laser pulse.

The transistors 118-1, 118-2, 118-3 and the capacitors 108-1, 108-2, 108-3 may form a plurality of transistor-capacitor pairs connected in parallel with one another, and controllable to individually provide electric power to the laser diode 106. Each capacitor 108-1, 108-2, 108-3 may have an associated charging circuit (e.g., first to third charging circuits 112-1, 112-2, 112-3 in the configuration in FIG. 1C), each including a respective DC source 102-1, 102-2, 102-3 and charging resistor 114-1, 114-2, 114-3. The charging voltage for each capacitor 108-1, 108-2, 108-3 may be individually set through the respective controllable DC source 102-1, 102-2, 102-3 by the control circuit 110.

The control of a transistor 118-1, 118-2, 118-3 by the control circuit 110 may include a modulation of the respective gate-source voltage to create a current to the laser diode current 106 to provide the desired laser pulse shape, e.g. to create a current provided by the controlled sum of the drain currents of the transistors 118-1, 118-2, 118-3. As an example, each of the transistors 118-1, 118-2, 118-3 may carry a same fraction of the current to be provided to the laser diode 106 (e.g., a transistor may be used as a controllable resistor). As another example, each of the transistors 118-1, 118-2, 118-3 may be used as a switch to turn fully ON or fully OFF the contribution of respective capacitor to the current provided at the laser diode 106.

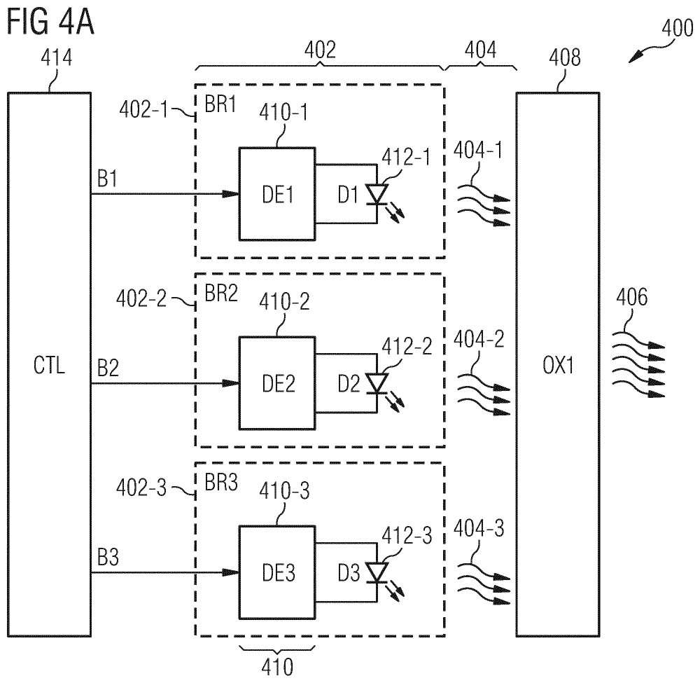

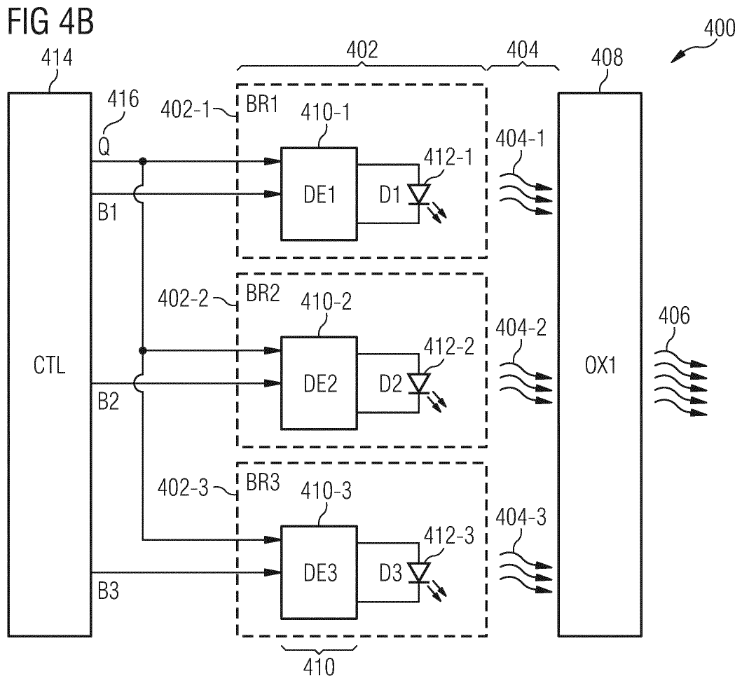

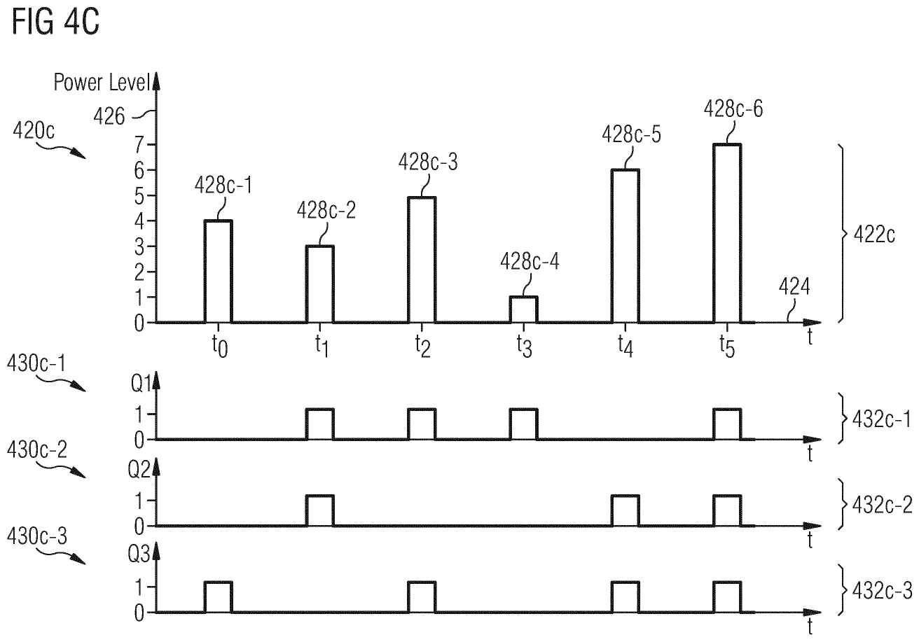

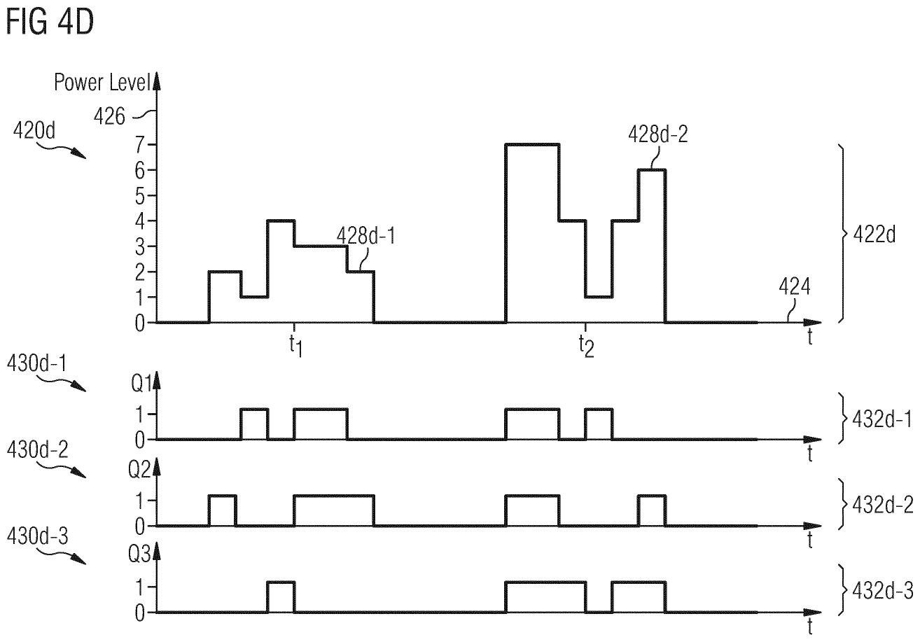

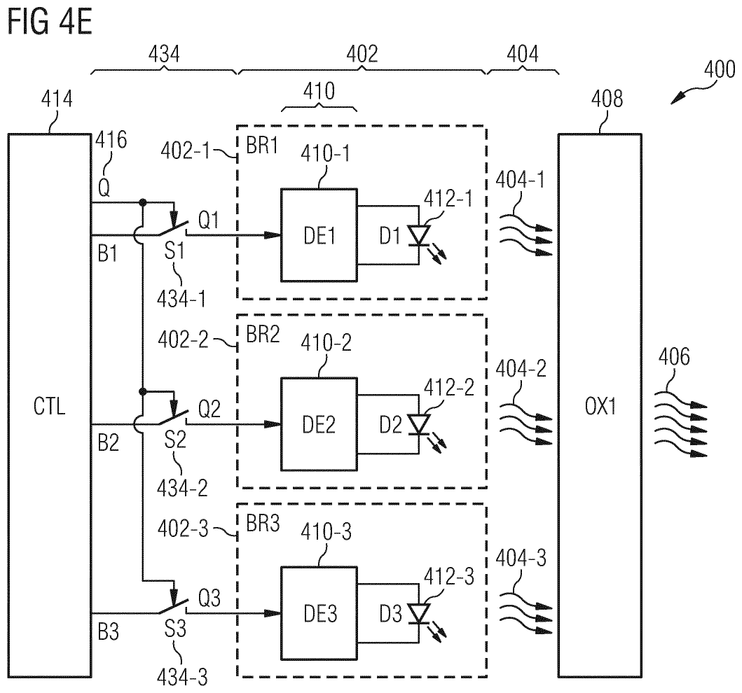

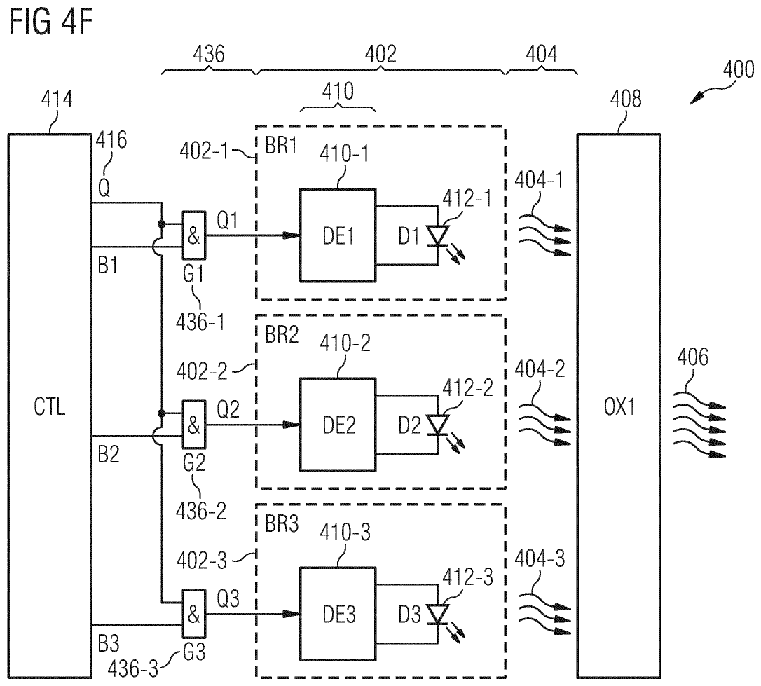

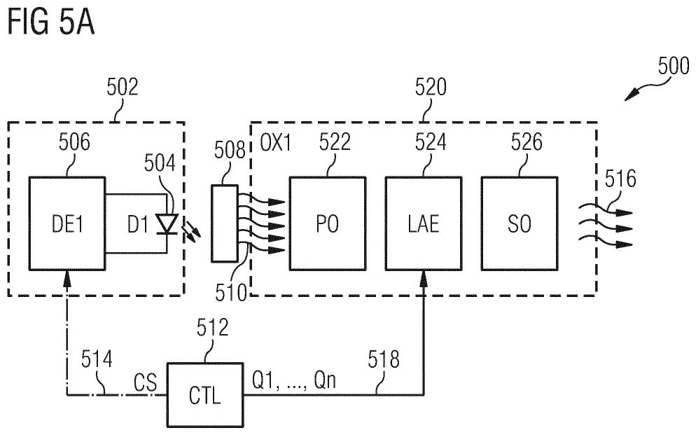

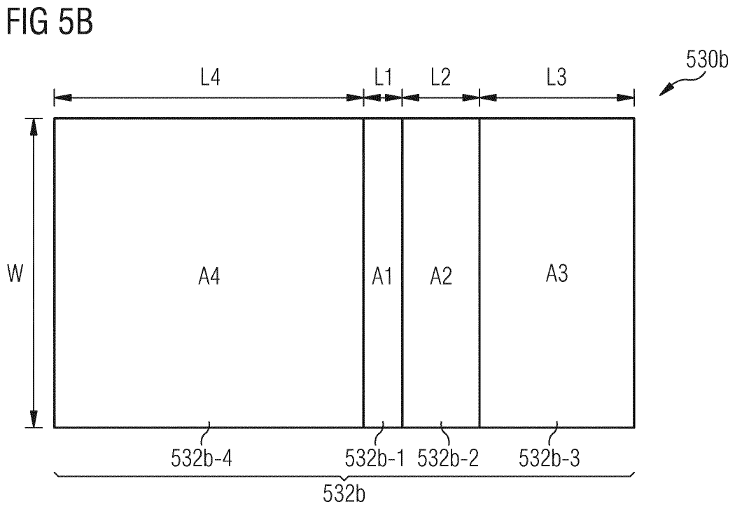

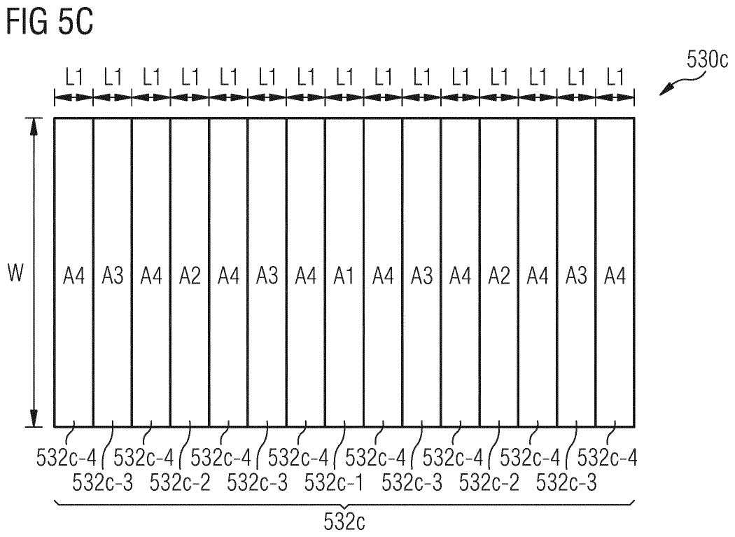

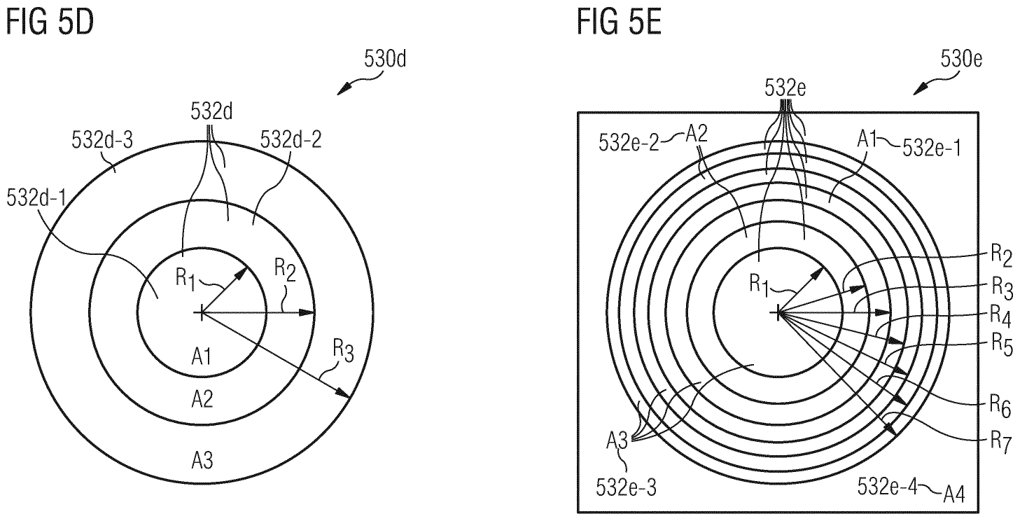

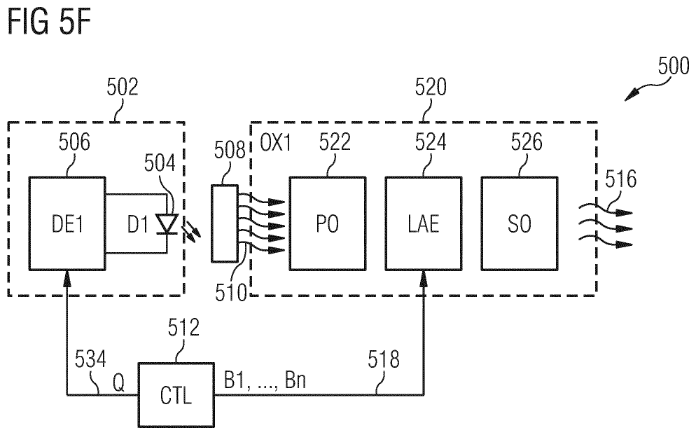

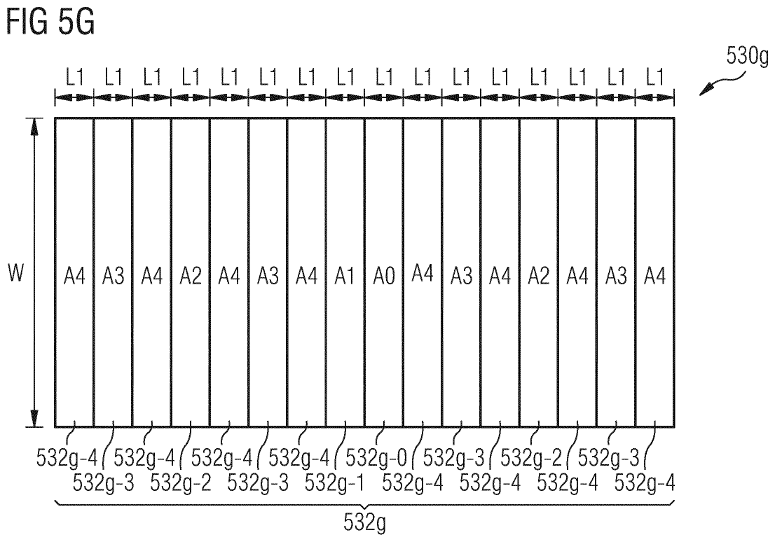

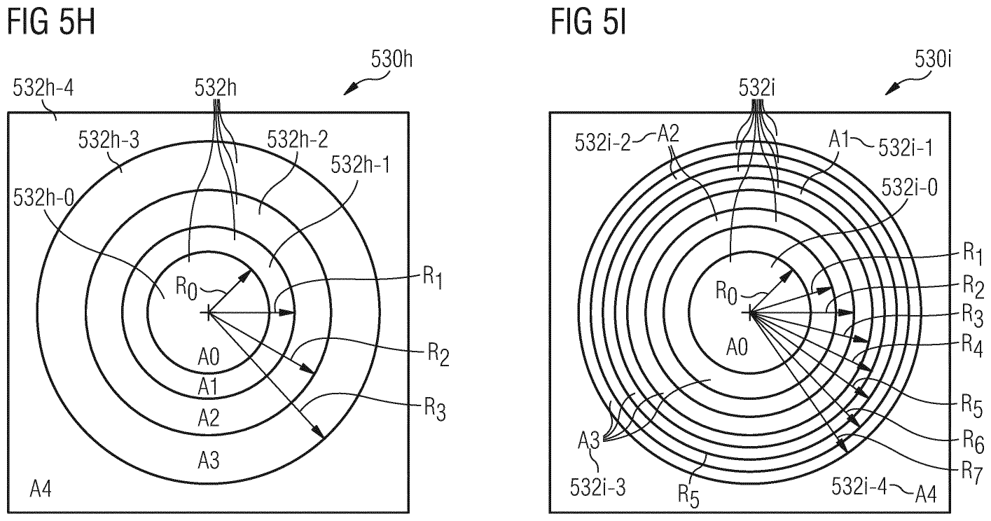

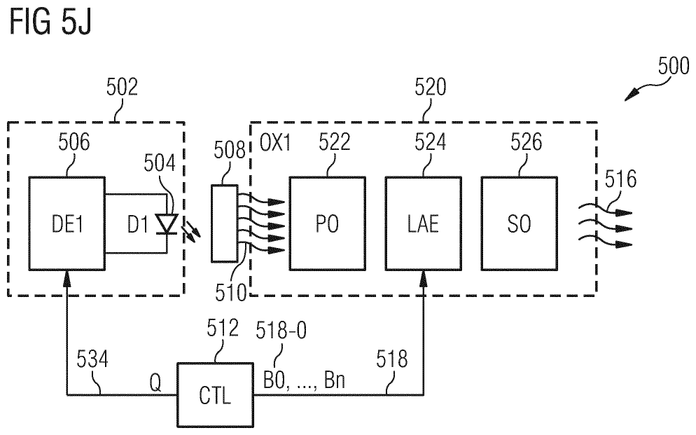

Various aspects may be related to a more advanced strategy with respect to the approach described in relation to FIG. 1A to FIG. 1C. The light emission described herein may be based on controlling a combination of partial signals as a function of a sequence of symbols to be encoded in the emitted light signal. In addition, in some aspects (see for example FIG. 4A to FIG. 5J), an emitted light signal may be provided by an optical combination of partial light signals, rather than by a combination of electrical signals, which may provide a simpler and faster strategy for providing a desired modulation.

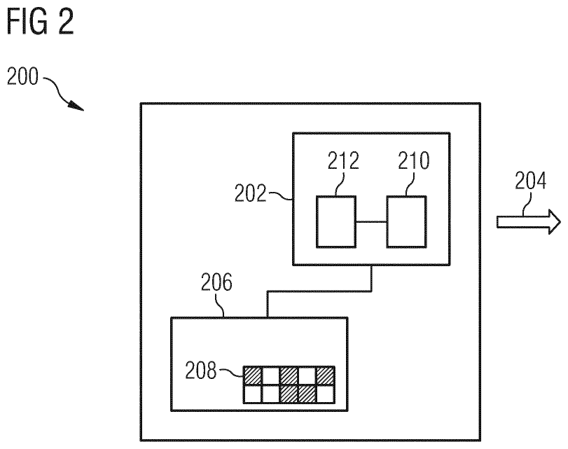

FIG. 2 shows a LIDAR module 200 in a schematic view according to various aspects. It is understood that the representation in FIG. 2 may be simplified for the purpose of illustration, and the LIDAR module 200 may include additional components with respect to those shown (e.g., a detector, one or more other sensors, etc.).

The LIDAR module 200 may include a light emitting device 202 configured to emit light 204, e.g. a light signal 204. The light emitting device 202 may be configured to emit the light signal 204 in accordance with (e.g., as a function of) a combination of a plurality of partial signals (e.g., partial electrical signals and/or partial light signals, as described in further detail below). Illustratively, the light emitting device 202 may include one or more electrical components configured to provide respective electrical signals and/or one or more optical components configured to provide respective light signals (in other words, respective optical signals) that may be combined with one another to provide the emitted light signal 204.

The light signal 204 may have a predefined wavelength, for example in the visible range (e.g., in the range from about 380 nm to about 700 nm), infra-red and/or near infra-red range (e.g., in the range from about 700 nm to about 5000 nm, for example in the range from about 860 nm to about 1600 nm, or for example at 905 nm or 1550 nm), or ultraviolet range (e.g., in the range from about 100 nm to about 400 nm).

In various aspects, the light emitting device 202 may include a light source 210 configured to emit light. In some aspects, an adaptation of the signal level of the emitted light signal 204 may include an adaptation of the light source 210, as described in further detail below. The light source 210 may include any suitable type of light source to provide light at a desired signal level and in a desired wavelength range. As an example, the light source 210 may include one or more light emitting diodes. As another example, the light source 210 may include one or more laser diodes (e.g., one or more edge emitting laser diodes, or one or more vertical cavity surface emitting laser diodes). The light source 210 may be configured as an array, or a stack, of light sources (e.g., a one- or two-dimensional array of light emitting diodes or laser diodes, or a stack of laser diodes).

In various aspects, the light emitting device 202 may include a driving circuit 212 configured to drive the light source 210. In some aspects, an adaptation of the signal level of the emitted light signal 204 may include an adaptation of the driving circuit 212, as described in further detail below. The driving circuit 212 may be configured to provide an electrical signal (e.g., a current, a voltage, or a power) to the light source 210 to drive the emission of light (e.g., the light source 210 may be configured to emit light in response to an electrical signal received from the driving circuit 212). In various aspects, the driving circuit 212 may include a plurality of driving circuits, each being configured to provide a respective electrical signal to the light source 210. In this configuration, different driving circuits may be assigned to different functions. As an example, at least one driving circuit may be assigned to provide the respective electrical signal for a ranging operation associated with the emitted light signal 204 (illustratively, for inducing the emission of light used for investigating the scene, e.g. the field of view of the LIDAR module 200). A ranging operation may include determining (e.g., measuring or calculating) the time-of-flight of the emitted light signal 204 (e.g., of at least one light pulse of the emitted light signal 204). As another example, at least one driving circuit may be assigned to provide the respective electrical signal for data transmission associated with the emitted light signal 204 (e.g., for encoding the sequence of symbols 208 in the emitted light signal 204).

The LIDAR module 200 may include one or more processors 206 (e.g., as part of a control circuit) configured to provide an instruction to the light emitting device 202 for controlling the emission of the light signal 204 (illustratively, to control the combination of the partial signals). The one or more processors 206 may be configured to encode a sequence of symbols 208, e.g. the one or more processors 206 may be configured to determine (e.g., generate, calculate) an instruction for controlling the light emitting device 202 as a function of the sequence of symbols 208. In various aspects, encoding the sequence of symbols may include generating a digital signal representing the sequence of symbols 208 in a way that may be provided as an instruction to the light emitting device 202. For example, the one or more processors 206 may include a microprocessor, a microcontroller, a discrete logic gate, a programmable logic, a field-programmable gate array (FPGA), and/or an application-specific integrated circuit (ASIC). In various aspects, the one or more processors 206 may be part of the light emitting device 202.

In various aspects, a symbol of the sequence of symbols may be representative of data or of a portion of data that may be transmitted via the emitted light signal 204. A symbol may be understood as an input to the communication channel, e.g. as a certain (modulated) light intensity input to the optical communication channel defined by the LIDAR module 200.

The sequence of symbols 208 may be configured to carry data to be transmitted. Illustratively, the sequence of symbols 208 may encode data to be transmitted optically via the emitted light signal 204. The data may include, for example, information to identify the LIDAR module 200 (e.g., information uniquely associated with the LIDAR module 200). As another example, additionally or alternatively, the data may include information to characterize the emitted light signal 204 (e.g., to distinguish a received light signal that was caused by the system's own emitted light signal 204, from other light signals, so-called alien signals, that were caused by other LIDAR modules). In various aspects, at least a portion of the sequence of symbols 208 may be uniquely associated with the LIDAR module 200, e.g. at least a portion of the sequence of symbols 208 may represent data uniquely identifying the LIDAR module 200 (e.g., a serial number of the LIDAR module 200). Additionally or alternatively, at least a portion of the sequence of symbols 208 may be uniquely associated with the light emitting device 202, e.g. at least a portion of the sequence of symbols 208 may represent data uniquely identifying the light emitting device 202 (e.g., an identifier of the light emitting device 202, for example the combination of an identifier and a serial number). It is understood that a portion of the sequence of symbols 208 may be also uniquely associated with other components of the LIDAR module 200 (e.g., a detector, a control circuit, etc.).

At least one symbol (e.g., each symbol) of the sequence of symbols 208 may be associated with a respective combination of the plurality of partial signals. Illustratively, at least one (e.g., each) symbol may be represented by a respective combination of the plurality of partial signals (e.g., by a respective light signal emitted according to that combination). A light signal 204 (or a portion of the light signal 204, e.g. a light pulse) emitted in accordance with the combination of the plurality of partial signals associated with a symbol may represent that symbol (e.g., may be decoded, at a receiver side, to extract the transmitted symbol from the light signal 204).

The one or more processors 206 may be configured to control the light emitting device 202 to combine the plurality of partial signals in accordance with (e.g., as a function of) the encoded sequence of symbols 208 to emit the light signal 204. The one or more processors 202 may be configured to generate an instruction to control the light emitting device 202, and the instruction may represent how to combine the partial signals (e.g., which partial signals, at which time point, for how long, etc.) to emit the light signal 204 in a way that the emitted light signal 204 represents the sequence of symbols 208.

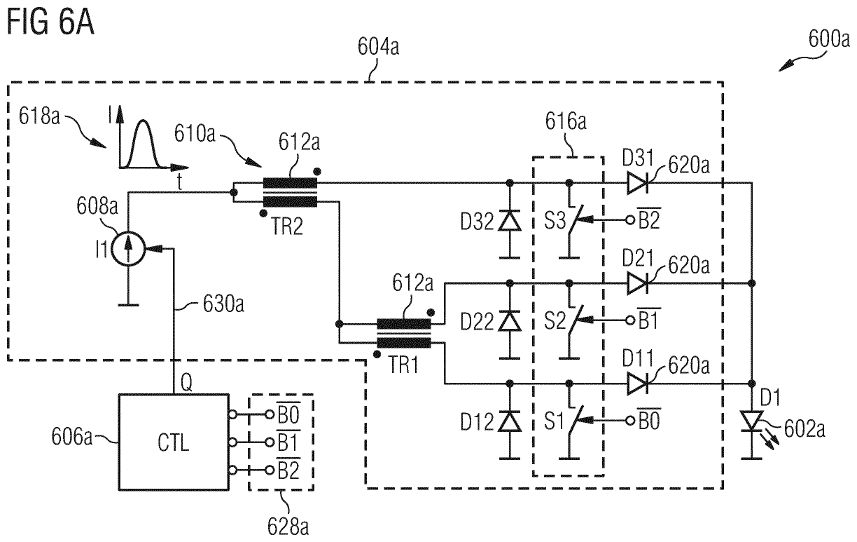

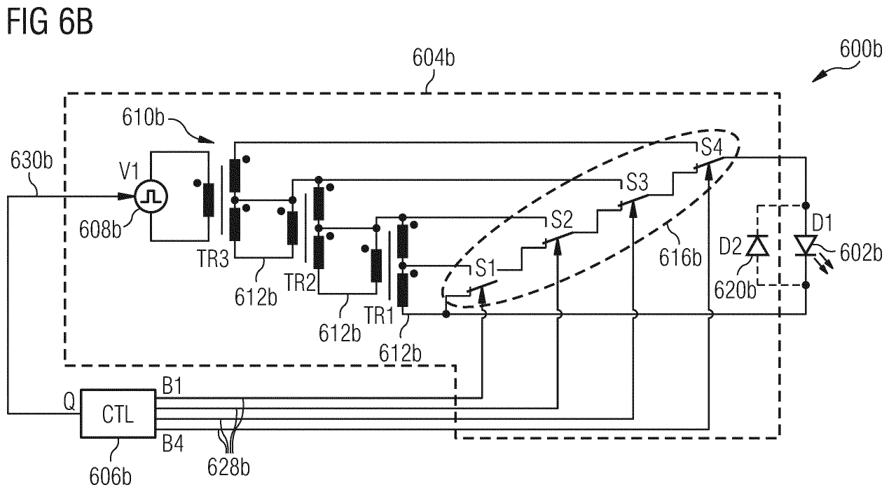

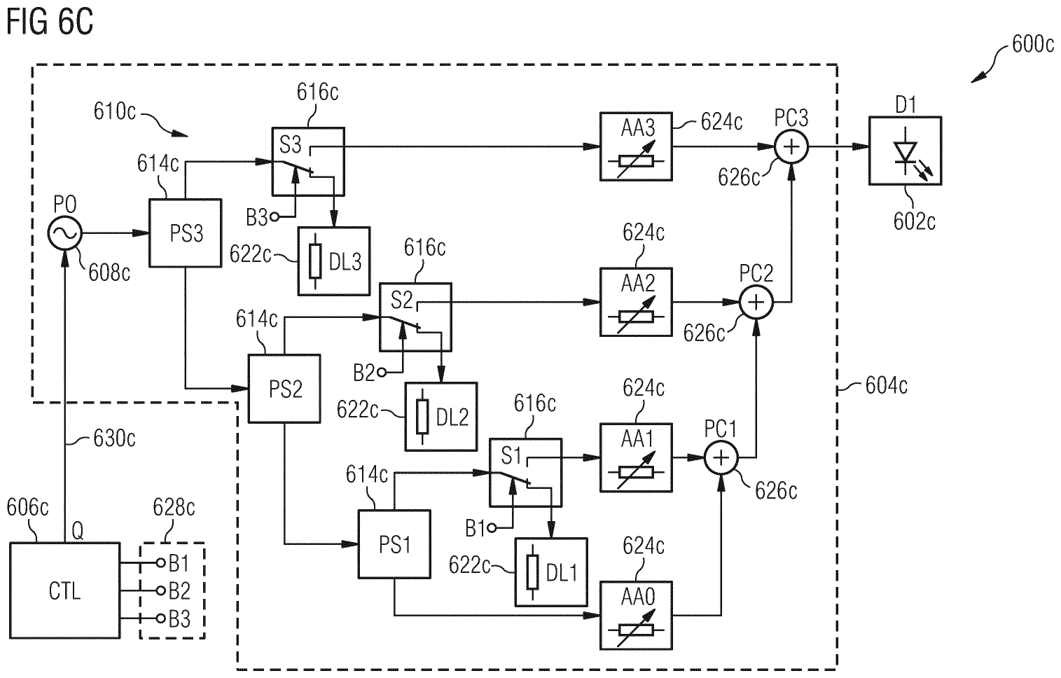

In the following, different approaches for emitting the light signal 204 are described, which may be characterized as “electrical approach” and “optical approach”. The LIDAR module 200 (e.g., the light emitting device 202) may be configured according to the “electrical approach”, or according to the “optical approach”, or according to a combination of the “electrical approach”, and the “optical approach”. Illustratively, in some aspects, the plurality of partial signals may include a plurality of partial light signals, and the combination of the plurality of partial signals may include an optical combination of the plurality of partial light signals (see FIG. 4A to FIG. 5J). In some aspects, the plurality of partial signals may include, additionally or alternatively, a plurality of partial electrical signals, and the combination of the plurality of partial signals may include an electrical combination of the plurality of partial electrical signals (see FIG. 6A to FIG. 8H).

Within the context of the electrical approach and the optical approach, two implementations will be described, which may be characterized as “additive combination” and as “subtractive combination”. Illustratively, the combination of the plurality of partial signals may include an additive combination of the plurality of partial signals and/or a subtractive combination of the plurality of partial signals. As described above, the various implementations may be combined with one another, e.g. the light emitting device 202 may be configured to provide an additive combination of partial electrical signals, and/or a subtractive combination of partial electrical signals, and/or an additive combination of partial light signal, and/or a subtractive combination of partial light signals, as described in further detail below.

Controlling the combination of partial signals to emit the light signal 204 may provide modulating the light signal 204, e.g. for encoding therein the sequence of symbols 208. According to various aspects, the emitted light signal 204 may include one or more light pulses (e.g., one or more laser pulses). The one or more light pulses may represent the encoded sequence 208, e.g. each light pulse may be associated with (e.g., may be representative of) respective one or more symbols of the sequence of symbols 208.

Various possibilities may be provided for encoding the sequence of symbols 208 into one or more light pulses of the emitted light signal 204. As an example, at least one (e.g., each) light pulse may be associated with a respective one symbol of the sequence of symbols 208, e.g. there may be a one-to-one correspondence between the light pulses and the symbols. As another example, at least one (e.g., each) light pulse may be associated with a respective plurality of symbols of the sequence of symbols 208, e.g. there may be a one-to-many correspondence between the light pulses and the symbols. As a further example, a subset of the plurality of light pulses may be associated with a respective one symbol of the sequence of symbols 208, e.g. there may be a many-to-one correspondence between the light pulses and the symbols. A symbol may thus be represented by a single light pulse, by a portion of a light pulse, or by a (sub-)plurality of light pulses of the emitted light signal 204.

The control over the combination of partial signals may provide generating light pulses with adjustable properties, e.g. adjustable amplitude and/or adjustable pulse shape and/or adjustable timing between the pulses.

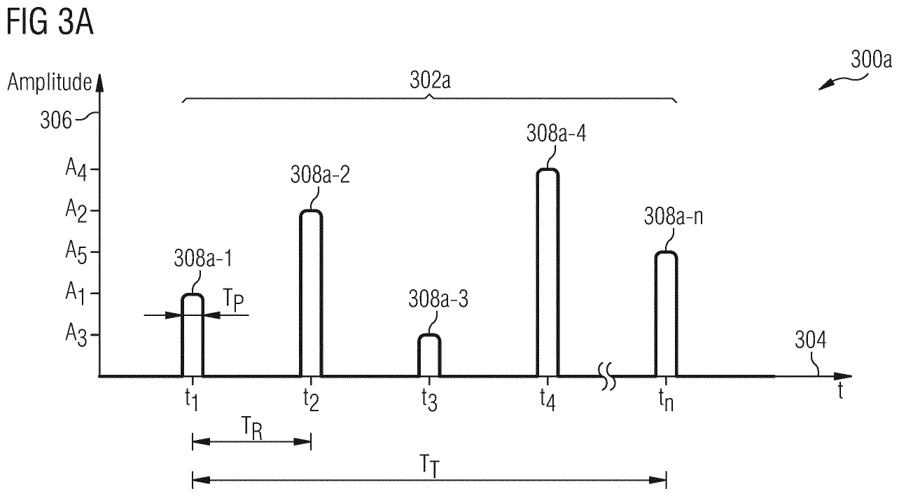

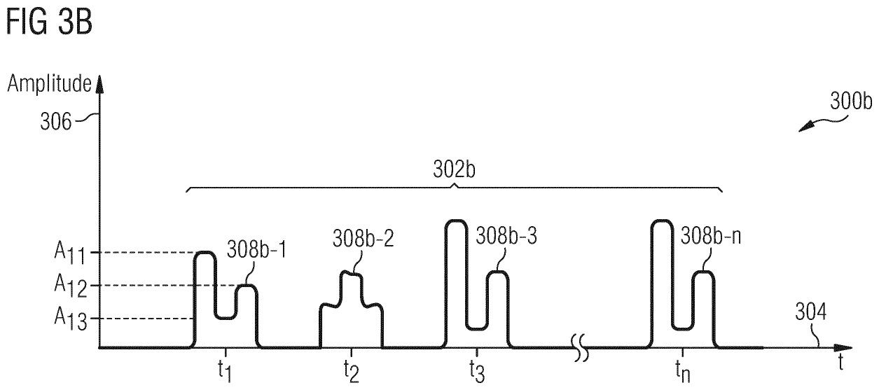

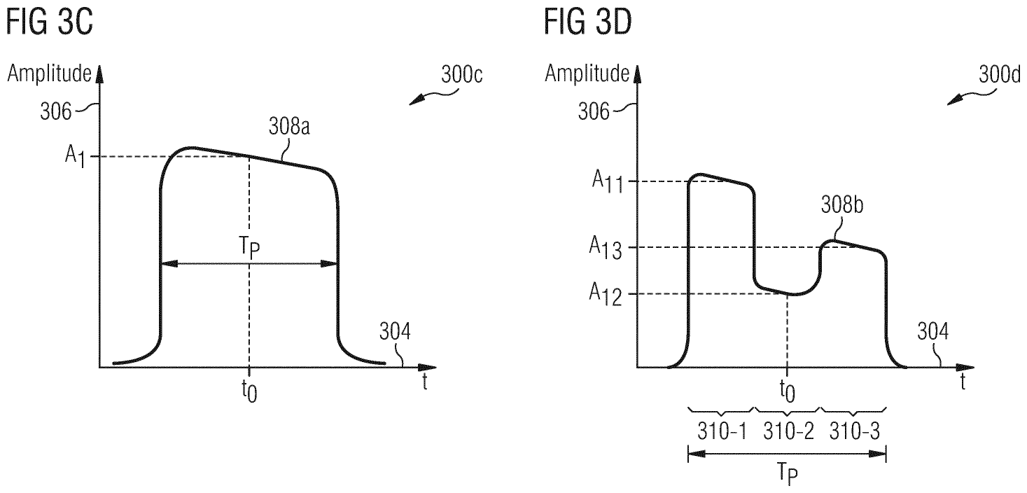

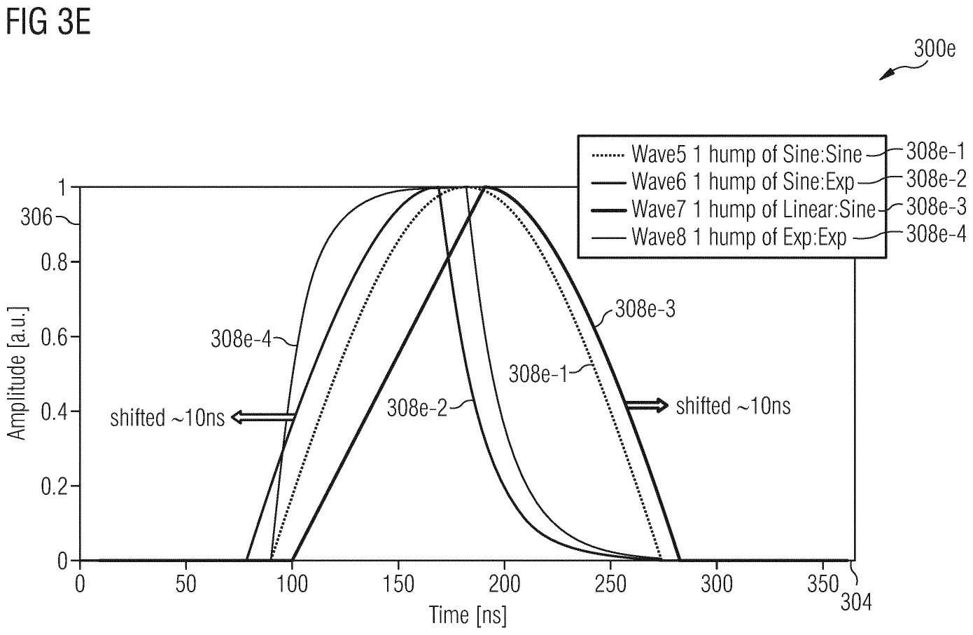

FIG. 3A and FIG. 3B show a respective graph 300a, 300b representing a respective light signal 302a, 302b according to various aspects. The light signal 302a, 302b may be represented over time (t, along the horizontal axis 304, e.g. expressed in nanoseconds) and in terms of signal level (e.g., the amplitude, along the vertical axis 306, e.g. expressed in arbitrary units a.u.). The light signal 302a, 302b may be an example of the light signal 204 described in relation to FIG. 2, e.g. the aspects described herein in relation to the light signal 302a, 302b may apply to the light signal 204. It is understood that the light signal 302a, 302b in FIG. 3A and FIG. 3B are exemplary representations of a light signal that may be emitted with the strategy described herein, and are provided to illustrate various properties that a light signal may have, but other configurations of an emitted light signal may be provided (e.g., with more or less light pulses, with different amplitude levels, with different timing between pulses, etc.). It is also understood that the amplitude is an exemplary parameter representing a signal level of the emitted light signal 302a, 302b, and other parameters may be used to represent the light signal, e.g. the (optical) power or the (optical) energy of the emitted light signal 302a, 302b.

The light signal 302a, 302b may include one or more light pulses 308a, 308b, e.g. n light pulses 308a, 308b (for example, a sequence of light pulses). In the exemplary configuration in FIG. 3A, the light signal 302a may include a first light pulse 308a-1, a second light pulse 308a-2, a third light pulse 308a-3, a fourth light pulse 308a-4, . . . , and an n-th light pulse 308a-n (e.g., emitted at respective first to n-th time points, t1, t2, t3, t4, . . . , tn). In the exemplary configuration in FIG. 3B, the light signal 302b may include a first light pulse 308b-1, a second light pulse 308b-2, a third light pulse 308b-3, . . . , and an n-th light pulse 308b-n (e.g., emitted at respective first to n-th time points, t1, t2, t3, . . . , tn). It is understood that a light signal 300a, 300b may include any suitable number of light pulses 308a, 308b, e.g. as a function of the sequence of symbols to be encoded. As a numerical example, a light signal 302a, 302b may include a number of light pulses 308a, 308b in the range from 1 to 100, for example in the range from 2 to 10.

A light pulse 308a, 308b may have an amplitude (also referred to as pulse height). The amplitude may be or may represent a maximum value of a signal level associated with the light pulse. In other words, the amplitude may be or may represent the magnitude of a signal level associated with the light pulse. Illustratively, the amplitude may be or may represent a signal level associated with the light pulse evaluated with respect to a reference signal level, e.g. a base signal level, for example 0. The amplitude may also be referred to as peak amplitude. Each light pulse 302a, 302b, may have one or more signal levels (e.g., one or more amplitude levels) associated therewith, as a function of the pulse shape, as described in further detail below.

The shape of a light pulse 308a, 308b may be adjusted by controlling the combination of partial signals to emit the light signal 300a, 300b. In various aspects, as shown in FIG. 3A (see also the graph 300c in FIG. 3C) a light pulse 308a may include a single portion, e.g. a light pulse 308a may be a single quasi-rectangular pulse. In various aspects, as shown in FIG. 3B (see also the graph 300d in FIG. 3D) a light pulse 308b may include a plurality of pulse portions (e.g., three pulse portions 310-1, 310-2, 310-3 in the exemplary configuration in FIG. 3D), e.g. a pulse 308b may be composed of multiple pulse portions (also referred to herein as pulse sections, sub-pulses, or humps). In various aspects, a light signal 302a, 302b may include a combination of light pulses including a single pulse portion and light pulses including a plurality of pulse portions. A light pulse 300b including a plurality of pulse portions may be understood as a light pulse including one or more local minima and one or more local maxima.

In the case that a light pulse 300b includes a plurality of pulse portions, each pulse portion may have a respective signal level, e.g. a respective amplitude. In the exemplary configuration in FIG. 3D, the light pulse 300b may include a first pulse portion 310-1 having a first signal level (a first amplitude A₁₁), a second pulse portion 310-2 having a second signal level (a second amplitude A₁₂), and a third pulse portion 310-3 having a third signal level (a third amplitude A₁₃).

The signal level of a light pulse 308a, 308b may be selected as a function of the one or more symbols associated with that light pulse 308a, 308b, e.g. the amplitude itself may be used to convey information. Illustratively, the signal level of a light pulse 308a, 308b may be defined by the one or more symbols associated with the light pulse 308b. In the case that a light pulse 308b includes a plurality of pulse portions, the individual signal levels of the plurality of pulse portions may be selected as a function of the symbols that the light pulse 308 represents, e.g. the signal levels of the plurality of pulse portions may be defined by the one or more symbols associated with the light pulse 308b. As an example, a first light pulse (e.g., the light pulse 308a-1) associated with one or more first symbols may have a first signal level, and a second light pulse (e.g., the light pulse 308a-2) associated with one or more second symbols may have a second signal level, and the first signal level may be different from the second signal level.

Additionally or alternatively, the shape of a light pulse 308a, 308b may be selected as a function of the one or more symbols associated with that light pulse 308a, 308b, e.g. the shape may be used to convey information (e.g., the shape of a light pulse 308a, 308b may be associated with the one or more symbols associated with the light pulse 308a, 308b). Illustratively, the shape of a light pulse 308a, 308b may be defined by the one or more symbols associated with the light pulse 308a, 308b. In the case that a light pulse 308b includes a plurality of pulse portions, the plurality of pulse portions may define the shape of the light pulse. As an example, a light pulse 308a, 308b (or a pulse portion) may have as pulse shape one of a rectangular pulse shape, a quasi-rectangular pulse shape, or a Gaussian pulse shape. In the following, for sake of simplicity, reference may be made to quasi-rectangular pulse sections. It is however understood that the aspects described herein, e.g. the electrical approach and optical approach described below, may apply to any suitable pulse shape (see also FIG. 3E), e.g. with suitable adjustments of the components (e.g., of the circuitry). The light signal 302a may include a LIDAR pulse train comprising several single quasi-rectangular pulses and the light signal 302b may include a LIDAR pulse train consisting of several pulses each composed of multiple quasi-rectangular pulse sections, but it is understood that these configurations are only an example, and pulses (or sub-pulses) with different shapes may be provided.

A light pulse 308a, 308b may have a pulse width Tp (also referred to as pulse length or duration). The pulse width Tp may be, in some aspects, determined as so called full width at half maximum (FWHM) of a pulse. In the case that a light pulse 300b includes a plurality of pulse portions, the total pulse duration Tp may be calculated from the durations of the sub-pulses. A sub-pulse i may have a duration Tp,i, and a “gap” between sub-pulses may be considered itself as a sub-pulse (as long as the “gap” logically belongs to the same pulse, e.g. as the pulse portion 310-2 in FIG. 3D). Considering a total number h (from humps) of sub-pulses per light pulse, the total duration of a light pulse may be calculated as

$${T}_{p} = {\sum }_{i =} {hT}_{p , i} \qquad ( 1 )$$

As a numerical example, at least one (e.g., each) light pulse 308a, 308b of a light signal 302a, 302b may have a (total) duration in the range from 1 ps to 1 ms, for example in the range from 10 ps to 10 μs, for example in the range from 100 ps to 100 ns, for example in the range from 200 ps to 25 ns. In the exemplary configuration in FIG. 3A, the light pulses 308a may have a pulse duration Tp of 12 ns (nanoseconds).

A distance between consecutive light pulses 308a, 308b in a light signal 302a, 302b may be adjusted depending on a desired data rate and/or depending on the capabilities of a light emitting device (e.g., of the light emitting device 202). As a numerical example, a repetition time T_{R} (a centre-to-centre distance between consecutive light pulses 308a, 308b) may be in the range from 100 ns to 2 μs (microseconds), for example in the range from 500 ns to 1.5 μs (e.g., 1.1 μs in the exemplary configuration in FIG. 3A). The repetition time may remain constant within a light signal 302a, 302b or may vary throughout a light signal 302a, 302b. In various aspects, a varying repetition time may be selected as a function of the sequence of symbols encoded in a light signal 302a, 302b, e.g. a variation of the repetition time may be used to encode information in the light signal 302a, 302b.

A light signal 302a, 302b may have a total duration T_{T} defined by the individual durations of the light pulses 302a, 302b, and the durations of the repetition time(s). As a numerical example, a light signal 302a, 302b may have a total duration in the range from 1 ps to 100 ms, for example in the range from 10 ps to 1 ms, for example in the range from 100 ps to 10 ps, for example in the range from 200 ps to 2.5 μs. In the exemplary configuration in FIG. 3A, the light signal 302 may have an overall pulse train duration T_{T} of 1 ms (milliseconds).

The time durations relevant in LIDAR applications may be on different orders of magnitude. Various aspects may be based on the realization that such differences may be relevant for circuits and the used technology in general. The optimal pulse duration Tp for a certain use case or application may depend on several factors, e.g. including the available technologies, the required precision, the allowed cost, energy consumption, and system complexity. For applications and technologies relevant for a LIDAR module (e.g., for the LIDAR module 200), even considering technological improvements over the next two decades, a pulse duration of 3 ps (picoseconds) to 800 μs (microseconds) may be in a relevant range, for example in the range from 300 ps to 8 μs, for example in the range from 10 ns to 500 ns.

In this regard, FIG. 3E shows a graph 300e illustrating several light pulses 308e-1, 308e-2, 308e-3, 308e-4 which are more than an order of magnitude longer compared to the light pulses 308a, 308b shown in FIG. 3A to FIG. 3D. The light pulses 308e-1, 308e-2, 308e-3, 308e-4 may have different shapes compared to the light pulses 308a, 308b, to illustrate other possible shapes that may be provided by the LIDAR module described herein (e.g., by the light emitting device 202). In the graph 300e, the light pulses 308e-1, 308e-2, 308e-3, 308e-4 may be normalized to an amplitude of 1. For the sake of clarity of representation, the second light pulse 308e-2 and the fourth light pulse 308e-4 are represented with a shift (e.g., 10 ns) with respect to the first light pulse 308e-1 and the third light pulse 308e-3. The first light pulse 308e-1 may be a sinusoidal pulse, e.g. may have a sinusoidal first portion and a sinusoidal second portion.

The second light pulse 308e-2 may have a first portion and a second portion having different shape characteristics, e.g. may have a sinusoidal first portion and an exponential second portion. The third light pulse 308e-3 may have a linear first portion and a sinusoidal second portion. The fourth light pulse 308e-4 may be an exponential pulse, e.g. may have an exponential first portion and an exponential second portion. It is understood that the combination of shape characteristics in FIG. 3E is only an example, and light pulses having different shape characteristics or different combinations of shape characteristics may be provided (e.g., as a function of an encoding of a sequence of symbols, e.g. of the sequence of symbols 208).

According to various aspects, the encoding of a sequence of symbols and the emission of a light signal (e.g., the encoding of the sequence of symbols 208 and the emission of the light signal 204) may be based on a so-called “binary light amplitude modulation” (or, more in general, binary modulation of a signal level of the emitted light signal). The combination of the plurality of partial signals may be controlled to provide a desired signal level (e.g., a desired amplitude) of the emitted light signal over time (e.g., in different light pulses, see FIG. 3A, and/or within a same light pulse, see FIG. 3B).

Which partial signals are combined and in what manner may define the modulation of the emitted light signal and may represent the encoded sequence of symbols. As an example, the combination of the plurality of partial signals associated with a symbol may include a combination of a subset of the plurality of partial signals (e.g., only some of the available partial signals may be combined to emit a light signal, or a portion of light signal, representing that symbol). As another example, the combination of the plurality of partial signals associated with a symbol may include a combination of all the partial signals of the plurality of partial signals (e.g., all the available partial signals may be combined to emit a light signal, or a portion of light signal, representing that symbol).

Only as an example, Table 1 describes a variation of the amplitude of a LIDAR pulse between zero light (minimum amplitude) and full light (maximal amplitude) in 8 equidistant power steps. As a numerical example the peak laser power may be varied between 0 W and 10.5 W. Table 1 describes the different light levels (illustratively, the different optical power levels). Table 1 may describe the generation of light pulses (e.g., laser pulses) with 8 intensity levels (from the 0-th level to the 7-th level) controlling the combination of three partial signals B1, B2, B3.

TABLE 1

| | | | | Optically Emitted |
|---|---|---|---|---|
| Level | B3 | B2 | B1 | Pulse Power [W] |
| 0 | 0 | 0 | 0 | 0 |
| 1 | 0 | 0 | 1 | 1.5 |
| 2 | 0 | 1 | 0 | 3 |
| 3 | 0 | 1 | 1 | 4.5 |
| 4 | 1 | 0 | 0 | 6 |
| 5 | 1 | 0 | 1 | 7.5 |
| 6 | 1 | 1 | 0 | 9 |
| 7 | 1 | 1 | 1 | 10.5 |

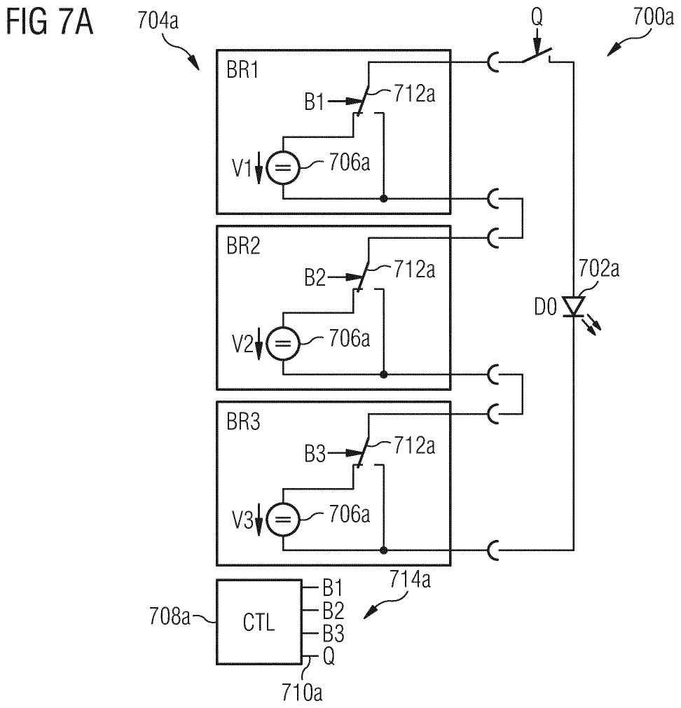

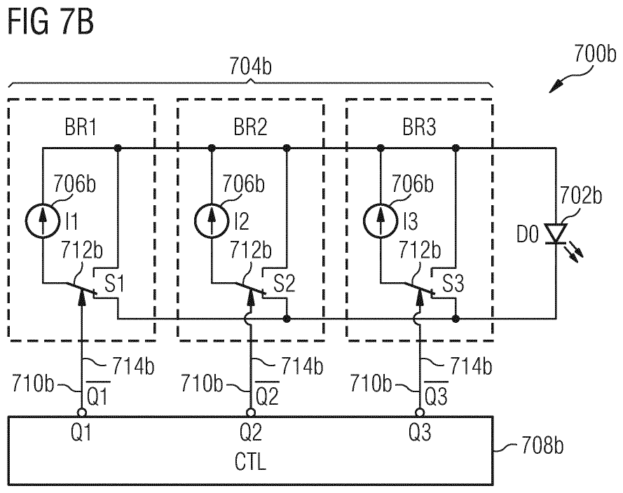

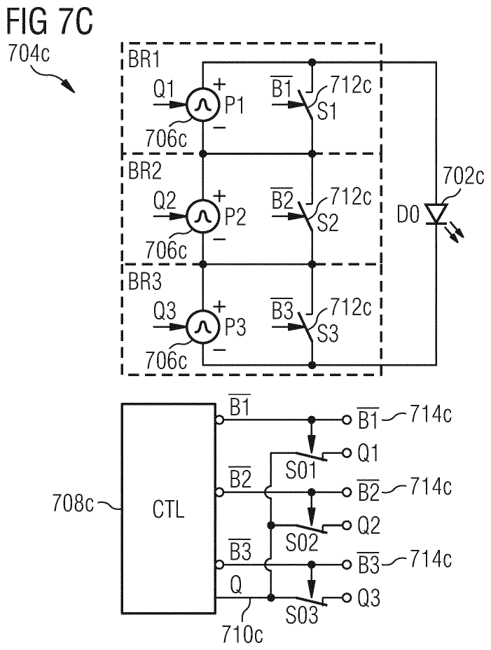

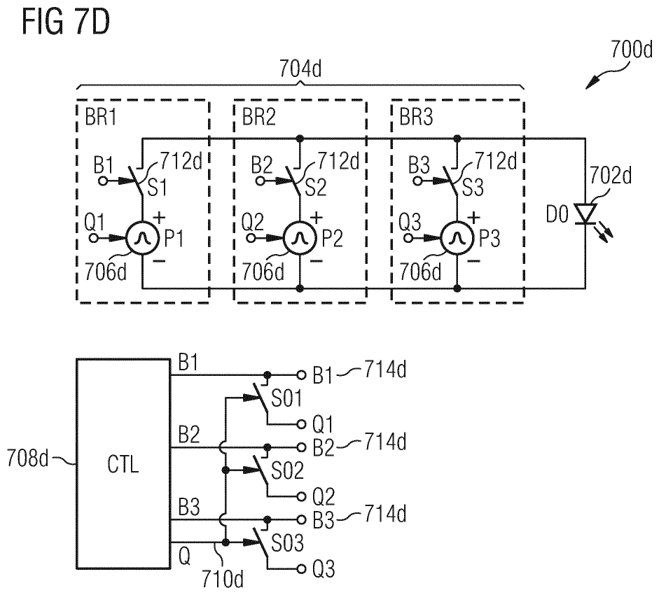

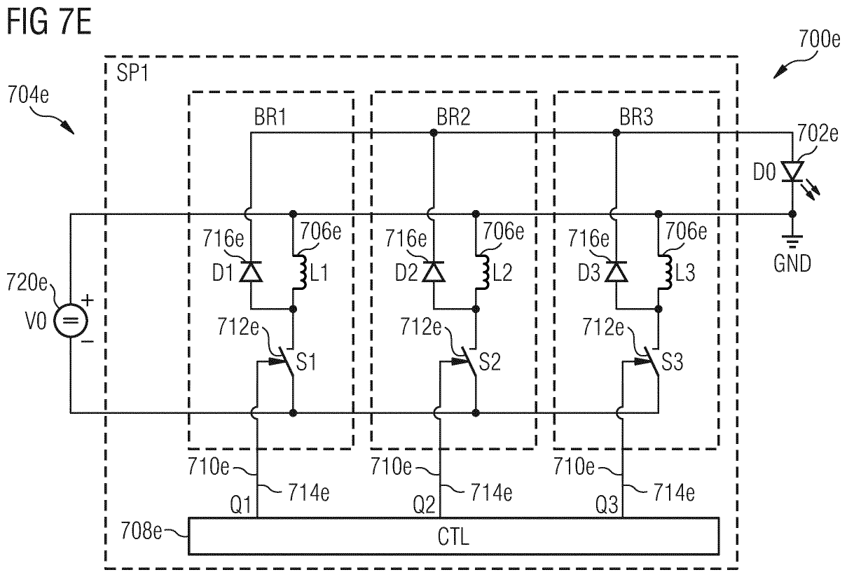

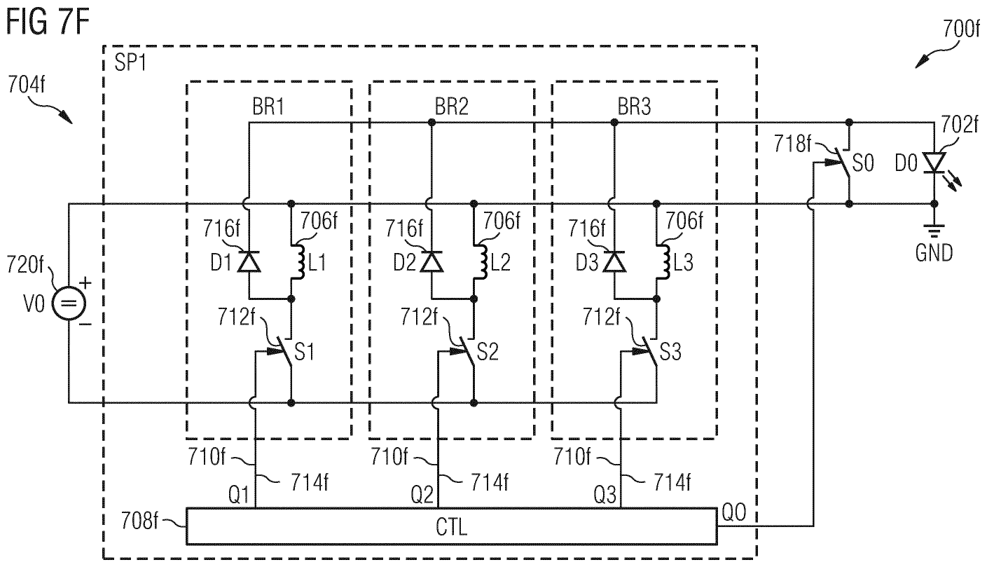

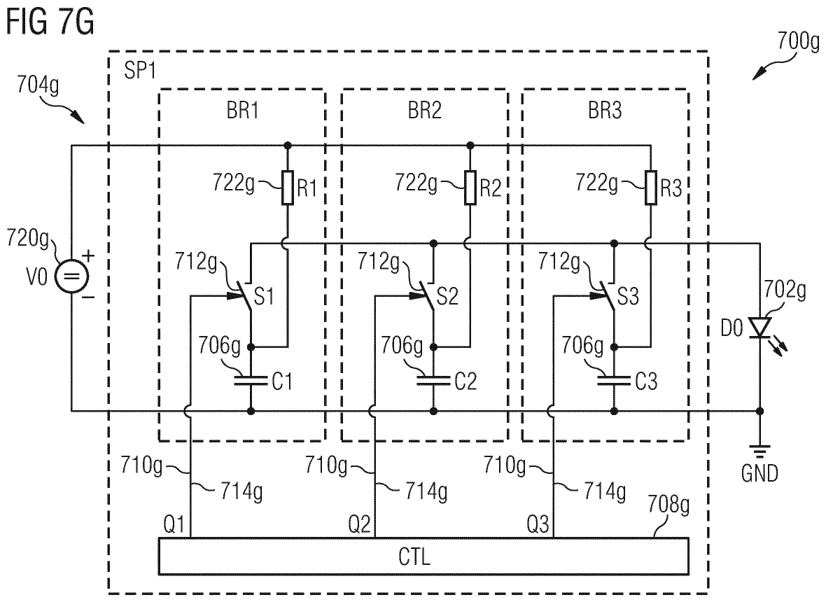

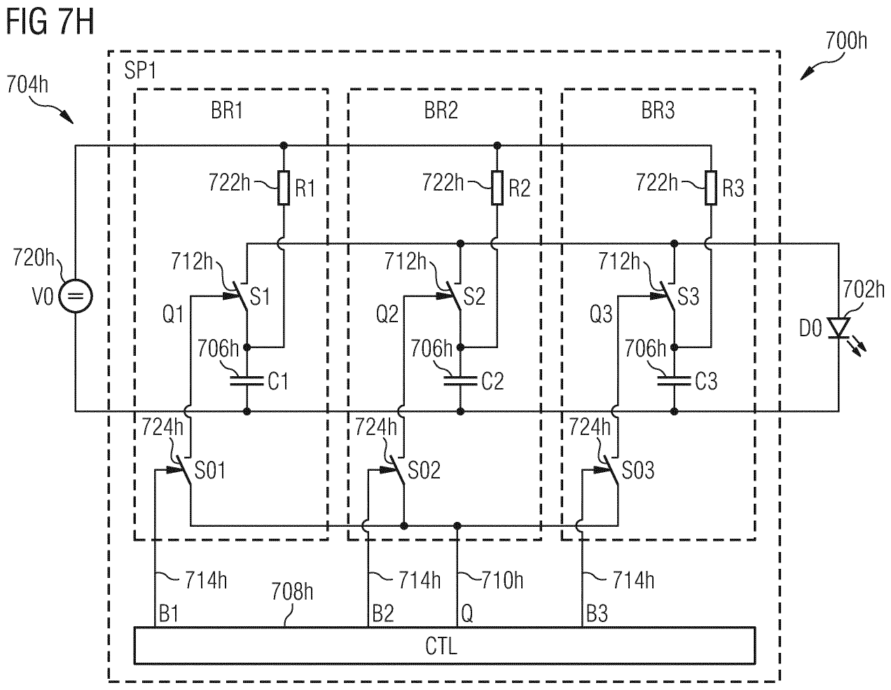

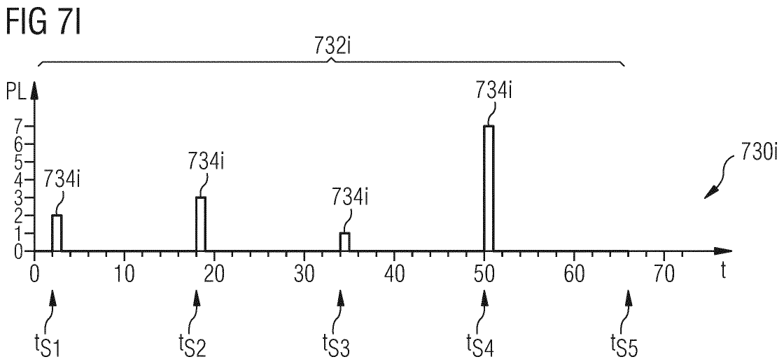

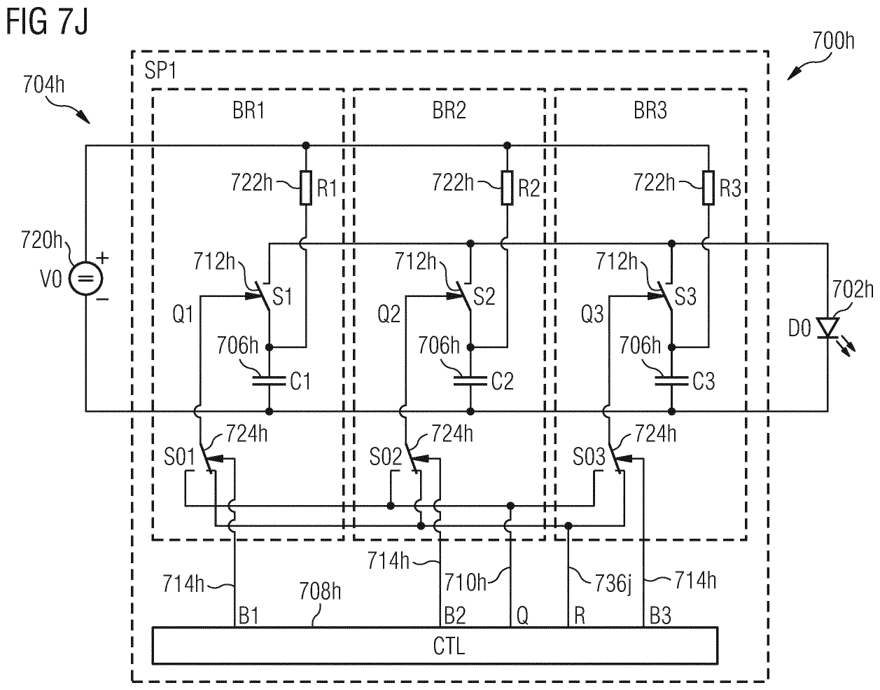

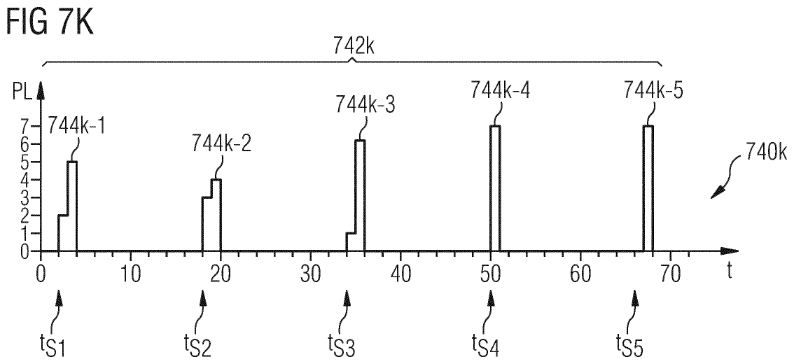

As described above, different approaches may be provided to emit a light signal (e.g., the light signal 204) as a combination of a plurality of partial signals, e.g. an “optical approach” and an “electrical approach”, which will be described in the following. FIG. 4A to FIG. 4F illustrate an “additive optical approach”; FIG. 5A to FIG. 5J illustrate a “subtractive optical approach”; FIG. 6A to FIG. 6C illustrate a “subtractive electrical approach”; and FIG. 7A to FIG. 7J illustrate an “additive electrical approach”. In the following, exemplary implementations are described, to illustrate how to put into practice the principles described herein. It is understood that the configurations shown in the figures are exemplary, and arrangements with additional, less, or alternative components may be provided to provide a combination of a plurality of partial signals (e.g., other configurations of electrical components to provide combinations of a plurality of partial electrical signals and/or other configurations of optical components to provide combinations of a plurality of partial light signals).

FIG. 4A and FIG. 4B each shows a light emitting device 400 in a schematic view according to various aspects. The light emitting device 400 may be configured as the light emitting device 202, e.g. the light emitting device 400 may be an exemplary configuration of the light emitting device 202 described in relation to FIG. 2.

The light emitting device 400 may include a plurality of partial light sources 402, e.g. first to third partial light sources 402-1, 402-2, 402-3 in the exemplary configuration in FIG. 4A and FIG. 4B (collectively referred to as partial light source(s) 402). Each partial light source 402 may be configured to emit light, e.g. may be configured to emit a respective partial light signal 404 (e.g., first to third partial light signals 404-1, 404-2, 404-3 in the exemplary configuration in FIG. 4A and FIG. 4B, collectively referred to as partial light signal(s) 404). Illustratively, a plurality of partial light sources 402 configured to emit respective partial light signals 404 may be understood as the light emitting device 400 being configured to emit a light signal 406 as an optical combination of the individual (partial) light signals emitted by the individual (partial) light sources. The light signal 406 may be an example of the light signal 204, and the partial light signals 404 may be an example of the partial signals described in relation to FIG. 2. The plurality of partial light sources 402 may be an example of light source of a LIDAR module, e.g. of the light source 210 of the LIDAR module 200.

The plurality of partial light sources 402 may include any suitable light source to provide a light signal having optical power in the desired power range. As an example, the plurality of partial light sources 402 may include at least one light emitting diode. As another example, the plurality of partial light sources 402 may include at least one laser diode. The plurality of partial light sources 402 may each include a same type of light source (e.g., each may be a light emitting diode, or a laser diode), or may include different types of light sources (e.g., one partial light source may include a light emitting diode, and another partial light source may include a laser diode, as an example). In the exemplary configuration in FIG. 4A and FIG. 4B, the light emitting device 400 may include three laser diodes 412-1, 412-2, 412-3, D1, D2, D3).

In various aspects, each partial light source 402 may include a respective driving circuit 410 (e.g., first to third driving circuits 410-1, 410-2, 410-3, DE1, DE2, DE3, in FIG. 4A and FIG. 4B, also referred to as driver electronics) configured to drive the partial light source 402 (e.g., the respective diode D1, D2, D3). The respective driving circuit 410 may be configured to receive one or more instructions describing how to control the associated light source, and to drive the associated (e.g., connected) light source as a function of the received instructions. The plurality of driving circuits 410 may be an example of driving circuit of a LIDAR module, e.g. of the driving circuit 212 of the LIDAR module 200.

The configuration in FIG. 4A and FIG. 4B may provide generating desired signal levels, e.g. amplitude levels and/or power levels (e.g., laser power levels), for providing a modulation of the emitted light signal 406.

In various aspects, each partial light source 402 of the plurality of partial light sources 402 may be configured to emit the respective partial light signal 404 at a signal level (e.g., a respective amplitude, or optical power) different from the signal level of the other partial light signals 404 emitted by the other partial light sources 402. Illustratively, each partial light source 402 may be associated with a respective (e.g., unique) signal level, such that the combination of the partial light signals 404 (of some, or all the partial light signals 404) may provide the desired signal level over time of the emitted light signal 406. In the exemplary arrangement in FIG. 4A and FIG. 4B, the light emitting device 400 may be configured to optically combine the light output 404 of three basically identical circuits however with different light levels.

The respective signal levels associated with the different partial light sources 402 may be selected as a function of a desired range for the signal level of the emitted light signal 406 (e.g., taking into account eye safety regulations for example).

In various aspects, a factor of two may be provided for the luminous flux of the different partial light sources 404. Illustratively, at least one partial light source 402 of the plurality of partial light sources 402 (e.g., the second partial light source 402-2) may be configured to emit twice the luminous flux of at least one other partial light source 402 of the plurality of partial light sources 402 (e.g., the first partial light source 402-1). In relation to the configuration of FIG. 4A and FIG. 4B, the second partial light source 402-2 may be configured to emit twice the luminous flux of the first partial light source 402-1, and the third partial light source 402-3 may be configured to emit twice the luminous flux of the second partial light source 402-2. A fourth partial light source would be configured to emit twice the luminous flux of the third partial light source 402-3, etc. The factor for the luminous flux of the different partial light sources 404 may be selected depending on the desired operation, e.g. in other aspects a factor of three may be provided, or a factor of five, as other examples.

In various aspects, the control of the light emitting device 400 to combine the plurality of partial signals may include controlling which partial light sources 402 emit the respective partial light signal 404. The light emitting device 400 may include (or may be connected to) one or more processors 414 (e.g., configured as the one or more processors 206) configured to control a combination of the partial light signals 404 by controlling which partial light sources 402 emit the respective partial light signal 404. Illustratively, the desired signal level of the emitted light signal 406 may be controlled by selecting the partial light sources 402 whose outputs combined provide that signal level. In various aspects, the one or more processors 414 may be part of a control circuit (CTL).

The light emitting device 400 may include an emitter optics arrangement 408 configured to receive the partial light signals 404, and to combine together the partial light signals 404 to emit the light signal 406. The emitter optics arrangement 408 may include suitable optical components (e.g., one or more mirrors, one or more lenses, one or more beam combiners, etc.) configured to direct the received partial light signals 404 along a same direction (such that the received partial light signals 404 overlap to provide the light signal 406).

In an exemplary scenario, in case the combining optics (the emitter optics arrangement 408) forms a single beam (the light signal 406) out of the up to three laser sources (the diodes 412-1 to 412-3) with an electrical-to-optical efficiency of 75%, then the first laser diode may be configured to generate 2 W, the second laser diode may be configured to generate 4 W, and the third laser diode may be configured to generate 8 W of laser power (optical power). It may be assumed that the optical efficiency for the different “branches” is identical, e.g. it may be assumed that the optical efficiency may be 75% irrespective of the “branch” in which the light was generated. The optical efficiency may be determined by considering all the light losses after the light leaves the semiconductor through the primary and secondary optics up to point where the “final light pulse” is generated (e.g., directly in front of the LIDAR module including the light emitting device 400, e.g. the LIDAR module 200).

The additive optical approach considering the scenario above may be illustrated with exemplary values in Table 2.

TABLE 2

| | | | | Cumulated Generated | Optically Emitted |
|---|---|---|---|---|---|
| Level | B3 | B2 | B1 | Optical Power [W] | Pulse Power [W] |
| 0 | 0 | 0 | 0 | 0 | 0 |
| 1 | 0 | 0 | 1 | 2 | 1.5 |
| 2 | 0 | 1 | 0 | 4 | 3 |
| 3 | 0 | 1 | 1 | 6 | 4.5 |
| 4 | 1 | 0 | 0 | 8 | 6 |
| 5 | 1 | 0 | 1 | 10 | 7.5 |
| 6 | 1 | 1 | 0 | 12 | 9 |
| 7 | 1 | 1 | 1 | 14 | 10.5 |

The desired light level “Level” in Table 2 may be determined by the one or more processors 414 (e.g., by the control circuit (CTL)), for example depending on the scene, etc. The binary representation of the desired light level may be identical to the signals B1-B3 (which may be understood as respective control signals provided by the one or more processors 414 to the light sources 402) in case of a 3-bit representation of the light level. In accordance with the configuration shown in FIG. 4A and FIG. 4B, with the branch BR2 contributing to twice the amount of light compared to BR1, and the branch BR3 contributing to twice the amount compared to BR2, the signals B1-B3 may directly select whether or not the associated light source 402 (e.g., the laser diode 412-1 to 412-3, D1-D3) will be provided with power by the respective driving circuit 410-1 to 410-3, DE1-DE3 (also referred to herein as driver electronics). Illustratively, in Table 2 with relation to B1-B3, a “0” may indicate the respective branch, e.g. the respective partial light source 402 being off, and “1” may indicate the respective branch, e.g. the respective partial light source 402 being on. The signals B1-B3 may determine whether the respective branch BR1-BR3 is contributing to the overall light generation or not. The generated light may then be combined (e.g., collimated) by the emitter optics arrangement 408 (also referred to herein as optical element, or optical sub-system, OX1).

According to various aspects, the one or more processors 414 may be configured to control the combination of the partial light signals 404 by providing a respective signal at the partial light sources 402 (e.g., at the respective driving circuit 410). The one or more processors 414 may be configured to generate a gating signal 416 (shown in FIG. 4B, see also FIG. 4E and FIG. 4F) representative of partial light sources to activate as a function the encoded sequence of symbols (e.g., the sequence 208). The use of a gating signal 416 may provide synchronization between the individual branches. Illustratively, the individual control signals (B1, B2, B3) may be applied in a manner that is not timing critical, and the gating signal 416 Q (e.g., the positive or negative edge of the gating signal Q) may ensure that the light sources (e.g., the laser diodes) are fired at once. In various aspects, as shown in FIG. 4E and FIG. 4F, the gating signal 416 may include a plurality of gating signals, e.g. one for each partial light source 402 (e.g., a first gating signal Q1 associated with the first partial light source 402-1, a second gating signal Q2 associated with the second partial light source 402-2, and a third gating signal Q3 associated with the third partial light source 402-3 in this exemplary configuration). The one or more processors 414 may be configured to control the partial light sources 402 by using the gating signal 416. The gating signal 416 may be understood as a control signal (or a plurality of control signals, see FIG. 4E and FIG. 4F) instructing the plurality of partial light sources 402 whether or not to emit the respective partial light signal 404. FIG. 4B, FIG. 4E, and FIG. 4F may illustratively show the concept of “additive optical binary power modulation” with gating signal 416 Q and gating implemented inside the driver electronics.

FIG. 4C and FIG. 4D each shows a graph 420c, 420d illustrating a light signal 422c, 422d emitted according to the additive optical approach, according to various aspects. The light signal 422c, 422d may be represented in terms of signal level (e.g., power level in W, along the vertical axis 426) over time (e.g., in nanoseconds, along the horizontal axis 424).

The light signals 422c, 422d shown in FIG. 4C and FIG. 4D are an example of a possible light signal that may be emitted by the light emitting device 400 described in relation to FIG. 4A and FIG. 4B.

It is understood that the light signals 422c, 422d are shown for illustrative purposes, and also light signals with different configurations (e.g., a different number of pulses, a different signal level, etc.) may be provided. The light signal 422c, 422d may include one or more light pulses 428c, 428d (e.g., first to sixth light pulses 428c-1, 428c-2, 428c-3, 428c-4, 428c-5, 428c-6 for the light signal 422c in FIG. 4C, and first and second light pulses 428d-1, 428d-2 for the light signal 422d in FIG. 4D). Illustratively, FIG. 4C and FIG. 4D show example pulse trains generated by the described setup. Only as an example, the pulse train in FIG. 4C may include several single quasi-rectangular pulses 428c with equally spaced (equidistant) power levels, and the pulse train in FIG. 4D may include several pulses each composed of multiple quasi-rectangular pulse sections with equally spaced (equidistant) power levels. The light signals 422c, 422d (the pulse trains) may be in line with the two types of pulse trains as described in FIG. 3A to FIG. 3E. The light signals 422c, 422d (the pulse trains) may be an example of the emitted light signal 406, and may be configured as the light signals 302a, 302b described in relation to FIG. 3A to FIG. 3E (e.g., the light pulses 428c, 428d may be configured as the light pulses 308a, 308b, 308e-1 to 308e-4).

In addition to the generated light level shown in the graphs 420c, 420d, FIG. 4C and FIG. 4D further illustrate exemplary gating signal(s) provided at the partial light source(s) 404 of the light emitting device 400. FIG. 4C and FIG. 4D show a plurality of graphs associated with a respective gating signal provided at a partial light source. Considering the exemplary configuration of FIG. 4A, FIG. 4B, FIG. 4E, and FIG. 4F, a first graph 430c-1, 430d-1 illustrates a (first) gating signal 432c-1, 432d-1 provided at the first partial light source 402-1, a second graph 430c-2, 430d-2 illustrates a (second) gating signal 432c-2, 432d-2 provided at the second partial light source 402-2, and a third graph 430c-3, 430d-3 illustrates a (third) gating signal 432c-3, 432d-3 provided at the third partial light source 402-3. The gating signals shown in FIG. 4C and FIG. 4D may be an example of the gating signal 416 described in relation to FIG. 4A, FIG. 4B, FIG. 4E, and FIG. 4F.

As shown in FIG. 4C and FIG. 4D a gating signal may assume a first value (e.g., a logic “0”) to instruct the associated partial light source not to emit the respective light signal (illustratively, to turn off the associated partial light source), and may assume a second value (e.g., a logic “1”) to instruct the associated partial light source to emit the respective light signal (illustratively, to turn on the associated partial light source). In the exemplary scenario in FIG. 4C, at time t0 only the third partial light source 404-3 may be emitting light, at time t1 only the first and second partial light sources 404-1, 404-2 may be emitting light, etc. In the exemplary scenario in FIG. 4D, at time t1, a first combination of gating signals may be provided to emit the first light pulse 428d-1 (turning on and off the associated partial light sources within the duration of the first light pulse 428d-1 to achieve the desired modulation), and at time t2, a second combination of gating signals may be provided to emit the second light pulse 428d-2.

The waveforms of the gating signals 432c-1 to 432c-3, 432d-1 to 432d-3, Q1-Q3 may define whether the respecting branch is contributing to the overall light generation at any point in time. As in LIDAR applications the timing may be critical, the generation of these signals may play an important role.

With relation to Table 2, the individual gating signals 432c-1 to 432c-3, 432d-1 to 432d-3, Q1-Q3 may be generated from the signals B1-B3 by gating or masking with the gating signal Q. The gating signal Q may be generated by the one or more processors 414, e.g. by using a clock running at a frequency of 1/T_{R} where T_{R} is the repetition time as described above. Illustratively, the one or more processors 414 may be configured to generate the gating signal 416 by using a same clock signal as the clock signal determining the repetition rate of the light emitting device 400.

The clock may trigger a timer (mono-flop) with pulse train duration T_{T}. The gating may be carried out inside the driver electronics as shown in FIG. 4B, or outside the driver electronics, as shown in FIG. 4E and FIG. 4F.

FIG. 4E and FIG. 4F each shows the light emitting device 400 in a schematic view according to various aspects. FIG. 4E and FIG. 4F show a possible configuration of the light emitting device 400 to implement the gating outside the driver electronics (e.g., with fast switches by AND gates).

According to various aspects, as shown in FIG. 4E, each partial light source 402 may be associated with a respective switch 434. The light emitting device 400 may include a plurality of switches 434, each coupled with a respective partial light source 402 (e.g., each providing a switchable connection between the associated partial light source 402 and a power supply, not shown). In the exemplary configuration in FIG. 4E, the light emitting device 400 may include first to third switches 434-1, 434-2, 434-3 associated with a respective one of the partial light sources 402-1, 402-2, 402-3. The gating signal 416 may include a respective instruction for each switch to connect or disconnect the associated partial light source, e.g. from a power supply (e.g., the power supply may be part of the control circuit of a LIDAR module, e.g. of the LIDAR module 200).

With the configuration in FIG. 4E, gating a signal by another signal may be realized by a signal-controlled switch 434, e.g. by the respective signal-controlled switches 434-1 to 434-3, S1-S3, to generate the individual gating signals Q1-Q3.

In various aspects, the switches 434 may be configured to be fast-switching. As an example, as shown in FIG. 4F, a possible implementation may include using logic gates. Illustratively, at least one switch 434 (in some aspects, each switch 434) may be realized as a logic gate 436, such as an AND gate (e.g., first to third AND gates 436-1, 436-23, 436-3, G1-G3 in this exemplary configuration). AND gates are an example of fast switches for the additive optical approach, and other types of logic gates may be used to provide the same function of selectively turning on or off a partial light source in a fast manner.

In the configuration of the light emitting device 400 described in relation to FIG. 4A to FIG. 4E, the optical power of several branches may be (optically) added to create the light output (the light signal 406) with the desired signal level (e.g., the desired amplitude). The approach may be referred to as “additive optical binary power modulation”, as the overall light output may be composed by adding light with intensities in a binary fashion to create the desired light output.

A different approach, referred to as “subtractive optical approach” will be described with relation to FIG. 5A to FIG. 5J. Instead of adding light, an initial beam of light may also be “split” into multiple beams (for example, with intensity distributions arranged in a binary fashion). By absorbing or redirecting some of the beams in respective “branches” of the optical path a “subtractive optical power modulation” can be realized.

The subtractive optical approach may be illustrated with exemplary values in Table 3 (e.g., assuming the same power levels and efficiencies as described in relation to Table 2), e.g. for the exemplary scenario of the generation of 8 intensity levels using three branches and 75% efficiency.

TABLE 3

| | | | | Cumulated Generated | Optically Emitted |
|---|---|---|---|---|---|
| Level | B3 | B2 | B1 | Optical Power [W] | Pulse Power [W] |
| 0 | 0 | 0 | 0 | 14 | 0 |
| 1 | 0 | 0 | 1 | 14 | 1.5 |
| 2 | 0 | 1 | 0 | 14 | 3 |
| 3 | 0 | 1 | 1 | 14 | 4.5 |
| 4 | 1 | 0 | 0 | 14 | 6 |
| 5 | 1 | 0 | 1 | 14 | 7.5 |
| 6 | 1 | 1 | 0 | 14 | 9 |
| 7 | 1 | 1 | 1 | 14 | 10.5 |

FIG. 5A shows a light emitting device 500 in a schematic view according to various aspects. The light emitting device 500 may be configured as the light emitting device 202 described in FIG. 2, e.g. the light emitting device 500 may be an exemplary configuration of the light emitting device 202 (e.g., additional or alternative to the configuration described in relation to FIG. 4A to FIG. 4F). FIG. 5A illustrates the concept of “subtractive optical binary power modulation”.

The light emitting device 500 may include a light source 502 configured to emit light (e.g., a light signal, also referred to herein as “light beam”, or simply “beam”). The light source 502 may be configured as the light source 202 and/or as one of the (partial) light sources 402 described in in relation to FIG. 2, and FIG. 4A to FIG. 4F. The light source 502 may be an example of light source of a LIDAR module, e.g. of the light source 210 of the LIDAR module 200. As an example, the light source 502 may include a laser diode 504 (D1) configured to emit laser light. The light source 502 may further include a driving circuit 506 (DE1) configured to drive the laser diode 504, e.g. configured as the driving circuit 212, 410 described in relation to FIG. 2, and FIG. 4A to FIG. 4F. The driving circuit 506 may be an example of driving circuit of a LIDAR module, e.g. of the driving circuit 212 of the LIDAR module 200.

The light emitting device 500 may include a beam-splitting device 508 configured to split the light emitted by the light source 502 into a plurality of partial light signals 510. The beam-splitting device 508 may be configured to receive the light emitted by the light source 502 (e.g., by the laser diode 504), and to distribute the received light into a plurality of branches, each associated with a respective partial light signal 510.

In the configuration in FIG. 5A, the light emitting device 500 may include or may be connected to one or more processors 512 (e.g., configured as the one or more processors 206 and/or as the one or more processors 414). In various aspects, the one or more processors 512 may be part of a control circuit of a LIDAR module (e.g., of the LIDAR module 200). The one or more processors 512 may be configured to control the light source 502 (e.g., the driving circuit 506), e.g. via a control signal 514 (CS). The control signal 514 may be configured to control whether the light source 502 (e.g., the laser diode 504) generates light.

The light emitting device 500 may further include an optical arrangement 520 (also referred to herein as optics arrangement, OX1) configured to absorb or redirect one or more of the plurality of partial light signals 510. Illustratively, the optical arrangement 520 may be configured to provide the desired combination of partial light signals 510, by optically controlling which (and how many) partial light signals 510 contribute to the generation of a light signal 516 emitted by the light emitting device 500. The optical arrangement 520 may be configured to absorb or redirect one or more of the plurality of partial light signals 510 as a function of a sequence of symbols to be encoded in the emitted light signal 516 (e.g., as a function of the encoded sequence of symbols 208). In various aspects, the one or more processors 512 may be configured to control the optical arrangement 520 to control the combination of partial light signals 510, as described in further detail below.

The optical arrangement 520 may include one or more optical components to provide the optically “subtractive” function. In the exemplary configuration in FIG. 5A, the optical arrangement 520 may include primary optics 522, a light absorbing device 524, and secondary optics 526. It is understood that the configuration of the optical arrangement 520 described herein is exemplary, to illustrate the subtractive optical approach, and the optical arrangement 520 may include additional, less, or alternative components with respect to those shown, as long as the overall configuration provides controlling a combination of the partial light signals 510 to provide the emitted light signal 516.

The primary optics 522 may be arranged optically upstream of the light absorbing device 524, and may be configured to collect the light emitted by the light source 502 (e.g., may be configured to collect the plurality of partial light signals 510 split by the beam splitting device 508). The primary optics 510 may be the first element of the optical arrangement 520 (the most optically upstream element with respect to the incoming light).

The secondary optics 526 may be arranged optically downstream of the light absorbing device 524 and may be configured to combine the partial light signals (not absorbed or redirected by the light absorbing device 524) to provide the emitted light signal 516.

The light absorbing device 524 may be a controllable light absorbing device configured to receive the plurality of partial light signals 510 (e.g., collected by the primary optics 522). The light absorbing device 524 may be configured to controllably absorb or redirect one or more of the partial light signals 510. Illustratively, in relation to the description of FIG. 2, controlling the light emitting device 500 to combine the plurality of partial signals may include controlling the light absorbing device 524 in accordance with the encoded sequence of symbols (e.g., the sequence 208). As an example, the light absorbing device 524 may include a liquid crystal device (e.g., a liquid crystal polarization grating) or a digital mirror device. A configuration of the light absorbing device 524 will be described in further detail below.

By way of illustration, the operation of the optical arrangement 520 may be described as follows. The primary optics 522 may collect the light emitted by the light source 502. Thereafter, the light may be partially or completely absorbed or redirected by the light absorbing device 524 (also referred to herein as light absorbing element, LAE). The light absorbing device 524 may be realized, for example, by a liquid crystal device/element/matrix similar to a LCD (liquid crystal display), DMD (digital mirror device, also referred to as digital light processing device (DLP) device, or LCPG (liquid crystal polarized grating). A DMD and a LCPG may be configured (e.g., controlled) to redirect the received light (e.g., towards a light absorbing area). The light absorbing device 524 may be controlled by the one or more processors 512, e.g. via signal lines 518 (Q1, . . . , Qn). The remaining light then gets collected by the secondary optics 526 (SO) and finally directed and formed creating the beam 516 leaving the light emitting device 500 (e.g., leaving the LIDAR module).

In the following, reference may be made in general to a light-absorbing area or light-absorbing segment of the light absorbing device 524. A light-absorbing area or light-absorbing segment may describe both a portion configured to directly absorb light (e.g., in the case that the light absorbing device 524 includes a liquid crystal device/element/matrix) and a portion configured to redirect light onto a light-absorbing area (e.g., in the case that the light absorbing device 524 includes a DLP or LCPG).

FIG. 5B, FIG. 5C, FIG. 5D, FIG. 5E each shows a respective light absorbing device 530b, 530c, 530d, 530e in a schematic view according to various aspects. These light absorbing devices 530b, 530c, 530d, 530e may be an exemplary configuration of the light absorbing device 524.

The light absorbing device 530b, 530c, 530d, 530e may include (e.g., may be divided into) a plurality of segments 532b, 532c, 532d, 532e. Each segment 532b, 532c, 532d, 532e may be configured, in a first state, to absorb or redirect light (e.g., a partial light signal 510) impinging onto that segment, and configured, in a second state, to transmit the light (e.g., the partial light signal 510) impinging onto that segment. Illustratively, a segment 532b, 532c, 532d, 532e may be understood as a switchable light-absorbing area, which may be controlled between an “absorbing state” and a “transparent state” to determine whether a partial light signal 510 contributes to the emission of the overall light signal 516. The light-absorbing areas may be associated with the plurality of branches along which the plurality of partial light signals 510 propagate.

The one or more processors 512 may be configured to control the plurality of segments 532b, 532c, 532d, 532e to be in the respective first state or second state as a function of the sequence of symbols to be encoded in the emitted light signal 516 (e.g., as a function of the encoded sequence 208). The one or more processors 512 may be configured to control the plurality of segments 532b, 532c, 532d, 532e to absorb, redirect, or let through the respective partial light signal 510 in accordance with the desired combination of partial light signal 510.

In various aspects, the one or more processors 512 may be configured to provide a gating signal (e.g., a plurality of gating signals Q1, . . . , Qn) to the light absorbing device 530b, 530c, 530d, 530e (e.g., one gating signal for each segment, or for each light-absorbing area), to control the switching of the plurality of segments 532b, 532c, 532d, 532e. Illustratively, the one or more processors may be configured to generate a gating signal representative of which segments 532b, 532c, 532d, 532e to switch in the first state and which segments 532b, 532c, 532d, 532e to switch in the second state, and may be configured to control the light absorbing device 530b, 530c, 530d, 530e by using the gating signal (e.g., provided via the signal lines 518).

The number and the configuration (e.g., the size) of the segments 532b, 532c, 532d, 532e may be adjusted depending on the light emitted by the light source 502. It is understood that the number and configuration of segments 532b, 532c, 532d, 532e shown in FIG. 5B to FIG. 5E are exemplary, and other numbers/configurations may be provided as long as a desired control range over the emitted light may be ensured.

In various aspects, the number of segments may be a function of the selected implementation for the light absorbing device 532b, 532c, 532d, 532e (e.g., a liquid crystal device/element/matrix, DMD, LCPG, etc.). Only as a numerical example, the plurality of segments 532b, 532c, 532d, 532e may include a number of segments in the range from 2 to 20, for example in the range from 4 to 16. It is understood that the plurality of segments 532b, 532c, 532d, 532e may include any suitable number of segments, e.g. also more than 50, or more than 100, or more than 1000 segments depending on the implementation.

FIG. 5B and FIG. 5C may be related to a configuration of a light absorbing device 530b, 530c in case of a rectangular shaped light beam.

In the case that the rectangular shaped light beam has a homogeneous intensity distribution (illustratively, constant intensity over the entire rectangular beam), a light absorbing device 530b with a regular distribution of segments may be provided. For example, as shown in FIG. 5B, a light absorbing device 530b with four controllable areas (four controllable segments 532b, A1-A4) may provide a modulation of the light with 16 intensity levels. The sixteen levels may include a “no light” level and a “full light” level. In the configuration in FIG. 5B and FIG. 5C at least one segment 532b, 532c (e.g., each segment 532b, 532c) may have rectangular shape.

The “binary concept” may be provided by selecting a length of the rectangular segments 532b (e.g., a first length L1 of the first segment 532b-1 A1, a second segment L2 of the second segment 532b-2 A2, a third length L3 of the third segment 532b-3 A3, and a fourth length L4 of the fourth segment 532b-4 A4, assuming a same width W (a same height) for each segment) as follows,

$$L 4 = 2 \times L 3 , \\ L 3 = 2 \times L 3 , \\ L 2 = 2 \times L 1.$$

The length L2 of a second segment 532b-2 may be twice the length Li of a first segment 532b-1. The length L3 of a third segment 532b-3 may be twice the length L2 of the second segment 532b-2. The length L4 of a fourth segment 532b-4 may be twice the length L3 of the third segment 532b-3, etc. Stated in a different fashion, in some aspects, different segments 532b may have a different surface area (e.g., varying by a factor of 2). A first segment 532b-1 may have a first surface area, a second segment 532b-2 may have a second surface area, a third segment 532b-3 may have a third surface area, etc. The second surface area may be greater than the first surface area, the third surface area may be greater than the second surface area, etc. As an example, the second surface area may be at least two times greater (e.g., exactly two times greater) than the first surface area, the third surface area may be at least two times greater (e.g., exactly two times greater) than the second surface area, etc.

As an exemplary scenario, the subtractive approach may be described for the case that the light absorbing device 530b includes an LCD. The one or more processors 508 (e.g., the control circuit) may control the 4 intensity bits (to provide 16 levels). The intensity bits B1-B4 may be assigned to the respective areas 532b-1, 532b-2, 532b-3, 532b-4 (A1-A4). Turning a bit B1-B4 “on” (e.g., having a logic value of “1” for the bit) may include turning “on” the corresponding control line Q1-Q4 (e.g., a corresponding line of the control lines 518) and thereby have the respective area A1-A4 “turned on” for the respective pulse duration Tp. During this pulse time, respective areas (the “turned on” areas) of the LCD may be transparent to light. At other time points (when “turned off”) the areas may absorb the incoming light.

In the case that the rectangular shaped light beam is not homogeneous (e.g., in case it has an inhomogeneous intensity distribution), the distribution of the rectangular segments 532c may be adapted accordingly, as shown in FIG. 5C. A light absorbing device 530c (e.g., a LCD) with segments having a same size may be provided. As an example, as shown in FIG. 5C, a light absorbing device 530c may include 15 sections making up the light-absorbing areas A1-A4. Illustratively, the light absorbing device 530c may include a plurality of segments 532c, and segments 532c disposed in different parts of the light absorbing device 530c may be associated with one another to (virtually) form a light-absorbing area. One or more first segments 532c-1 may form a first light-absorbing area A1, one or more second segments 532c-2 may form light-absorbing area A2, etc. In case of a linear intensity gradient along the long axis of the rectangle the layout shown in FIG. 5C may provide intensity modulated light with matching intensity levels.

In the configurations in FIG. 5C, according to various aspects, the segments 532c may have a same length (L1). Each segment 532c of the plurality of segments has a same surface area as the other segments 532c of the plurality of segments (a first surface area may be equal to a second surface area, equal to a third surface area, etc.), e.g. assuming a same width W for each segment. The total surface area of a light absorbing area may be defined by the number of associated segments 532c.

FIG. 5D and FIG. 5E may be related to a configuration of a light absorbing device 530d, 530e in case of a circular shaped light beam. In this configuration, at least one segment 530d, 530e may have a circular shape (e.g., a central segment of the light absorbing device 530d, 530e). At least one segment 530d, 530e may have a ring shape (e.g., each segment, or each segment other than the central segment, as examples).

In case of a circular shaped light beam with homogeneous intensity distribution (constant intensity over the entire beam) the light absorbing device 500d may be shaped as shown in FIG. 5D. In case of a circular shaped light beam with inhomogeneous (in other words, non-uniform) intensity distribution the light absorbing device 500e may be shaped as shown in FIG. 5E.

For a light absorbing device 530d with an outer radius R covering a dynamic range of n bits (illustratively, having n branches), the n radii Rₖ for each of the concentric segments may be chosen according to the following formula,

$${R}_{k} = \sqrt{\frac{{2}^{k} - 1}{{2}^{n} - 1}} R with k ∈ \{ 1 , … , n \} \qquad ( 2 )$$

With the selection of the radii according to equation (2), the respectively defined areas A1, . . . , An, may provide the binary order A2=2× A1, A3=2× A2, . . . , An=2×A (n−1). Illustratively, as described in relation to FIG. 5B, in the configuration in FIG. 5D a first segment 532d-1 may have a first surface area, a second segment 532d-2 may have a second surface area, a third segment 532d-3 may have a third surface area, etc. The second surface area may be greater than the first surface area, the third surface area may be greater than the second surface area, etc. As an example, the second surface area may be at least two times greater (e.g., exactly two times greater) than the first surface area, the third surface area may be at least two times greater (e.g., exactly two times greater) than the second surface area, etc. The first segment 532d-1 may have a first radius R1, the second segment 532d-2 may have a second radius R2, etc.

As described in relation to the rectangular arrangement in FIG. 5C above, a subdivision of the rings (the segments 532e) into smaller rings (e.g., having a same surface area, see FIG. 5E) and which then jointly create the areas A1-An may be provided in case the light distribution is differing from a homogeneous distribution, e.g. due to tolerances in manufacturing. Illustratively, the light absorbing device 530e may include a plurality of segments 532e, and segments 532e disposed in different parts of the light absorbing device 530e may be associated with one another to (virtually) form a light-absorbing area. One or more first segments 532e-1 may form a first light-absorbing area A1, one or more second segments 532e-2 may form light-absorbing area A2, etc.

For a light absorbing device 530e with an outer radius R covering a dynamic range of n bits (illustratively, having n branches), the 2ⁿ−1 radii Rₖ of the concentric segments may be chosen according to the following formula,

$${R}_{k} = \sqrt{\frac{k}{{2}^{n} - 1}} R with k ∈ \{ 1 , … , {2}^{n} - 1 \} \qquad ( 3 )$$

With the selection according to equation (3) a configuration as shown in FIG. 5E may be provided (e.g., for the exemplary case n=3). The radii defined according to equation (3) may provide segments 532e (e.g., rings) of identical areas. The areas may be lumped together in a binary fashion to make up the areas A1-An. The overall surface areas of the light-absorbing areas formed by the segments 532e may continue to adhere to the binary order A2=2×A1, A3=2×A2, . . . , An=2×A(n−1). The first segment 532e-1 may have a first radius R1, the second segment 532e-2 may have a second radius R2, etc.

In various aspects, a light absorbing device may include a segment configured to be light-absorbing independently of its state, e.g. may include a light-absorbing area configured only to absorb light impinging thereon. This configuration is shown for example in FIG. 5E, with the light absorbing device 530e including a (fourth) segment 532e-4 (providing a fourth light-absorbing area A4) configured to absorb light independently of its state. The (fourth) segment 532e-4 may be used for limiting the light beam by functioning as an aperture.

Other possible configurations of a light emitting device and light absorbing device (e.g., of the light emitting device 500 and light absorbing device 524) will be described in relation to FIG. 5F to FIG. 5J.

FIG. 5F shows the light emitting device 500 in a schematic view according to various aspects.

Often, cost-effective light absorbing elements may have poor temporal reactiveness, e.g. regarding the achievable switching speeds. This poor temporal reactiveness may be also referred to as poor dynamic performance. In various aspects, the gating may be carried out electrically via the gating signal 534 (Q) as shown in FIG. 5F (provided via a gating signal line 534). Illustratively, in some aspects, the one or more processors 512 may be configured to provide the gating signal 534 to the light source 502 (e.g., to the driving circuit 506). In this configuration, the driving circuit 506 (the driving circuit 506) may have a suitable temporal reactiveness (e.g., realizing fast rise and fall times of the current through the laser diode 504, D1).

In the case that the gating is realized electrically, the “no light” level, e.g. the state B1=B2=B3=0, may be dispensed with in controlling the light absorbing element 520, as it may be provided by the light source 502 directly, e.g. creating no light output may be achieved by keeping the gating signal 534 constantly at a level defining that state (e.g., constantly at zero).

The otherwise redundant state B1=B2=B3=0 may then be used to expand the dynamic range by one level at almost no cost. This approach is illustrated in Table 4 and FIG. 5G to FIG. 5I for an exemplary case with eight intensity levels and electrical gating.

TABLE 4

| | | | | | Cumulated | Optically |
|---|---|---|---|---|---|---|
| | | | | | Generated | Emitted |
| | | | | | Optical | Pulse |
| Level | B3 | B2 | B1 | Q | Power [W] | Power [W] |
| 0 | 0 | 0 | 0 | 0 | 14 | 0 |
| 1 | 0 | 0 | 0 | 0−>1−>0 | 14 | 1.31 |
| 2 | 0 | 0 | 1 | 0−>1−>0 | 14 | 2.63 |
| 3 | 0 | 1 | 0 | 0−>1−>0 | 14 | 3.94 |
| 4 | 0 | 1 | 1 | 0−>1−>0 | 14 | 5.25 |
| 5 | 1 | 0 | 0 | 0−>1−>0 | 14 | 6.56 |
| 6 | 1 | 0 | 1 | 0−>1−>0 | 14 | 7.88 |
| 7 | 1 | 1 | 0 | 0−>1−>0 | 14 | 9.19 |
| 8 | 1 | 1 | 1 | 0−>1−>0 | 14 | 10.50 |

FIG. 5G, FIG. 5H, and FIG. 5I each shows a light absorbing device 530g, 530h, 530i in a schematic view according to various aspects. These light absorbing devices 530g, 530h, 530i may be an exemplary configuration of the light absorbing device 524. The light absorbing devices 530g, 530h, 530i may include a plurality of segments 532g, 532h, 532i.

In various aspects, a light absorbing device 530g, 530h, 530i may include a segment 532g-0, 532h-0, 532i-0 configured to be light-transparent independent of its state, e.g. a light absorbing device may include as part of the arrangement a light-transparent area A0. Illustratively, the light absorbing devices 530g, 530h, 530i may be configured as the light absorbing devices 530c, 530d, 530e described in relation to FIG. 5C to FIG. 5E, with the addition of the transparent segment 532g-0, 532h-0, 532i-0. In various aspects, the transparent segment 532g-0, 532h-0, 532i-0 may be a central segment (e.g., may be disposed in the geometric center of the light absorbing device 530g, 530h, 530i). In various aspects, as shown in FIG. 5G, the transparent segment 532g-0 may have a same length L1 and a same width W (and a same area) as the other segments.

As an example, the area A0 may be realized by an area of a liquid crystal device being always turned on and having the same size as the area A1. Realizing A0 by the liquid crystal device and not by a “whole”, the inherent and small absorption of the liquid crystal device in areas where it is turned on also applies to the area A0. This may provide the advantage that manufacturing tolerances will not harm the binary nature of the proposed scheme.

The presence of the additional area A0 may increase the available resolution by one state. This may provide an improvement with respect the previously outlined approach (e.g., shown in FIG. 5B to FIG. 5D), which may be large in case of a small n (illustratively, in case of a small number of bits, for example less than 3 bits). As a numerical example, the resolution improvement for n=2 with originally states from 0 to 3 (a step size of 33%) may be improved to a step size of 25%. As another numerical example, for n=4, the improvement may be from a step size of 1/(2ⁿ−1)=1/7=14.29% to 1/(2ⁿ)=1/8=12.5%.

As shown in FIG. 5H, the light absorbing device 530h may be shaped as described in relation to the light absorbing device 530d shown in FIG. 5D in case of a circular shaped light beam with homogeneous intensity distribution. As shown in FIG. 5I, the light absorbing device 530i may be shaped as described in relation to the light absorbing device 530e shown in FIG. 5E in case of a circular shaped light beam with inhomogeneous intensity distribution.

For the light absorbing device 530h, the radii may be selected according to the following formula,

$${R}_{k} = \frac{1}{\sqrt{{2}^{n - k}}} R with k ∈ \{ 0 , … , n \} \qquad ( 4 )$$

The transparent segment 532h-0 may have a radius R0, the first segment 532d-1 may have a first radius R1, the second segment 532d-2 may have a second radius R2, etc.

For the light absorbing device 530i, the radii may be selected according to the following formula,

$${R}_{k} = \sqrt{\frac{k + 1}{{2}^{n}}} R with k ∈ \{ 0 , … , {2}^{n} - 1 \} \qquad ( 5 )$$

The transparent segment 532i-0 may have a radius R0, the first segment 532i-1 may have a first radius R1, the second segment 532i-2 may have a second radius R2, etc.

Table 5 and Table 6 illustrate exemplary numerical values for the ratios Rₖ/R for n=3 and n=4, respectively, for option 1 (the light absorbing device 530d (no electrical gating), 530h (with electrical gating) shown in FIG. 5D and FIG. 5H), and for option 2 (the light absorbing device 530e (no electrical gating), 530i (with electrical gating) shown in FIG. 5E and FIG. 5I).

TABLE 5

Electrical Gating

| | | | |
|---|---|---|---|
| No | No | Yes | Yes |

Option

| k | 1 | 2 | 1 | 2 |
|---|---|---|---|---|
| 0 | — | — | 0.353553 | 0.353553 |
| 1 | 0.377964 | 0.377964 | 0.5 | 0.5 |
| 2 | 0.654654 | 0.534522 | 0.707107 | 0.612372 |
| 3 | 1 | 0.654654 | 1 | 0.707107 |
| 4 | — | 0.755929 | — | 0.790569 |
| 5 | — | 0.845154 | — | 0.866025 |
| 6 | — | 0.92582 | — | 0.935414 |
| 7 | — | 1 | — | 1 |

TABLE 6

Electrical Gating

| | | | |
|---|---|---|---|
| No | No | Yes | Yes |

Option

| k | 1 | 2 | 1 | 2 |
|---|---|---|---|---|
| 0 | — | — | 0.25 | 0.25 |
| 1 | 0.258199 | 0.258199 | 0.353553 | 0.353553 |
| 2 | 0.447214 | 0.365148 | 0.5 | 0.433013 |
| 3 | 0.68313 | 0.447214 | 0.707107 | 0.5 |
| 4 | 1 | 0.516398 | 1 | 0.559017 |
| 5 | — | 0.57735 | — | 0.612372 |
| 6 | — | 0.632456 | — | 0.661438 |
| 7 | — | 0.68313 | — | 0.707107 |
| 8 | — | 0.730297 | — | 0.75 |
| 9 | — | 0.774597 | — | 0.790569 |
| 10 | — | 0.816497 | — | 0.829156 |
| 11 | — | 0.856349 | — | 0.866025 |
| 12 | — | 0.894427 | — | 0.901388 |
| 13 | — | 0.930949 | — | 0.935414 |
| 14 | — | 0.966092 | — | 0.968246 |
| 15 | — | 1 | — | 1 |

In various aspects, the transparent segment 532g-0, 532h-0, 532i-0 (A0) may be addressable by the one or more processors 512 (e.g., by the control circuit), e.g. the one or more processors 512 may be configured to control the transparent segment 532g-0, 532h-0, 532i-0 to absorb light. This may provide improving the heat spreading inside the light absorbing device 530g, 530h, 530i. The energy of the absorbed light within the light absorbing device 530g, 530h, 530i may lead to heating of the light absorbing device.

As increased temperatures may shorten a component life proper thermal management is important, and may be even more critical for a light absorbing device with circular-shaped areas than for a light absorbing device with rectangular shaped areas.

FIG. 5J shows the light emitting device 500 in a schematic view according to various aspects.

In the configuration of the light emitting device 500 in FIG. 5J, the transparent segment (e.g., the transparent segment 532g-0, 532h-0, 532i-0 (A0) described in relation to FIG. 5G to FIG. 5I) may be addressable by the one or more processors 512 via a respective (dedicated) signal line 518-0 (B0).

Whenever an uneven power level is set (illustratively, a power level that would turn off the area A1), the one or more processors 512 may be configured to flip A0 and A1 on a regular basis (e.g., system clock-based, or with the repetition frequency of a line of the entire image). Illustratively, the one or more processors 512 may be configured to alternatively turn on and off A0 and A1, so that one of the two areas is transparent whereas the other is absorbing.

An additional or alternative option, in some aspects, A0 may be only half of the size of A1. In combination with the addressing via B0, this may provide a setup having double the resolution. The improved resolution may be “traded” for a slightly worse thermal behavior.

Additionally or alternatively to the “optical approach” described in relation to FIG. 4A to FIG. 5J, a light emitting device may be configured according to an “electrical approach” for providing an emitted light signal with a desired modulation, as described in further detail below. A “subtractive electrical approach” is described in relation to FIG. 6A to FIG. 6C, and an “additive electrical approach” is described in relation to FIG. 7A to FIG. 7K. It is understood that the configurations of the light emitting devices shown in FIG. 6A to FIG. 7K are exemplary to illustrate the principles of the electrical approach, and a light emitting device may include additional, less, or alternative components with respect to those shown, configured to provide the desired “subtractive” or “additive” function.

FIG. 6A, FIG. 6B, and FIG. 6C each shows a light emitting device 600a, 600b, 600c in a schematic view according to various aspects. The light emitting devices 600a, 600b, 600c may be configured as the light emitting device 202 described in FIG. 2, e.g. the light emitting devices 600a, 600b, 600c may be an exemplary configuration of the light emitting device 202 (e.g., additional or alternative to the configuration described in relation to FIG. 4A to FIG. 5J).

The light emitting device 600a, 600b, 600c may include a light source 602a, 602b, 602c configured to emit light (e.g., a light signal). The light source 602a, 602b, 602c may be configured as the light source 210 described in FIG. 2, e.g. as one of the (partial) light sources 402 described in in relation to FIG. 4A to FIG. 4F. As an example, the light source 602a, 602b, 602c may be or may include a laser diode (D1) configured to emit laser light (or a plurality of laser diodes, e.g. an array or a stack of laser diodes).

The electrical approach may include an adaptation of a driving circuit used to drive the light source 602a, 602b, 602c.

The light emitting device 600a, 600b, 600c may include a (adapted) driving circuit 604a, 604b, 604c configured to drive the light source 602a, 602b, 602c, e.g. configured to provide an electrical signal to the light source 602a, 602b, 602c. A signal level of the emitted light signal may be dependent on a signal level of the electrical signal provided to the light source 602a, 602b, 602c. Illustratively, a modulation of the electrical signal used to drive the light source 602a, 602b, 602c may provide the desired modulation of the emitted light signal. The driving circuit 604a, 604b, 604c may be an example of driving circuit of a LIDAR module, e.g. of the driving circuit 212 of the LIDAR module 200.

The electrical signal may include a current signal (e.g., a current pulse), a voltage signal (e.g., a voltage pulse), or a power signal (e.g., a power pulse), depending on the configuration of the driving circuit 604a, 604b, 604c, as described in further detail below. A power signal or power pulse may be understood as an energy per unit time that is transferred to the light source 602a, 602b, 602c.

The light emitting device 600a, 600b, 600c may include one or more processors 606a, 606b, 606c configured to control the driving circuit 604a, 604b, 604c, e.g. to control the modulation of the electrical signal. The one or more processors 606a, 606b, 606c may be configured as the one or more processors 206 (and/or as the one or more processors 414, 512), e.g. may be an exemplary configuration of the one or more processors 206.

In various aspects, the driving circuit 604a, 604b, 604c may be configured such that the electrical signal is split into a plurality of partial electrical signals. The control of the light emitting device 600a, 600b, 600c to combine the plurality of partial signals may include the one or more processors 606a, 606b, 606c being configured to control the driving circuit 604a, 604b, 604c to combine the plurality of partial electrical signals. Illustratively, the one or more processors 606a, 606b, 606c may be configured to control which partial electrical signals contribute to the driving of the light source 602a, 602b, 602c to emit the light signal.

In various aspects, the driving circuit 604a, 604b, 604c may include an electrical energy source 608a, 608b, 608c configured to generate an electrical signal. As an example, the electrical energy source 608a, 608b, 608c may be or include a current source (FIG. 6A), a voltage source (FIG. 6B), or a power source (FIG. 6C, e.g. a RF power source). The driving circuit 604a, 604b, 604c may include a splitting circuit 610a, 610b, 610c configured to split the electrical signal into the plurality of partial electrical signals.

By way of illustration, in analogy to the optical approach of “subtractive optical binary power modulation”, a “subtractive electrical binary power modulation” may be provided, in which an electrical pulse source is generating a pulse which is attenuated electrically/electronically in a binary fashion before being applied to the light source (e.g., the laser diode).

There may be various possibilities for circuits and systems configured to consecutively split a pulse (e.g., current, voltage, power) into two pulses of identical magnitude. In the following, in relation to FIG. 6A to FIG. 6C, possible configurations of the splitting circuit 610a, 610b, 610c are provided, but it is understood that other configurations may be possible.

Depending on the selected output level, the first pulse either contributes to the output signal or is ignored (e.g., short or open circuit or dissipated in a resistor). The second pulse may be split further into two pulses. The nested/consecutive splitting may be performed as many times as the number of bits (and the resolution) of the application require.

Illustratively, the splitting circuit 610a, 610b, 610c may be configured such that a first partial electrical signal and a second partial electrical signal are in a first relationship with one another, and such that the second partial electrical signal and a third partial electrical signal are in the first relationship with one another (and a fourth partial electrical signal and the third partial electrical signal are in the first relationship, etc.). As an example, the first relationship may include the first partial electrical signal having a first signal level (e.g., a first amplitude) two times smaller than a second signal level of the second partial electrical signal (and the second signal level being two times less than the third signal level, etc.). It is understood that other “splitting” (other relationships) may be provided, e.g. a one-third or a one-fourth relationship, as other examples.

There may be two ways of handling the “last” “second pulse” of this consecutive splitting action.

As a first option, the last second pulse may be handled identically to the “last” “first pulse” and therefore selectively (e.g., depending on signal status “B0”) contributing to the output or not. This configuration may enable turning off all contributions from all branches. With this configuration a pulse with zero magnitude at the output may be provided, e.g. by controlling the signal lines B0, . . . , Bn (in other words, the output may be turned off by commanding the signal lines B0, . . . , Bn).

As a second option, the last second pulse may be contributing to the output signal in any case. In this configuration, the “switching circuitry” in the path of the last second pulse may be dispensed with, thus reducing cost and complexity. This arrangement may include gating the pulse source to turn the pulse fully off (illustratively, to generate a pulse with zero amplitude), for example via “blanking” of the signal Q commanding the pulse generator to deliver a pulse.

For both the first option and the second option, the output pulse can be varied between zero and the full pulse in steps of 1/((2ⁿ)−1) of the full pulse. The magnitude of the full pulse may be assumed to be substantially equal to the magnitude of the initially generated pulse minus the unintentional losses of the circuitry.

As an exemplary implementation, in some aspects, the splitting circuit 610a, 610b may include one or more transformers 612a, 612b, as shown in FIG. 6A and FIG. 6B. The one or more transformers 612a, 612b may be adapted to provide the desired splitting of the electrical signal. For example, at least one transformer of the one or more transformers 612a, 612b may have a winding ratio of 1:1. For example, at least one transformer of the one or more transformers 612a, 612b may have a winding ratio of 2:1:1. The winding ratios of the one or more transformers 612a, 612b may be adapted as a function of the splitting to be provided.

As another exemplary implementation, in some aspects, the splitting circuit 610c may include one or more power splitters 614c, as shown in FIG. 6C. Each power splitter 614c may be associated with a respective partial electrical signal. In various aspects, each power splitter 614c may be associated with a respective adjustable phase and adjustable attenuation circuit 624c (AA1-AA3) configured to delay and/or attenuate the respective partial electrical signal, as described in further detail below. An adjustable phase and adjustable attenuation circuit 624c AA0 may be provided (in addition) for the last second pulse.

In various aspects, the splitting circuit 610a, 610b, 610c may include a plurality of switches 616a, 616b, 616c (S1, . . . , S4). The plurality of switches 616a, 616b, 616c may be configured to connect or disconnect a respective electrical path associated with one of the partial electrical signals. Illustratively, the plurality of switches 616a, 616b, 616c may be configured to allow or prevent a respective electrical signal from contributing to the generation of the electrical signal provided at the light source 602a, 602b, 602c.

The one or more processors 606a, 606b, 606c may be configured to control the combination of the plurality of partial electrical signals by controlling the plurality of switches 616a, 616b, 616c. The one or more processors 606a, 606b, 606c may be configured to control the plurality of switches 616a, 616b, 616c via a plurality of signal lines 628a, 628b, 628c (e.g., one signal line for each switch, illustratively one signal line for each “bit”).

In various aspects, the one or more processors 606a, 606b, 606c may be configured to generate a gating signal (Q) representative of which switches 606a, 606b, 606c are to be activated to connect the respective electrical path, and may be configured to control the plurality of switches 606a, 606b, 606c by using the gating signal. Illustratively, the splitting circuit 610a, 610b, 610c may provide along each electrical path a respective partial electrical signal having a respective signal level (e.g., with a factor of two between different partial electrical signals), and the controlling of the switches 616a, 616b, 616c may provide controlling which partial electrical signals contribute to driving the light source 602a, 602b, 602c to provide the desired modulation of an emitted light signal. The one or more processors 606a, 606b, 606c may be configured to provide the gating signal (Q) via a gating signal line 630a, 630b, 630c. In various aspects, the gating signal line 630a, 630b, 630c may also be used by the one or more processors 606a, 606b, 606c to provide a trigger signal (to the electrical energy source 608a, 608b, 608c), and may be understood also as a trigger signal line.

The exemplary configuration in FIG. 6A illustrates subtractive electrical binary power modulation with n=2 by current splitting. The driving circuit 604a may generate pulses with 3 amplitude levels, and an additional (fourth) level may be zero (illustratively, no light output at all). In the configuration in FIG. 6A, the pulse magnitude may be selected with a step size of n=2 bits, leading to a total of 4 possible levels.

Triggered by the signal Q from the one or more processors 606a (the control CTL) the current source 608a (I1) may generate a pulse. An exemplary pulse waveform of such a pulse is shown in the graph 618a in FIG. 6A.

A first transformer 612a (TR2) with a winding ratio of 1:1 may split the incoming current into two currents of equal amplitude. In various aspects, the wires of the two windings may be wound around the body of the core together (a so-called bifilar-wound). This may provide a good coupling between the two windings of the first transformer 612a (TR1). The current in the upper winding may flow through a first diode 620a (D31) and then through the light source 602a (the laser diode D1 or a stack of laser diodes) and then back to the source 608a, unless the respective switch 616a (S3) is closed. In the case that the respective switch 616a (S3) is closed, then the current may flow through the switch 616a (S3) directly back to the source 608a. The first diode 620a (D31) may be reverse biased and may block any current potentially coming from the light source 602a, allowing other branches of the circuit to feed the light source 602a.

The current in the lower winding of the first transformer 612a (TR2) get split by a second transformer 612a (TR1) into two currents of equal amplitude flowing out of the upper and lower winding of the second transformer 612a (TR1). As the current out of the lower winding of the second transformer 612a (TR1), in this configuration, may be the “last second pulse” according to the above description the respective switch 616a (S1) may be dispensed with, as the “complete darkness” (no current through the light source 602a) may be realized by “blanking” of the signal Q (as described for the second option above).

In the case the switch 616a (S1) is present, it may swap its function with another switch 616a (S2) from time to time, e.g. as described in relation to the addressable A0 and the toggling of A0 and A1. This may provide a better thermal homogeneity of the circuitry.

The exemplary configuration in FIG. 6B illustrates subtractive electrical binary power modulation with n=3 by voltage splitting.

The circuit 604b may be configured to generate pulses with 7 amplitude levels, and an additional (eighth) level may be zero (illustratively, no light output at all). The pulse magnitude may be selected with a step size of n=3 bits, leading to a total of 8 possible levels.

Triggered by the signal Q from the one or more processors 606b (the control CTL) the voltage source 608b (V1) may generate a pulse. A first transformer 612b (TR3), e.g. with a winding ratio of 2:1:1, may split the incoming voltage into two voltages of equal amplitude on its two secondary windings. In various aspects, four wires may be wound around the body of the core together, and then two of them may be serially connected forming the primary winding, and the two other windings may form the two secondary windings. This configuration may provide good coupling between the windings. The voltage of the upper secondary winding may be selected to be part of the voltage applied to the light source 602b (the laser diode D1) by the respective switch 616b (S4) connected to this winding. The voltage generated on the lower secondary winding may be feeding the primary winding of a second transformer 612b (TR2) for further splitting. The voltages of the selected secondary windings of all the transformers may add up to the voltage applied to the light source 602b.

A (e.g., reverse biased) diode 620b (D2) may be dispensed with (e.g., assuming ideal components). If present, the diode 620b (D2) may be configured to protect the light source 602b against reverse voltages that may be potentially generated by ringing effects.

As described in relation to the current splitting setup in FIG. 6A, the switch 616b (S1) associated with the “last second pulse”, illustratively the switch 616b (S1) associated with the lower secondary wining of a third (e.g., last in this configuration) transformer 612b (TR1) may be dispensed with, or, if present, used to provide thermal homogeneity, as an example.

The exemplary configuration in FIG. 6C illustrates subtractive electrical binary power modulation with n=3 by power splitting.

The circuit 604c may be configured to generate pulses with 7 amplitude levels, and an additional (eighth) level may be zero (illustratively, no light output at all). The pulse magnitude may be selected with a step size of n=3 bits, leading to a total of 8 possible levels.

Triggered by the signal Q from the one or more processors 606c (the control CTL) the power source 608c (P0) may generate a pulse. The power source 608c may also be referred to herein as pulse power source, or pulse power generator. The power source 608c (P0) may be configured to provide a pulse with a defined amount of energy, irrespective of the connected load. The pulse may be split by a first power splitter 614c (PS3). A power splitter may also be referred to as power divider.

The two pulses of equal magnitude may be fed to either the switch 616c (S3) associated with the first power splitter 614c (PS3), or to a second power splitter 614c (PS2). Based on the signal B3 provided to the switch 616c (S3) associated with the first power splitter 614c (PS3), the switch 616c (S3) either dumps the pulse into a first dummy load 622c (DL3) or feeds it into a respective (first) adjustable phase and adjustable attenuation circuit 624c (AA3).

An adjustable phase and adjustable attenuation circuit 624c may be configured to delay the pulse as well as to attenuate the pulse. As an exemplary implementation, an adjustable phase and adjustable attenuation circuit may include delay lines, power resistors, and impedance matching networks.

Both functionalities, e.g. manipulating amplitude and phase of the RF signal, may allow tuning of the circuit in such a way that each branch truly contributes the respective fraction of power to the overall pulse after the final output pulse has been created by the power combiners 626c (PC1 to PC3). The output pulse may be then fed to the light source 602c (the laser diode D1). In various aspects, an impedance matching network may be provided so that that ideally the entire power of the pulse may be absorbed by the light source 602c (and no power is reflected back towards the power source 608c).

An additional or alternative “electrical approach” based on an “additive” combination of a plurality of partial electrical signals will be described in relation to FIG. 7A to FIG. 7K. By way of illustration, in analogy to the subtractive electric binary power modulation, the additive approach may include aggregating electricity originating from multiple branches of the circuit, each branch including a source of electrical energy, into the “final” electrical pulse which is then provided to the light source (e.g., the laser diode), thereby emitting the desired optical pulse.

FIG. 7A, FIG. 7B, FIG. 7C, FIG. 7D, FIG. 7E, FIG. 7F, FIG. 7G, and FIG. 7H each shows a light emitting device 700a, 700b, 700c, 700d, 700e, 700f, 700g, 700h (in the following, 700a-700h) in a schematic view according to various aspects. The light emitting devices 700a-700h may be configured as the light emitting device 202 described in FIG. 2, e.g. the light emitting devices 700a-700h may be an exemplary configuration of the light emitting device 202 (e.g., additional or alternative to the configuration described in relation to FIG. 4A to FIG. 6C).

The light emitting device 700a-700h may include a light source 702a, 702b, 702c, 702d, 702e, 702f, 702g, 702h (in the following, 702a-702h) configured to emit light (e.g., a light signal). The light source 702a-702h may be configured as the light source 210 described in FIG. 2, e.g. as one of the (partial) light sources 402 described in in relation to FIG. 4A to FIG. 4F. As an example, the light source 702a-702h may be or may include a laser diode (D1) configured to emit laser light (or a plurality of laser diodes, e.g. an array or a stack of laser diodes).

The additive electrical approach may include an adaptation of a driving circuit used to drive the light source 702a-702h.

The light emitting device 700a-700h may include a (adapted) driving circuit 704a, 704b, 704c, 704d, 704e, 704f, 704g, 704h (in the following, 704a-704h) configured to drive the light source 702a-702h, e.g. configured to provide an electrical signal to the light source 702a-702h. The driving circuit 704a-704h may be an example of driving circuit of a LIDAR module, e.g. of the driving circuit 212 of the LIDAR module 200.

In the configuration according to the additive electrical approach, the driving circuit 704a-704h may include a plurality of electrical energy sources 706a, 706b, 706c, 706d, 706e, 706f, 706g, 706h (e.g., a plurality of current sources, and/or a plurality of voltage sources, and/or a plurality of power sources, and/or a plurality of energy storage elements), in the following 706a-706h. Each electrical energy source 706a-706h may be configured to generate a respective partial electrical signal. Illustratively, the additive electrical approach may be based on controlling which (and how many) electrical energy source 706a-706h provides the respective electrical signal for driving the light source 702a-702h. In various aspects, the plurality of electrical energy sources 706a-706h may be connected in series with one another. In other aspects, the plurality of electrical energy sources 706a-706h may be connected in parallel with one another. In general, two basic approaches or circuitry types may be distinguished for additive electrical binary power modulation: series connection or parallel connection of sources contributing to the final electrical pulse. It is understood that also a combination of serially and parallel connected sources may be provided.

In various aspects, each electrical energy source 706a-706h may be configured to provide the respective partial electrical signal having a signal level different from the other partial electrical signals provided by the other electrical energy sources 706a-706h. Illustratively, the plurality of electrical energy sources 706a-706h may be configured in such a way that each electrical energy source generates an electrical signal having a specific signal level (e.g., a current value, a voltage value, an amplitude value). This configuration may allow providing a (combined) electrical signal having a desired signal level at the light source 702a-702h by selecting which electrical energy sources 706a-706h are active, thus enabling binary modulation (in a similar manner as described above for the optical approach in Table 2).

As described above for the optical approach and the subtractive electrical approach, a defined relationship between the signal levels associated with different electrical energy sources 706a-706h may be provided, so that a defined modulation may be imposed to the electrical signal provided at the light source 702a-702h. A first electrical energy source may be associated with a first signal level, a second electrical energy source may be associated with a second signal level, a third electrical energy source may be associated with a third signal level, etc. The first signal level may be in a first relationship with the second signal level, the second signal level may be in the first relationship with the third signal level, etc.

As an example, the first relationship may include the first signal level being two times less than the second signal level, the second signal level being two times less than the third signal level, etc. It is understood that other relationships may be provided, e.g. a one-third or a one-fourth relationship, as other examples.

The light emitting device 700a-700h may include (or may be connected to) one or more processors 708a, 708b, 708c, 708d, 708e, 708f, 708g, 708h, (e.g., configured as the one or more processors 206, e.g. part of a control circuit CTL), in the following 708a-708h. According to the additive electrical approach, the control of the light emitting device 700a-700h to combine the plurality of partial signals may include the one or more processors 708a-708h being configured to control the plurality of electrical energy sources 706a-706h to generate the respective partial electrical signal.

In various aspects, the one or more processors 708a-708h may be configured to generate a gating signal representative of which electrical energy sources 706a-706h to activate to emit the respective partial electrical signal, and may be configured to control the plurality of electrical energy sources by using the gating signal (e.g., provided to the driving circuit 704a-704h via one or more gating signal lines 710a, 710b, 710c, 710d, 710e, 710f, 710g, 710h). In the configuration in FIG. 7C, FIG. 7D, and FIG. 7H, the gating signals Q1-Q3 to control the electrical energy sources 706c, 706d, 706h may be generated via a gating signal Q (provided via the gating signal line 710c, 710d, 710h) from the signals B1-B3 (provided via the signal lines 714c, 714d, 714h) using signal switches S01-S03 (e.g., as described in relation to FIG. 4E).

In various aspects, each electrical energy source 706a-706h may be associated with (e.g., connected to) a respective switch configured to connect or disconnect the associated electrical energy source 706a-706h to a respective electrical path. Illustratively, the light emitting device 700a-700h may include a plurality of switches 712a, 712b, 712c, 712d, 712e, 712f, 712g, 712h, each configured to open or close a respective electrical path connecting an electrical energy source 706a-706h with the light source 702a-702h.

The gating signal generated by the one or more processors 708a-708h may be representative of which switches 712a-712h to activate (illustratively, to close) to connect the associated electrical energy source 706a-706h to the respective electrical path. The control of the switches 712a-712h may provide controlling which electrical energy sources 706a-706h may deliver the respective electrical signal to the light source 702a-702h, providing the desired modulation of the emitted light signal. The one or more processors 708a-708h may control the switches 712a-712h via a plurality of signal lines 714a, 714b, 714c, 714d, 714e, 714f, 714g, 714h (e.g., one signal line for each switch, e.g. one signal line for each “bit”). In various aspects, the gating signal lines 710a-710h may be used as signal lines 714a-714h.

In various aspects, as shown in FIG. 7E to FIG. 7H, the plurality of electrical energy sources 702e-702h may include at least one electrical energy storage element (e.g., an inductor or a capacitor). In some aspects, each electrical energy source 702e-702h may be or may include an electrical energy storage element, e.g. the plurality of electrical energy sources 702e-702h may include a plurality of electrical energy storage elements (e.g., a plurality of inductors and/or a plurality of capacitors). In this configuration, the generation of the respective partial electrical signal may include a discharge of the electrical energy storage element.

Depending on the impedance of the used electrical energy sources 706a-706h (or in case of a combination of series and parallel connection of sources the impedance of the resulting “stitched” sources may be considered), ether a serial connection or a parallel connection may be more suited in terms of energy efficiency (e.g., to have as least energy as possible provided by one source dissipated in another source of the circuit). In the case that the sources 706a-706h have a relatively low impedance, e.g. in case of sources that may be well modelled by voltage sources, a series connection of sources may be provided (see FIG. 7A). In the case that the sources 706a-706h have a relatively high impedance, e.g. current sources, a parallel connection may be provided (see FIG. 7B).

The light emitting device 700a in FIG. 7A may illustrate, as an example, a circuit arrangement with n=3 (branches BR1-BR3, or “bits”), realizing a LIDAR emitter featuring light pulses (e.g., laser pulses) with 8 intensity levels (e.g., the level 0 may correspond to no light output at all). The three branches may be basically identical except for the component values of the voltage sources 706a (V1-V3). Depending on the desired output level, some of the sources 706a may be connected in series to make up the final voltage applied to the light source 702a (e.g., the laser diode). This approach may be referred to herein as additive electrical binary power modulation by voltage aggregation.

In the case that the light source 702a has an approximately linear characteristic between applied voltage and flux of the emitted light, the voltage of a branch may be selected to be approximately twice the voltage of the preceding branch (the voltage V2 of the second branch may be twice the voltage V1 of the first branch, the voltage V3 of the third branch may be twice the voltage V2 of the second branch, etc.):

$$V 2 \sim 2 \times V 1 , \\ V 3 \sim 2 \times V 2.$$

In a real case scenario, a laser diode may not behave as a voltage source. To take into account this deviation from the ideal behavior, the final selected values for the voltage signals provided by the voltage sources 706a may be tuned based on the laser diode or laser diodes used as light source 702a (e.g., a series connection, a parallel connection, or a combination of series and parallel connection of laser diodes).

The light emitting device 700b in FIG. 7B may illustrate, as an example, a circuit arrangement according to the additive electrical binary power modulation by current aggregation with n=3, realizing a LIDAR emitter featuring light pulses (e.g., laser pulses) with 8 intensity levels (e.g., level 0 may correspond to no light output at all). The three branches BR1-BR3 may be basically identical except for the component values of the current sources 706b (I1-I3). In analogy to the voltage aggregation, for current aggregation multiple current sources 706b may be connected in parallel to make up the current provided to the light source 702b (e.g., to the laser diode(s)). Depending on the desired output level the number of utilized current sources 706b may be controllably varied.

As laser diodes (and alternatively used light emitting diodes) exhibit an approximately linear characteristic between applied current and flux of the emitted light, the current of a branch may be selected to be approximately twice the current of the preceding branch (the current I2 of the second branch may be twice the current I1 of the first branch, the current I3 of the third branch may be twice the current I2 of the second branch, etc.):

$$I 2 \sim 2 \times I 1 , \\ I 3 \sim 2 \times I 2.$$

The final selected values may be tuned based on the laser diode or laser diodes used as light source 702b (e.g., a series connection, a parallel connection or a combination of series and parallel connection of laser diodes).

There is another consideration to be made when looking at additive electrical power modulation, namely the time-characteristics of the sources 706a-706h.

In the case that the characteristics of the sources are 706a-706h are substantially time-independent, switches 712a-712h may be utilized to connect and disconnect the sources 706a-706h to the light sources 702a-702h (e.g., to the laser diode(s)).

Substantially time-independent may be understood as the voltage or current not changing significantly over time after “loading” the source, e.g. in case of “ideal” voltage sources or “ideal” current sources. In this case, the resulting light pulse may be mainly shaped by the switches of the circuitry.

In the case of sources 706a-706h that may be “drained” and only provide a limited amount of energy, thus having a time-dependent contribution, the shape of the light pulse is not only shaped by switching actions of the circuitry, but may also be significantly impacted by the time-behavior of the sources contributing to the “final” electrical pulse.

In various aspects, as shown in the light emitting device 700c, 700d in FIG. 7C and FIG. 7D, pulse sources 706c, 706d providing distinct amounts of energy may be utilized to form the aggregated pulse applied to the light source 702c, 702d (e.g., to the laser diode) to create the (laser) light output pulse. Illustratively, FIG. 7C shows a circuit arrangement according to the additive electrical binary power modulation by energy aggregation with n=3, having three branches BR1-BR3 all connected in series, realizing a LIDAR emitter featuring light pulses (e.g., laser pulses) with 8 intensity levels, where level 0 may correspond to no light output at all. FIG. 7D shows a circuit arrangement according to the additive electrical binary power modulation by energy aggregation with n=3, having three branches BR1-BR3 all connected in parallel, realizing a LIDAR emitter featuring light pulses (e.g., laser pulses) with 8 intensity levels, where level 0 may correspond to no light output at all.

According to the desired output level the respective sources 706c, 706d may be utilized to form the aggregated pulse. This approach may be referred to herein as additive electrical binary power modulation by energy aggregation. A pulse source 706c, 706d may be configured to create the electrical pulse by releasing previously stored capacitive or inductively stored electrical energy.

In the case that the laser diode 702c, 702d exhibits an approximately linear characteristic between applied electrical pulse energy and the energy emitted by the optical pulse, each pulse source 706c, 706d may be selected to provide a contribution to the aggregated pulse of approximately twice the energy of the preceding pulse source 706c, 706d.

In some aspects, the disconnection (or short-circuiting) of the laser diode(s) 702c, 702d to end the light generation may be carried out without switches or switching action as the sources 706c inherently stop providing power to the laser diode(s) 702c, 702d (when the discharge is complete).

As mentioned above, the three branches BR1-BR3 may be basically identical except for the component values of the pulse sources 706c. The energy provided by each branch may be chosen to be approximately twice the energy provided by the preceding branch (the energy E2 of the second branch may be twice the energy E1 of the first branch, the energy E3 of the third branch may be twice the energy E2 of the second branch, etc.):

$$E 2 \sim 2 \times E 1 , \\ E 3 \sim 2 \times E 2 , \\ with {E}_{k} = {\int }_{0}^{{T}_{P}} {V}_{k} ( t ) {I}_{k} ( t ) dt .$$

Vₖ(t) is the voltage and Iₖ(t) is the current of a respective pulse source 706c, 706d, and T_{P} is the pulse duration of an electrical pulse provided by the pulse source 706c, 706d.

The final selected values may be tuned based on the laser diode or laser diodes used as light source 702c, 702d (e.g., a series connection, a parallel connection or a combination of series and parallel connection of laser diodes).

The switches 712c, 712d (S1, S2 and S3) may be used to short-circuit pulse sources 706c, 706d not contributing to the overall pulse. In various aspects, the switches 712c, 712d (S1, S2 and S3) may be dispensed with, thus reducing complexity and cost, in case the utilized pulse sources 706c, 706d not being active have low impedance.

As stated above, a pulse source may use capacitive or inductively stored electrical energy to create the electrical pulse. In the following, configurations including inductively stored energy (FIG. 7E and FIG. 7F), and configurations including capacitively stored energy (FIG. 7G and FIG. 7H) are described. The common aspect may be that the light emitting devices 700e-700h include multiple pulse sources with a defined amount of energy connected in parallel, as described above and illustrated in FIG. 7D.

The light emitting device 700e, 700f in FIG. 7E and FIG. 7F illustrate, as an example, a circuit arrangement according to the additive electrical binary power modulation using inductively stored energy according to concept of FIG. 7D. The pulse sources 706e, 706f may be realized by inductors L1-L3 and the function of the switches described in relation to FIG. 7D may be realized by the diodes 716e, 716f (D1-D3). Depending on the desired output level, some of the inductors 706e may be “charged” by closing the associated switches 712e, 712e (respective signals Qi go high, turning on the respective switch Si). During this time the current through the respective inductors 706e, 706f may ramp up linearly. Then, all signals Qi may return to low, thereby turning off all switches 712e, 712f. This may define the beginning of the output pulse.

The currents through the respective inductors 706e, 706f may continue to flow turning on the respective diodes 716e, 716f Di and the light source 702e, 702f (the laser diode DO). All previously charged inductors 706e, 706f may freewheel and dump their energy into the light source 702e, 702f (and considering non-ideal components some small amount of this energy may be dissipated in diodes the 716e, 716f D1-D3).

The selection of the inductance values of the inductors 706e, 706f L1-L2 may depend on the characteristic of the light source 702e, 702f (the laser diode DO).

In case the laser diode behaves resistively (illustratively, the forward voltage increases linearly with the diode forward current), then each branch may be configured to provide twice the energy compared to the energy provided by the preceding branch (L may denote the respective inductance of the inductor, L1 may be the inductance of the first inductor, L2 may be the inductance of the second inductor, etc.),

$$L 2 = \frac{1}{\sqrt{2}} L 1 \\ L 3 = \frac{1}{\sqrt{2}} L 2.$$

In the case that the laser diode behaves as an ideal voltage source (illustratively, in case it may be well modeled by a constant forward voltage irrespective of the diode current), the branches B1-B3 may be configured such that the current provided by each branch may be twice the current provided by the preceding branch (L may denote the respective inductance of the inductor, L1 may be the inductance of the first inductor, L2 may be the inductance of the second inductor, etc.),

$$L 2 = \frac{1}{2} L 1 \\ L 3 = \frac{1}{2} L 2.$$

As soon as the pulse duration T_{P} has lapsed, the light source 702f may be short-circuited by an additional switch 718f S0, as shown in FIG. 7F. This may provide limiting the length (the duration) of the laser pulse.

In this configuration, the remaining energy stored in the inductors 706f may be dissipated in the inductors 706f L1-L3, the diodes 716f D1-D3 and the switch 718f S0. Other options (not shown) for dissipating the remaining energy may include, for example, a snubber circuit dissipating most of the energy, or energy regeneration by feeding the stored energy back to the voltage source 720e, 720f V0 used to charge the inductors 716e, 716f by an additional switch arrangement which may allow the diode current flow into the negative pole of the voltage source 720e, 720f V0 (V0 may be applied in reverse direction onto the inductors to demagnetize them until their currents have turned to zero).

In a real case scenario, a laser diode 702e, 702f may have a characteristic in-between an ideal voltage source and an ideal resistor. Based on this consideration, the inductor values used in the circuits represented in FIG. 7E and FIG. 7F may be chosen in-between the above-mentioned boundaries. The selection or tuning of the inductivities may be done in such a way to get as close as possible to a binary relationship between the light amplitudes of the generated light pulses and/or a most linear behavior, illustratively providing amplitudes of the generated light pulses creating a most evenly distribution over all the output levels.

The light emitting device 700g, 700h in FIG. 7G and FIG. 7H illustrate, as an example, a circuit arrangement according to the additive electrical binary power modulation using capacitively stored energy according to concept of FIG. 7D. The pulse sources may be realized by switches 712g, 712h (Si) and associated capacitors 706g, 706h (Ci) being charged via resistors 722g, 722h (Ri) from a common voltage source 720g, 720h (V0). The voltage source 720g, 720h may be implemented, as an example, by switch-mode power supply, providing a constant voltage over time and exhibiting an effectively low series resistance, getting close to an ideal voltage source. The light emitting devices 700g, 700h may provide a LIDAR emitter featuring light pulses (e.g., laser pulses) with 8 intensity levels using capacitively stored energy.

The energy of one or multiple of the capacitors 706g, 706h C1-C3 may be dumped into the light source 702g, 702h (the laser diode D0). The pulse may be ended without any switching action, as the pulse provided at the light source 702g, 702h naturally ends with the discharge of the contributing capacitors 706g, 706h, neglecting the currents flowing through the resistors 722g, 722h Ri, which may be assumed to be small compared to the “current pulse” provided by the capacitors 706g, 706h.

The shape of the generated pulse may deviate from the above mentioned quasi-rectangular shape, depending on the characteristics of light source 702g, 702h as well as the parasitic elements being part of the circuit arrangement.

In the case that the sources 706g, 706h exhibit high impedance for those sources 706g, 706h that do not contribute to the overall pulse, the switches 712g, 712h may be dispensed with.

As mentioned above, the three branches BR1-BR3 may be basically identical except for the component values. As one branch (e.g., B2) may be configured to generate twice the pulse power compared to another branch (e.g., B1), its capacitor 706g C2 may have about twice the capacity compared to the capacitor 706g C1 of the other branch (assuming a same charging voltage for all branches BR1-BR3). The diode D2 of the second branch may have about twice the semiconductor area (assuming same design) compared to the diode D1 of the first branch. And finally, the switch S2 of the second branch may be configured to carry about twice the peak current compared the switch Si of the first branch (e.g., may have twice the semiconductor area (assuming same design) of S1). The pulse provided by the third branch BR3 may be about “double” that of the second branch BR2, and thus roughly “four times bigger” compared to the pulse provided by the first branch BR1.

In the configuration in FIG. 7H, the signals Q1-Q3 to control the capacitors 706h C1-C3 may be generated via a gating signal Q (provided via the gating signal line 710h) from the signals B1-B3 (provided via the signal lines 714h) using signal switches 724h S01-S03 (e.g., as described in relation to FIG. 4E). As a difference with respect to the (power) switches 712h S1-S3, the signal switches 724h S01-S03 do not carry the pulse current (laser diode current), but only currents for signaling. The generated diode current and the light output of the circuit 700h may be identical to the respective current and light output of the circuit 700g in FIG. 7G.

FIG. 7I shows a time diagram 730i of a light signal 732i according to various aspects. The light signal 732i may be an exemplary light signal that may be emitted using one of the light emitting devices 700a-700h described in relation to FIG. 7A to FIG. 7H, in particular using one of the light emitting devices 700g, 700h described in relation to FIG. 7G and FIG. 7H. In the time diagram 730i the power level (PL) of the light signal 732i is represented over time (t).

The time diagram 730i is provided for illustrating the data transmission capabilities of the light emitting devices 700g, 700h. As an exemplary sequence of symbols to be encoded, the symbol stream 2,3,1,7,0,0,7,7,4,4 may be provided. The light signal 732i may include the light output pulses 734i generated by the light emitting devices 700g, 700h considering this example symbol stream. The resulting waveform may be similar to the waveform shown in FIG. 3A above. For the sake of representation, only the transmission of the symbols 2,3,1,7,0 is illustrated in the timeframe shown in FIG. 7I.

As shown in the time diagram 730i, using the symbol 0 results in no pulse. In this case, due to data communication functionality the ranging functionality of a LIDAR module (e.g., of the LIDAR module 200) may be impacted, especially if measures are not taken (e.g., by suitable coding) to avoid that a sequence of 0s is transmitted. An alternative (more rigorous) approach may include the exclusion of the symbol 0 (and potentially also of the symbol 1) from the used symbols in order to provide sufficiently high light amplitude and ensure at least a minimal ranging performance of the LIDAR system for every pulse transmitted.

A configuration of a light emitting device according to the additive electrical approach may provide the possibility of a herein so-called “residual gating”, described in further detail below in relation to FIG. 7J and FIG. 7K.

FIG. 7J shows the light emitting device 700h in a schematic view according to various aspects. In the configuration in FIG. 7J, the light emitting device 700h may be adapted to (additionally) provide the residual gating functionality. It is understood that the residual gating is described in relation to the light emitting device 700h, but it may be applied also to other configurations of the light emitting device 700c-700h shown in FIG. 7C to FIG. 7H.

In the configuration in FIG. 7J, the capacitors 706h not contributing to the pulse generation may remain charged. The energy remaining in the circuit may be used to form a second pulse directly following the first pulse, thereby generating a pulse with two sub-pulses (in other words, with two pulse portions). The second sub-pulse may be referred to herein as residual sub-pulse. The direct “firing” of a second sub-pulse after the first sub-pulse may be referred to herein as residual gating of the remaining switches.

The residual gating may be understood as the one or more processors 708h being configured to control a discharge of a first part (e.g., a first subset) of the electrical energy storage elements (e.g., the capacitors 706h, or the inductors in a different configuration) during a first portion of the emitted light signal, and to control a discharge of a second part (e.g., a second subset) of the electrical energy storage elements during a second portion of the emitted light signal. The discharge of the first part of the electrical energy storage elements may provide a (first) electrical signal (e.g., a current or a voltage) to the light source to emit a first light pulse or a first portion of a light pulse, and the discharge of the second part of the electrical energy storage elements may provide a (second) electrical signal to the light source to emit a second light pulse or a second portion of the light pulse.

In various aspects, according to the residual gating approach, a light pulse may include a first pulse portion having a first energy and a second pulse portion having a second energy, and the first energy may be complementary to the second energy with respect to a total energy of the light pulse. In various aspects, the first energy being complementary to the second energy may be understood as a result of a summation of the first energy with the second energy to be substantially 100% of the total energy of the light pulse.

The residual gating may be achieved via a residual gating signal 736j (R), as shown in FIG. 7J. The one or more processors 708h may be configured to provide the residual gating signal 736j (R) to the switches 712h associated with the capacitors 706h.

The shape of the residual sub-pulse may be given by the shape of the first sub-pulse, as the amount of energy available in the circuit may be constant for two corresponding sub-pulses (the pair of sub-pulses). Having a second sub-pulse may increase the robustness of the communication, not only thanks to having twice the chance to receive a sub-pulse that carries the encoded information, but also in view of the relationship between the two sub-pulses. The second sub-pulse may be the “inverse” of the first sub-pulse, as shown in the time diagram 740k in FIG. 7K. Illustratively, the light signal 742k shown in the diagram 740k may include a plurality of light pulses 744k-1, 744k-2, 744k-3, 744k-4, 744k-5, and each light pulse may include a first portion and a second portion having complementary energies with respect to a total energy of the light pulse (e.g., 7 W in terms of optical power in the exemplary configuration in FIG. 7K).

Residual gating may provide the additional advantage of data-independent thermal loading of all components including the light source 702h (e.g., the laser diode). This may provide higher reproducibility with respect to communication and ranging performance as well as device aging. It may also simplify the power supply design, as a branch always consumes the same amount of current/power, helping to ease the control and electromagnetic compatibility (EMC) design.

The residual gating may alleviate the above-described issue with minimal signal amplitude for symbols 0 and 1, as the second sub-pulse is even stronger if the first pulse is very small or even non-existent (as shown in FIG. 7K for the fifth light pulse 744k-5). However, by using all symbols a potential (but much smaller) issue may remain. As shown in FIG. 7K the pulses generated by symbols 0 (the fifth pulse 744k-5) and 7 (the fourth pulse 744k-4) are identical except for their precise timing. In case the relative velocity of transmitter and receiver is highly fluctuating the transmitter would not be able to distinguish the times tₛᵢ at which the light pulses are emitted based on previously received pulses and would therefore not be able to reliably distinguish between symbols 0 and 7.

The circuitries 700g, 700h described in relation to FIG. 7G, FIG. 7H, and FIG. 7J may not be suitable for generating more complex pulses, e.g. pulses having multiple sub-pulses (as the ones shown in FIG. 3B). The reason for this is that the discharged capacitors 706g, 706h need to be recharged before they can be discharged again.

In various aspects, multiple options may be provided to generate such pulse trains (e.g., pulse trains configured as shown in FIG. 3B).

As a first option, more complex circuitry compared to the circuitries 700g, 700h described in relation to FIG. 7G, FIG. 7H, and FIG. 7J may be provided, to implement fast recharging of the capacitors 706g, 706h.

As a second option, light pulses generated by multiple circuits may be aggregated using optical methods (e.g., as described in relation to the additive optical binary power modulation).

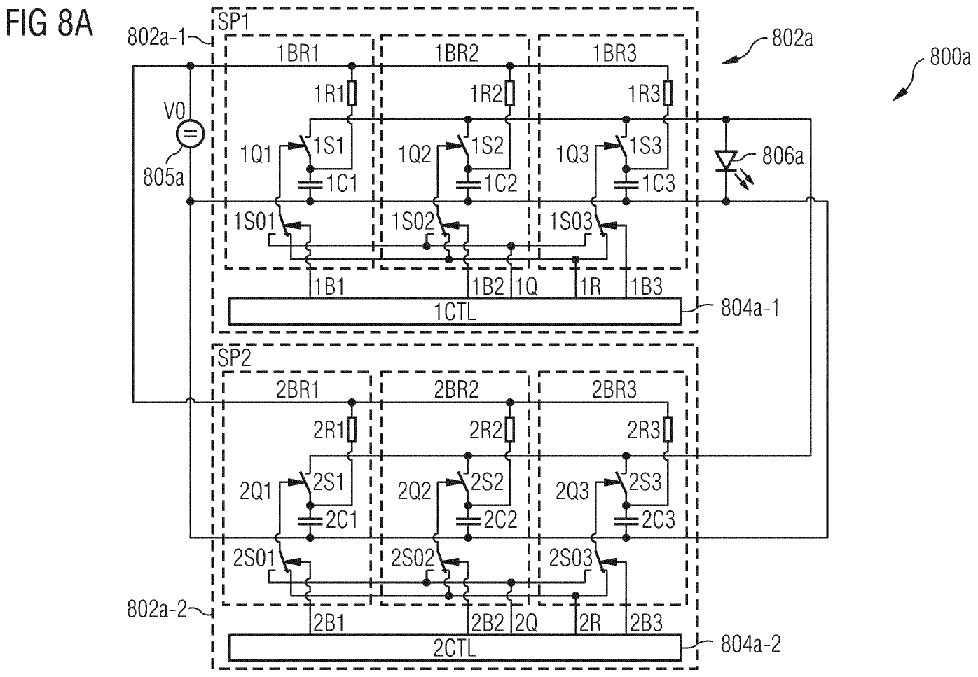

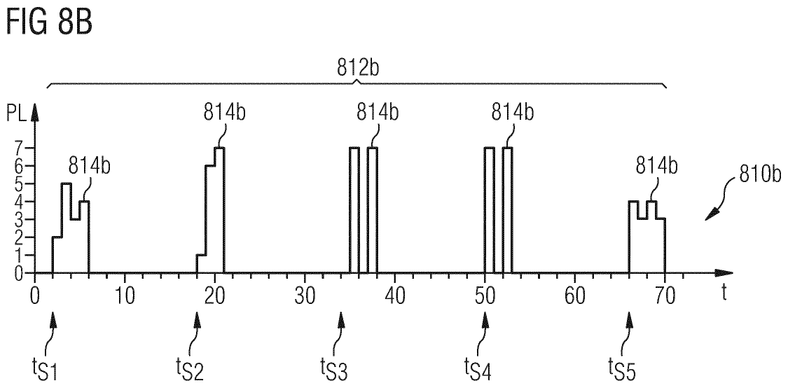

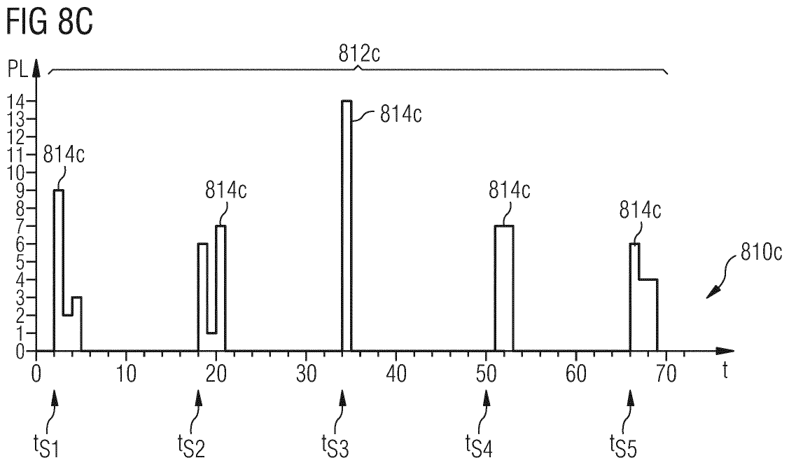

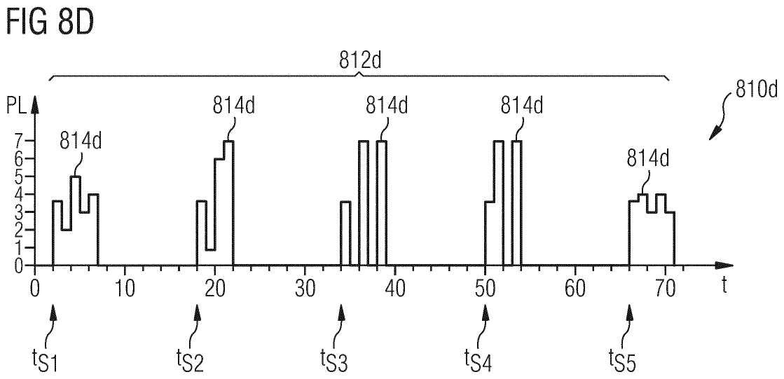

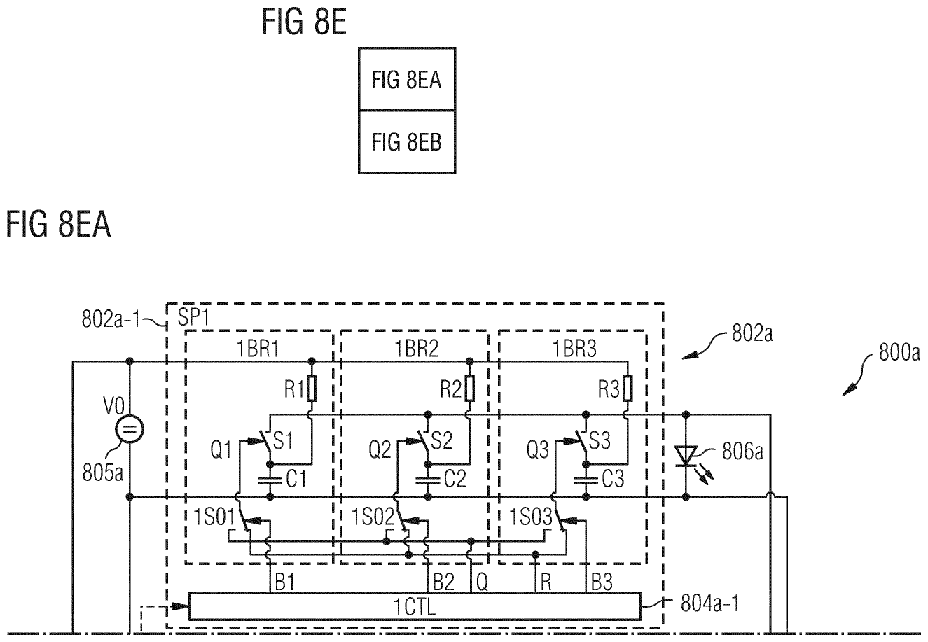

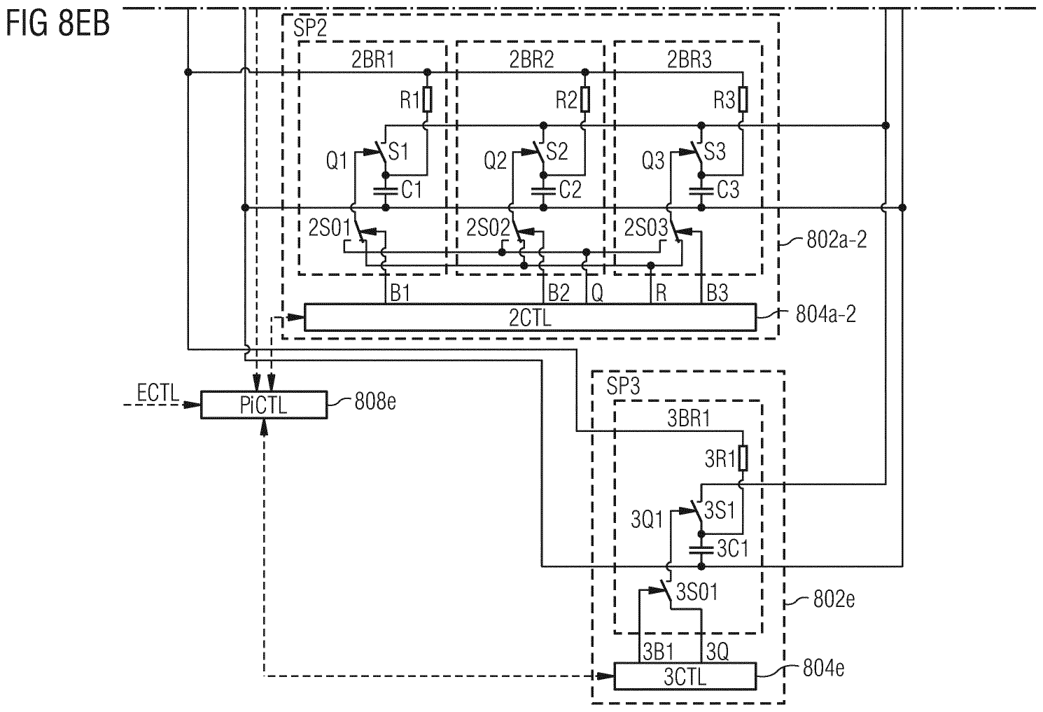

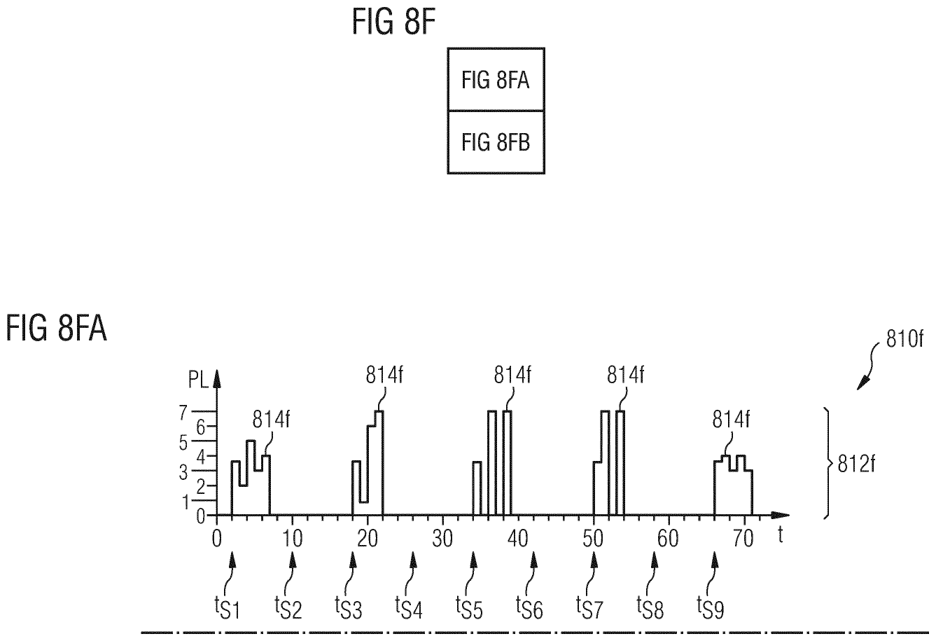

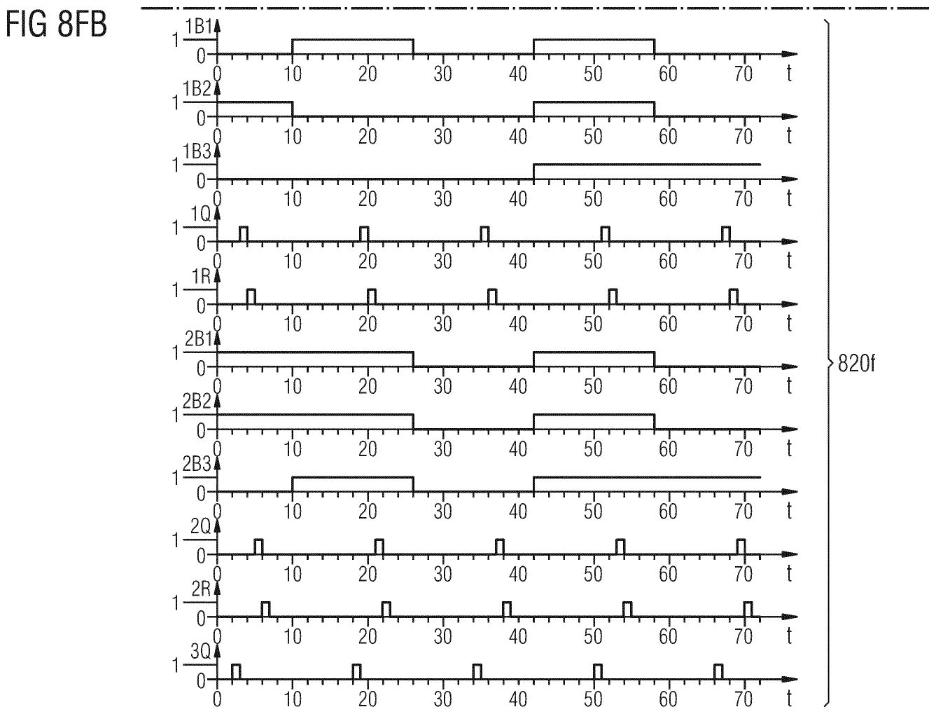

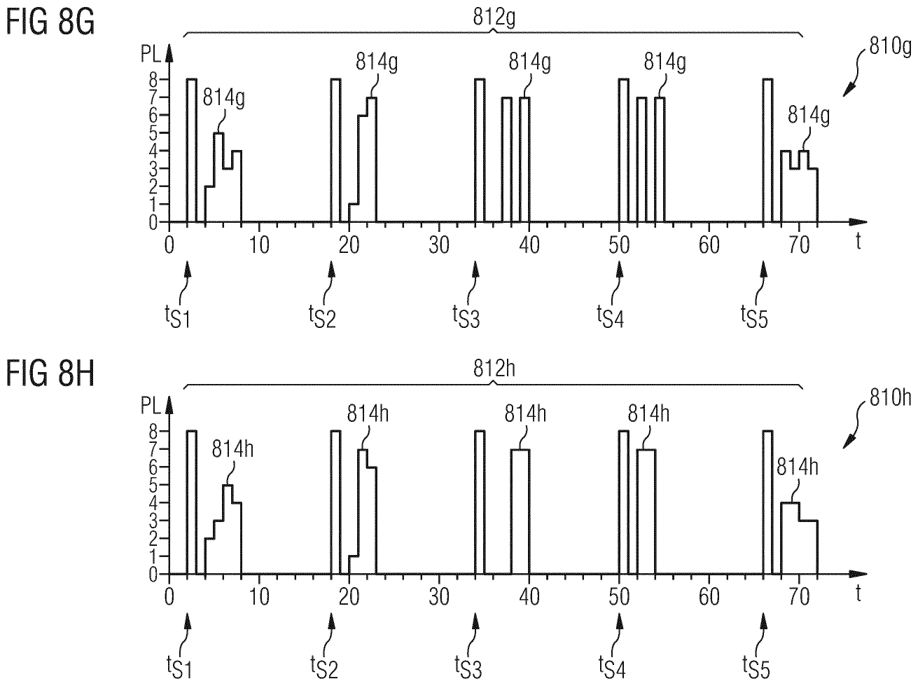

As a third option, electrical pulses of multiple circuits configured as the circuitries 700g, 700h described in relation to FIG. 7G, FIG. 7H, and FIG. 7J may be provided, thereby creating an electrical pulse of a more complex waveform. Such third approach will be described in further detail below, in relation to FIG. 8A to FIG. 8H.

FIG. 8A shows a light emitting device 800a in a schematic view according to various aspects. The light emitting device 800a may be configured as the light emitting device 202 described in FIG. 2, e.g. the light emitting device 800a may be an exemplary configuration of the light emitting device 202 (e.g., additional or alternative to the configuration described in relation to FIG. 4A to FIG. 7K).

The light emitting device 800a may illustratively include a plurality (e.g., two in this example, a first driving circuit 802a-1, and a second driving circuit 802a-2, but not limited to this number) of driving circuits 802a with associated one or more processors 804a-1, 804a-2. The driving circuits 802a shown in FIG. 8A may be configured as the driving circuit 704h described in relation to FIG. 7H and FIG. 7J, so the description of the individual components will be omitted. The driving circuits 802a may be connected to a common voltage source 805a and may be used to provide an electrical signal to a common light source 806a (e.g., configured as the light source 202, e.g. a laser diode). It is understood that the driving circuit(s) 802a may also have another configuration, e.g. as described above in relation to FIG. 7A to FIG. 7H (and may have, in some aspects, different configurations with respect to one another).

Each driving circuit 802a contributing to the overall electrical pulse may be made up of so-called sub-pixel (SP). The first sub-pixel SP1 is also referred to as first driving circuit 802a-1, the second sub-pixel SP2 is also referred to as second driving circuit 802a-2, etc. Each sub-pixel may include multiple branches, e.g. the sub-pixel SP1 may include three branches BR1 through BR3. Illustratively, the individual driving circuits 802a-1, 802a-2 may be understood as sub-pixels not in the strict optical sense (e.g., as described in relation to the optical approach), but in the sense of a circuit contributing in part to the driving of the light source 806a. The entire power circuit arrangement including all sub-pixels and the light source 806a (e.g., the laser diode) may be understood as a pixel.

In various aspects, the circuit and components of a sub-pixel may be identical to the neighboring sub-pixels (e.g., the first driving circuit 802a-1 may be configured as the second driving circuit 802a-2, etc.), the individual components may be shown with the same reference designators. The components of different sub-pixels may be distinguished by a leading number identical to the number of the respective sub-pixel, e.g. the resistor R3 in the first sub-pixel SP1 may be shown as 1R3, and the resistor with the same function in sub-pixel SP2 may be referenced as 2R3, etc.

FIG. 8B, FIG. 8C, and FIG. 8D each shows a respective timing diagram 810b, 810c, 810d of a light signal 812b, 812c, 812d (e.g., including a plurality of light pulses 814b, 814c, 814d) that may be generated with a plurality of sub-pixels, e.g. with the circuit 800a shown in FIG. 8A. The light pulses 814b, 814c, 814d of the light signal 812b, 812c, 812d may be provided by using the residual gating approach in the circuit 800a shown in FIG. 8A. In the time diagrams 810b, 810c, 810d the power level (PL) of the light signal 812b, 812c, 812d is represented over time (t).

Each sub-pixel 802a may contribute to two sub-pulses. The two sub-pixels 802a in the exemplary configuration in FIG. 8A may thus allow creating a total of four sub-pulses generating the overall light pulse 814b, 814c, 814d. For illustration purposes the transmission of the same example symbol stream being 2,3,1,7,0,0,7,7,4,4 is illustrated in FIG. 8B to FIG. 8D. In this adapted configuration, the symbol rate may be double (e.g., with respect to the one provided by the circuit 700g, 700h), and two symbols per pulse 814b, 814c, 814d may be provided: 2,3;1,7;0,0;7,7;4,4 (semicolon is used to separate pulses). The data rate may increase linearly with the number of sub-pixels 802a.

For LIDAR applications the pulse duration T_{P} and the repetition time T_{R} may be an order of magnitude or even more different from each other, as described above.

The light signal 812c shown in the diagram 810c may be provided by using a joint residual gating, illustratively a residual gating for both sub-pixels 802a at the same time and before the “very first sub-pulse” (illustratively, before emitting the initial pulse 814c of the signal 812c). This approach may provide a leading sub-pulse of typically significant amplitude which may be used as the “primary (sub-)pulse” for the ranging functionality of the LIDAR system (e.g., of the LIDAR module 200).

The symbol rate (two symbols per pulse) remains unchanged compared to the approach of a residual gating per sub-pixel provided for the light signal 812b in FIG. 8B. The feature of a data-independent thermal load remains unchanged. In the case that all symbols have the same likelihood to be transmitted (statistically evenly distributed symbols in the symbol stream), and the laser diode is capable of generating such high pulses, this approach leads to a ranging sub-pulse which is statistically of higher amplitude compared to all subsequent sub-pulses.

This approach provides advantages from a ranging precision point of view (as the very strong residual sub-pulse may provide a better signal-to-noise ratio compared to a regular “first sub-pulse” as in the case of residual gating per sub-pixel). The approach according to FIG. 8B may provide a more robust communications scheme (information is transmitted in a redundant way over four rather than three times the sub-pulse duration T_{Pi}, or differently said, the pulse duration T_{P} may be 33% longer in case of residual gating per sub-pixel).

In various aspects, the initial sub-pulse for ranging and/or calibration may be generated by a separate sub-pixel. This approach may provide the freedom to freely select the amplitude of the initial sub-pulse, making waveforms as shown in the light signal 812d in FIG. 8D possible. The waveform of the light signal 812d is identical to the light signal 812b shown in FIG. 8B. However, in the light signal 812d a leading sub-pulse of an amplitude corresponding to a power level of 3.5 is added. The initial sub-pulse in this arrangement may provide half of the maximal amplitude of any sub-pulse, allowing for an easy pulse-by-pulse receiver calibration or receiver range calibration.

FIG. 8E shows the light emitting device 800a in a schematic view according to various aspects. For illustration purposes, FIG. 8E is split into FIG. 8EA and FIG. 8EB, it is however understood and described as a single figure FIG. 8E. In the configuration in FIG. 8E, an additional driving circuit 802e (the sub-pixel SP3, having a single branch 3BR1) with associated one or more processors 804e (an associated sub-pixel control 3CTL) may be provided. Each sub-pixel may have an individual sub-pixel control 1CTL-3CTL.

FIG. 8F shows a timing diagram 810f of a light signal 812f (with pulses 814f) that may be emitted with the configuration shown in FIG. 8E, and a plurality of timing diagrams 820f showing the timing of the circuitry 800a. For illustration purposes, FIG. 8F is split into FIG. 8FA and FIG. 8FB, it is however understood and described as a single figure FIG. 8F. The configuration in FIG. 8E may provide emitting light pulses with 8 intensity levels: SP1 and SP2 (both including three branches each) may be capable of generating light of power levels 1 through 7, and SP3 (including a single branch) may generate light of power level 3.5, hence light of 8 different intensity levels can be provided. In the time diagram 810f the power level (PL) of the light signal 812f is represented over time (t).

In various aspects, for saving complexity and cost, a sub-pixel, e.g. the third sub-pixel 802e, may include a single branch (differently from the two other sub-pixels 802a). This configuration may be provided in case no variation of the generated pulse amplitude is required (in this case, the switch 3501 may be dispensed with, as the signal 3B1 may be always high).

In various aspects, the sub-pixel controls 804a, 804e may be coordinated by a common pixel control 808e PiCTL. The communication between the individual sub-pixel controls 804a, 804e and the pixel control 808e may be realized by bi-directional communication (illustrated by dashed lines with arrows on both ends). In various aspects, the pixel control 808e may be configured to communicate with an overall emitter control ECTL (not shown) via bi-directional communication. The overall emitter control ECTL may be configured to control (illustratively, orchestrate) multiple pixels, all part of the same LIDAR module (e.g., of the LIDAR module 200).

As an example, the overall emitter control may be part of a main LIDAR module control circuit, controlling not only the emitters via the pixel controls, but also the optics (such as a DMD, digital mirror device, or oscillating MEMS mirror) as well as the individual parts of the light receivers. An overview of used terms and abbreviations is provided in Table 7 (each object may include one or more of the objects listed in the lines below). Table 8 provides a summary of the objects relevant in the scope of this description (each object may include one or more of the objects listed in the lines below).

TABLE 7

| Abbrevi- | | Abbrevi- | | |
|---|---|---|---|---|
| ation | Object | ation | Controller | Comment |
| | Car | | Person (or AI) | |
| | . . . | | Car-control | |
| | LIDAR | | . . . | |
| | module | | | |
| | Emitter | ECTL | LIDAR module | |
| | | | control circuit | |
| Pi | Pixel | PiCTL | Emitter control | |
| SP | Sub-pixel | CTL | Pixel control | |
| BR | Branch | | Sub-pixel control | |
| FPC | Fundamental | | Basic gates or | FPC: see |
| | pulse cell | | mathematical | below |
| | | | operations | |

TABLE 8

| Object | Why? | Description |
|---|---|---|
| LIDAR | Ranging and | |
| module | communication | |
| Emitter | Light generation | An emitter illuminates the |
| | | entire field of view of the |
| | | LIDAR module. |
| Pixel | Separation in Space | A pixel illuminates an area of |
| | | the optics with a light pulse. |
| Sub-pixel | Intensity modulation | A sub-pixel generates a sub- |
| | within a single pulse | pulse. |
| Branch | Binary intensity | Each branch creates provides a |
| | adjustment | “digit” of the light level |
| Fundamental | Modularity | Allowing integration and |
| pulse cell | | complexity and cost reduction |

As mentioned above, an arrangement with an additional sub-pixel (e.g., the third sub-pixel 802e SP3 in FIG. 8E) for generating the initial sub-pulse may provide the possibility of freely selecting the amplitude of such initial sub-pulse. This freedom may be used, in some aspects, to generate a leading sub-pulse always stronger (and not only sometimes stronger as in case of a leading residual sub-pulse) than any consecutive sub-pulses. In various aspects, an additional gap between the “main train of data-bases sub-pulses” and the “leading ranging sub-pulse” may be introduced.

Illustratively, a light signal may include a (first) light pulse (or a first plurality of light pulses) associated with ranging, and a (second) plurality of light pulses associated with data transmission, and the first light pulse may be separated from the second plurality of light pulses by the additional gap. An example combining both, the strong leading ranging sub-pulse, and separation of ranging sub-pulse and following data-based sub-pulses, is shown in FIG. 8G, which shows a timing diagram 810g of a light signal 812g (including a plurality of light pulses 814g) that may be generated with an arrangement with three sub-pixels (e.g., with the arrangement shown in FIG. 8E).

This concept allows providing basic and advanced LIDAR functionality. The basic functionality may provide good ranging functionality but no data communication. This functionality may be realized by simple receivers (low cost) only utilizing the first sub-pulse and the following “gap”. The “gap” may provide a “nicely shaped pulse” suited for primitive ranging concepts.

With the same modulation/pulse scheme also higher-grade systems may be provided (with the same transmitters). More complex receivers may be used, utilizing the first sub-pulse for initial (fast) ranging and for channel estimation. Considering the derived channel information, the subsequently coded symbols may be decoded. In addition to the initial ranging, a precision ranging (high accuracy distance measurement) may be implemented by using the entire pulse waveform (including the first “ranging sub-pulse” and all consecutive “data sub-pulses”) for ranging. The precision ranging and the data decoding may be carried out in a single step, e.g. by correlation analysis in a correlation receiver, providing distance and the most likely transmitted symbols.

In various aspects, for making the communication more robust (in addition to the built-in redundancy by the residual sub-pulses), the residual sub-pulses may be moved to the end of the train of sub-pulses while all (non-residual) data sub-pulses may come first (right after the initial “ranging sub-pulse”) thereby reducing the probability that a single interference event or noise pulse would disturb both the data sub-pulse and its residual counterpart. An example of this configuration is shown in the timing diagram 810h in FIG. 8H showing a light signal 812h with light pulses 814h, where the same symbol sequence is used as in FIG. 8G. Table 9 describes the stream of sub-pulses shown in FIG. 8H. Residual data may be naturally generated by using up all stored energy. As each of the used sub-pixels includes, for example, three branches “holding” a total energy of 7, in the case that the data is 2 then the corresponding residual data may be 5, and so on.

TABLE 9

| | | | | | | |
|---|---|---|---|---|---|---|
| R: | 8 | 8 | 8 | 8 | 8 | ranging sub-pulse |
| G: | 0 | 0 | 0 | 0 | 0 | gap |
| Q: | 23 | 17 | 00 | 77 | 44 | data |
| R: | 54 | 60 | 77 | 00 | 33 | residual data |
| T: | 802354 | 801760 | 800077 | 807700 | 804433 | total stream of sub-pulses |

In various aspects, the robustness may be further increased by adding error check information to the sequence of symbols to be encoded (e.g., to the sequence of symbols 208). Illustratively, the sequence of symbols to be encoded (e.g., to the sequence of symbols 208) may include at least one error check symbol (e.g., a parity symbol) representative of error check information associated with the sequence. In various aspects, at least one driving circuit (illustratively, a parity sub-pixel) may be assigned provide the respective electrical signal for emitting the light signal (or the individual light pulse) including (e.g., encoding) the error check symbol.

Robustness may be increased by adding parity information. Multiple options may be provided to add parity information to the above data stream.

As a first option (a), the parity information is added by adding additional sub-pulses. As a second option (b), the parity information may be added as “additional data” into the data stream.

In relation to the first option (a) an additional sub-pixel (similar to the one assigned to the initial ranging sub-pulse) may be provided in a driving circuit (e.g., as described in relation to FIG. 8E). The additional sub-pixel (also referred to herein as parity sub-pixel) may include one or more branches. As an example, the additional sub-pixel may have just a single branch.

The intensity of light level generated by the “parity sub-pixel” may be chosen freely. In other words, the two amplitude levels of the parity sub-pulse and the residual parity sub-pulse may be chosen freely. Table 10 and Table 11 show exemplary values for emitted light pulses, in which amplitudes of 6 and 0 were chosen for the parity information, allowing a “parity sub-pixel” with only a single branch. In Table 11 the residual even parity pulse may be directly following the even parity pulse. In Table 10 and Table 11, as well as in Table 12 below, the values in the rows R, G, Q, R, and P provide the total stream in row T (the sequence of values in row T). The row P provides both the parity and the residual parity (which is the inverted of the parity). In Table 11, the reverse sequence for the residual data is provided compared with the data.

TABLE 10

| | | | | | | |
|---|---|---|---|---|---|---|
| R: | 8 | 8 | 8 | 8 | 8 | ranging sub-pulse |
| G: | 0 | 0 | 0 | 0 | 0 | gap |
| Q: | 23 | 17 | 00 | 77 | 44 | data |
| R: | 54 | 60 | 77 | 00 | 33 | residual data |
| P: | 0 6 | 6 0 | 6 0 | 6 0 | 6 0 | even parity |
| | | | | | | and |
| | | | | | | residual |
| T: | 80230546 | 80176600 | 80006770 | 80776000 | 80446330 | total |
| | | | | | | stream of |
| | | | | | | sub-pulses |

TABLE 11

| | | | | | | |
|---|---|---|---|---|---|---|
| R: | 8 | 8 | 8 | 8 | 8 | ranging sub-pulse |
| G: | 0 | 0 | 0 | 0 | 0 | gap |
| Q: | 23 | 17 | 00 | 77 | 44 | data |
| R: | 45 | 06 | 77 | 00 | 33 | residual data |
| P: | 06 | 60 | 60 | 60 | 60 | even parity |
| | | | | | | and residual |
| T: | 80230645 | 80176006 | 80006077 | 80776000 | 80446033 | total stream |
| | | | | | | of sub-pulses |

Depending on where the one or multiple parity sub-pulses are added, the shape of the pulse varies (and in any case the pulse may become longer). This approach does not reduce the data rate, but it may be provided with additional energy and hardware. The additional hardware, which is additional sub-pixels (additional driving circuits) to create the parity sub-pulse(s) may be provided as long as the circuit does not allow recharging capacitors within the duration of the pulse in which the capacitor has been discharged (even with a longer pulse due to the presence of the parity information).

As mentioned, for the above examples shown in Table 10 and Table 11, amplitudes of 6 and 0 were chosen, allowing a “parity sub-pixel” with only a single branch.

As an alternative, two “regular” sub-pixels with 3 branches each may be provided to generate the ranging sub-pulse as well as the parity and the residual parity sub-pulses. In this configuration, the driving circuit may include 4 identical sub-pixels each having three branches (e.g., four sub-pixels 802a). With this configuration, the stream of sub-pulses shown in Table 12 may be provided. As in the previous example, the ranging pulse has an amplitude of 8, but the levels used for parity are 2 and 4.

| | | | | | | |
|---|---|---|---|---|---|---|
| R: | 8 | 8 | 8 | 8 | 8 | ranging sub-pulse |
| G: | 0 | 0 | 0 | 0 | 0 | gap |
| Q: | 23 | 17 | 00 | 77 | 44 | data |
| R: | 54 | 60 | 77 | 00 | 33 | residual data |
| P: | 2 4 | 4 2 | 4 2 | 4 2 | 4 2 | even parity |
| | | | | | | and residual |
| T: | 80230544 | 80174602 | 80004772 | 80774002 | 80444332 | total stream |
| | | | | | | of sub-pulses |

As an exemplary configuration, the two data sub-pixels may be denoted as sub-pixels SP1 and SP2 (and sub-pixels SP3 and SP4 are provided for ranging). The ranging pulse may be created by “firing” all branches of SP3 and branch BR1 of SP4 at the same time creating the ranging pulse. This leaves BR2 and BR3 of SP4 for the parity and the residual parity. In this configuration, the parity and residual parity sub-pulses may have the amplitudes of 2 (created by firing BR2) or 4 (generated by firing BR3). Aside from the advantage that identical sub-pixels are used, thereby reducing complexity and easing integration, the generated pulse waveforms may be always of the same length. Every pulse may begin with amplitude 8 and may end with an amplitude of 2 or 4. This pulse property may be advantageous when it comes to building highly sensitive and robust receiver topologies.

In the example above, a parity bit per pulse was added. It is however understood that more parity bits may be added, e.g. two parity bits per pulse. The first parity bit may be calculated from the bits transmitted in the lower branches (e.g., BR1 of all sub-pixels), and the second parity bit may be calculated from the upper branches (e.g., BR2 and BR3 of all sub-pixels). In various aspects, the upper branches may include more branches, and the respective parity bits may be calculated from a larger number of bits, compared to the parity bit calculated from the lower branches, as the upper branches may correspond to the more resilient bits. In addition a (e.g., third) parity bit calculated from all the parity bits may be added.

The number of parity bits per a certain amount of data bits may be selected depending on the implementation addressing a specific application and use case. The more parity bits are added, the more robust the communication becomes, but at the same time the higher the hardware effort for additional sub-pixels (in case of option (a)) and error correction (e.g., computational power and memory). The additional hardware may lead to increased associated cost. Another possible drawback may be a reduced data rate, as described in further detail below.

For a given use case an optimum may be found (e.g., based on channel characteristics, e.g. optical channel characteristics between transmitter and receiver, and a required minimum data throughput, e.g. 100k bps hundred kilobits per second).

One or multiple parity sub-pulses within a pulse may provide an overall more robust communication. The parity bit may be calculated from one multiple symbols within the same pulse. This may provide not only the possibility of identifying if a bit has flipped but also to correct the flipped bit, as the parity sub-pulses would indicate whether the data sub-pulse or the respective residual sub-pulse should be trusted.

In various aspects, either an even or an odd parity sub-pulse may be added. In both cases the residual pulse of the parity sub-pulse may also be added. This may be achieved by utilizing a separate sub-pixel for the parity sub-pulse, and firing this sub-pulse and its residual sub-pulse in every pulse.

In various aspects, the parity information may be added only from time to time, e.g. only every 10th pulse (as an example) based on the information of the previous 10 pulses. However, having parity information in every pulse may provide a more robust approach, and the information integrity of multiple pulses may be secured with a CRC (cyclic redundancy check).

In relation to the option (b) above, parity information may be added as “additional data” in the data stream. This approach may reduce the effective data rate, but may be implemented without any additional hardware. With this approach, care should be taken as to where to add the parity bit into the data stream, as there may be bits (those being created by higher order branches, using a lot of light) that are more robust than others. In various aspects, one of the “more resilient” bits may be used as parity bit. This approach may be implemented with a setup similar to the one above, e.g. the light emitting device 800a described with relation to FIG. 8E creating the stream shown in FIG. 8G and FIG. 8H, however expanded by another sub-pixel with 3 branches. Illustratively, the light emitting device may include three identical sub-pixels used for data communication, and a sub-pixel used for the initial ranging “sub-pulse”. In this configuration, no “parity sub-pixel” is provided (it may be there in the case that approach (a) is followed).

The light signal emitted with this configuration may include a pulse having three data sub-pulses, each data sub-pulse carrying 3 bits (and the light signal may also include the residual data sub-pulses). These 9 bits may be used to represent one byte of data, and the parity bit of that data byte. In the case that the parity bit would be transmitted with one of the “more resilient” bits, then the parity bit may be assigned to one of the third branch out of the 3 data sub-pixels. This may ensure that the parity bit is transmitted using an energy amount equaling 4 LP, light power, (either an intensity of four light levels would be in the data sub-pulse or the residual data sub-pulse).

Aside from the parity bit (depending on the approach) being encoded in a “more resilient” bit, the more resilient bits may be used, in some aspects, for the data flow control. The data flow control (as part of the lower layer communication stack) may be used for communication between two LIDAR communication nodes to negotiate the data communication protocol.

In the following, a summary of methods for power modulation described above is provided.

The above described methods realizing intensity modulation are quite different in their nature, and have different properties, including strength and weaknesses. As an example, the concept of “subtractive optical power modulation” may be less energy efficient, as light falling on “turned off” areas is being dissipated (illustratively wasted), but it may provide a better linearity. Depending on the use case and application the best-suited method may be chosen. Table 13 provides an overview and may be used to select the best-suited approach. As described above, multiple approaches may be combined. The combination of optical modulation (either subtractive or additive) and electrical modulation (either subtractive or additive) may be utilized to generate systems with very large dynamic ranges.

| | | Initial energy type modulated | |
|---|---|---|---|
| | | Optical energy/ | Electrical energy/ |
| | | Light | Electricity |
| Approach | Subtrac- | Subtractive optical | Subtractive electrical |
| | tive | power modulation | power modulation |
| | | System efficiency: | System efficiency: Low |
| | | Lowest | System cost: Medium |
| | | System cost: Low | System size: Medium |
| | | System size: Small | Linearity: Poor . . . Good |
| | | Linearity: Excellent | |
| | Additive | Additive optical | Additive electrical |
| | | power modulation | power modulation |
| | | System efficiency: | System efficiency: |
| | | High | High . . . Highest |
| | | System cost: Low | System cost: Medium |
| | | System size: Medium | System size: Smallest |
| | | Linearity: Very good | Linearity: Poor . . . Good |

The system efficiency for additive electrical power modulation may be highest for small number of branches/modulation levels. The linearity of “subtractive electrical power modulation” may be poor for voltage splitting, mediocre for power splitting, and good for current splitting. The linearity of “additive electrical power modulation” may be poor for voltage aggregation, mediocre for power aggregation, and good for current aggregation.

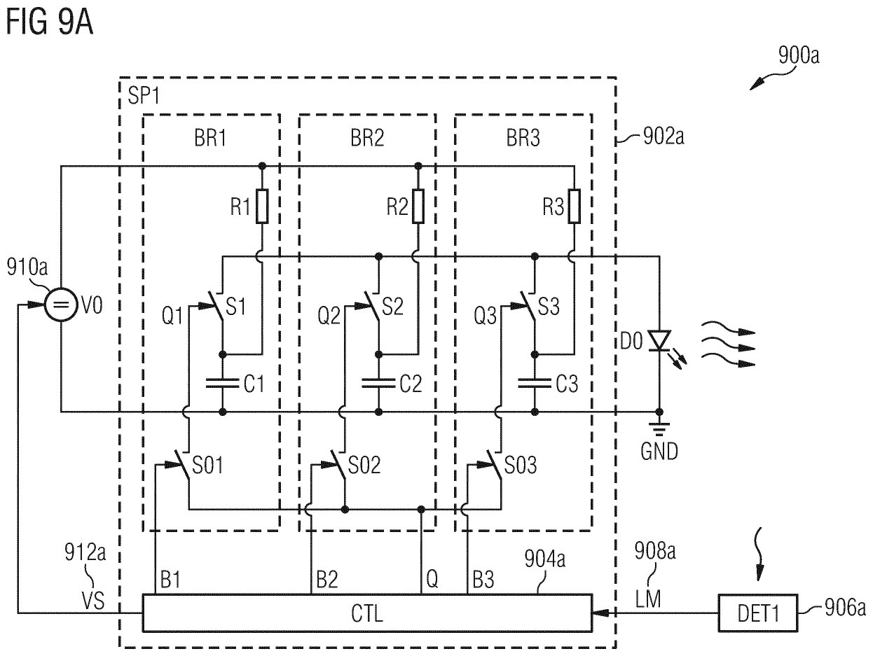

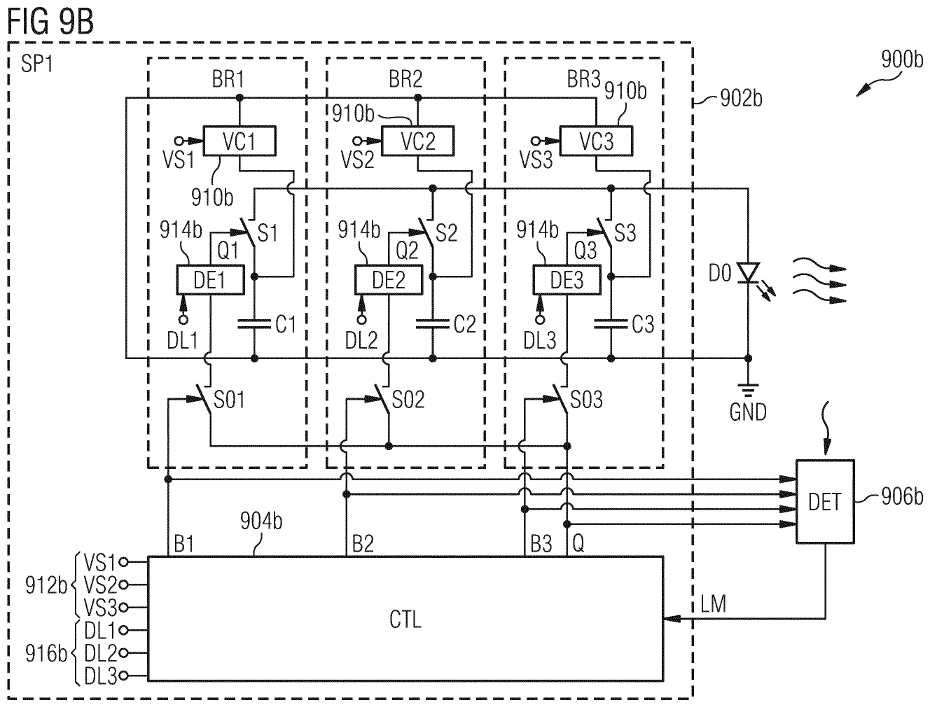

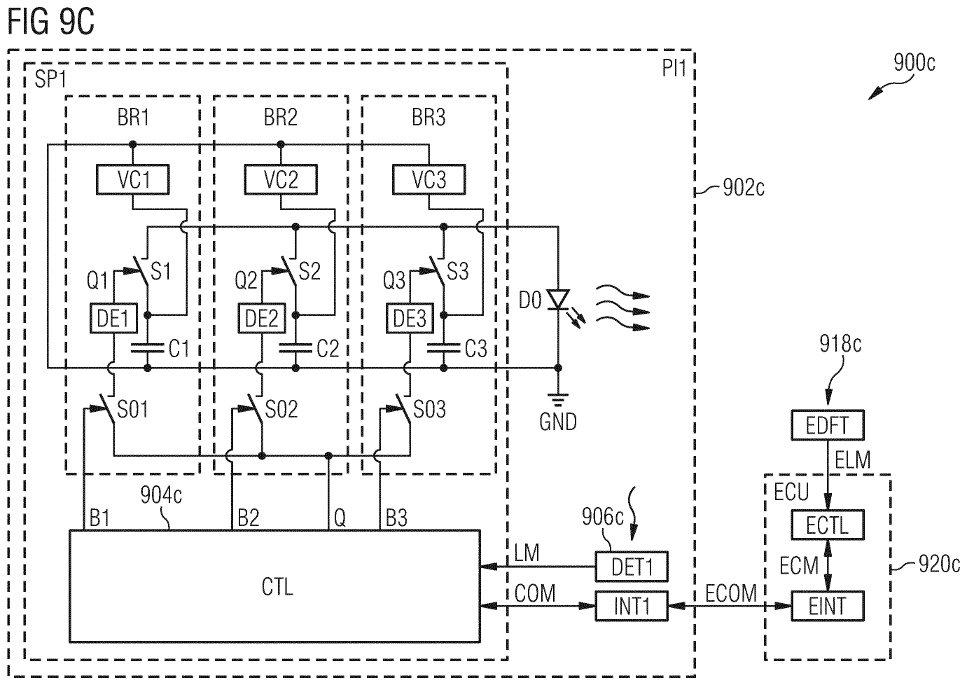

In various aspects, an additional functionality may be provided in a LIDAR module (e.g., in the LIDAR module 200) by detecting the emitted light signal, and adjusting the emission/reception as a function of the detected signal, as described in further detail below in relation to FIG. 9A to FIG. 9C.

A LIDAR module (e.g., the LIDAR module 200) may include a photo detector configured to detect the emitted light signal (e.g., a photo detector including one or more photo diodes, such as avalanche photo diodes, or pin photo diodes, as examples). In various aspects, the photo detector may be part of the light emitting device of the LIDAR module (e.g., part of the light emitting device 202).

The photo detector may be configured to provide the detected signal (e.g., a signal representative of the detected light signal 204) to the one or more processors of the LIDAR module (e.g., to the one or more processors 206). The one or more processors may be configured to adjust the control of the light emitting device as a function of the detected signal. For communicating with the one or more processors, the photo detector may include a wired or wireless communication channel with the one or more processors, e.g. a unidirectional or a bidirectional communication channel.

In some aspects, adjusting the control of the light emitting device may include adjusting the set value determining a capacitor charge voltage (illustratively, of one or more of the capacitors used to provide an electrical signal to the light source). The adjustment may be implemented in a feed-forward or in a closed-loop. Illustratively, based on the signal level of the previously detected signal, the one or more processors may control the charging of one or more of the capacitors to increase or reduce the stored charge (and thus the signal level of the next emitted light signal or light pulse).

As another example, additionally or alternatively, adjusting the control of the light emitting device may include the photo detector being configured to adjust a sensitivity level based on an expected signal level of the emitted light signal. Illustratively, based on the signal level of the previously detected signal, the one or more processors may instruct the photo detector to increase or reduce its sensitivity for better capturing the next emitted light signal.

In various aspects, the photo detector may be configured to receive a trigger signal from the one or more processors, and may be configured to be sensitive to incoming light for a predefined period of time after reception of the trigger signal. Illustratively, the photo detector may be activated only for the time necessary for detecting the emitted light signal, e.g. may be activated in accordance (e.g., in synchronization) with the emitted light signal. As an example, the trigger signal may include a gating signal (e.g., may be provided via a gating line to the photo detector).

The possibility of adjusting light emission and/or detection provided by the photo detector may enable automatic calibration and charge voltage control. This may provide dealing with component and manufacturing tolerances, temperature drifts, component aging, and their impact on the generated light output levels.

In the following, in relation to FIG. 9A to FIG. 9C, the introduction of a photo detector is shown, only as an example, in a light emitting device configured according to the “additive electrical binary power modulation”. It is however understood that any of the configurations described above in relation to FIG. 2 to FIG. 8H (for any of the described approaches) may include a photo detector configured as described herein.

FIG. 9A, FIG. 9B, and FIG. 9C each shows a light emitting device 900a, 900b, 900c in a schematic view according to various aspects. The light emitting device 900a, 900b, 900c may be configured as the light emitting device 202 described in FIG. 2, e.g. the light emitting device 900a, 900b, 900c may be an exemplary configuration of the light emitting device 202 (e.g., additional or alternative to the configuration described in relation to FIG. 4A to FIG. 8H).

The driving circuits 902a, 902b, 902c shown in FIG. 9A to FIG. 9C may be configured as the driving circuit 704h described in relation to FIG. 7H and FIG. 7J, so the description of the individual components will be omitted (only some relevant components will be mentioned). The light emitting device 900a, 900b, 900c may include respective one or more processors 904a, 904b, 904c (a respective control circuit) adapted according to the configuration of the respective photo detector 906a, 906b, 906c, as described in further detail below.

In the configuration in FIG. 9A, the photo detector 906a DET1 may be configured to provide a signal 908a representative of the measured light level LM (as an analog or digital value) to the control 904a CTL. As the control 904a may be aware of which branch or branches BR1-BR3 are addressed, it may determine discrepancies between the calculated (expected) light level and the measured light level. The control 904a may be configured to adjust the overall light output by controlling the capacitor charge voltage, e.g. by the control via the control signal 912a (a signal voltage set VS) provided to the voltage source 910a V0.

The control 904a may “fire” each branch separately and calculate the ratio of consecutive branches, e.g. to assess the linearity of the arrangement.

In various aspects, as shown in FIG. 9B, the light emitting device 900b may include individually controllable charge circuits 910b (e.g., individually controllable voltage sources VC1-VC3). Via the charge voltage set signals 912b VS1-VS3 the charge circuits 910b may be controlled in their overall operation (on/off) as well as with respect to the respective provided charge voltage.

As an example, the charge circuit may include an adjustable linear regulator with adjustable output voltage or a DC/DC converter with adjustable output voltage. In the case that the charge circuit is commanded off, then the circuit behaves as a high impedance (illustratively, between its two “power terminals”, one of them being connected to the capacitor and the other connected to ground; the supply terminal of the charge circuit, which would be the “third power terminal” is not shown).

In particular, during “firing” of a branch and the charge/discharge of the respective capacitor C1-C3 through the laser diode DO, the charge circuit is turned “off” by the control 904b thereby avoiding a current flow from the charge circuit 910b over the closed respective switch S1-S3 into the laser diode DO.

FIG. 9B also shows a setup with a more advanced photo detector 906b: As the photo detector 906b may be provided with the signals B1-B3 it may be configured to adjust its sensitivity depending on what light level is expected in the next pulse, as described above. As the “value” (in other words, the output level) of B1-B3 increases, the sensitivity of the photo detector may be reduced. The sensitivity of the photo detector 906b may be reduced, for example, by reducing the sensor-internal bias voltage of the photosensitive element (e.g., of a photo diode). As another example, the sensitivity of the photo detector 906b may be reduced by reducing the amplification of the photo amplifier, which is amplifying the weak signal of the photosensitive element. As a further example, sensitivity of the photo detector 906b may be reduced by increasing the counter divider value of a digital divider following a photon-to-signal conversion device as in the case of an avalanche photo diode or SPAD (single photon avalanche diode) array.

In various aspects, the reduction of the photodetector's sensitivity may be carried out in a binary fashion thereby taking advantage of the output level being provided in a binary fashion (illustratively, without data conversion) and keeping the output signal of the photo detector 906b always close to 1. Deviations from 1.000 may be seen as imperfections which may be addressed, for example, by adjusting the charge voltages 910b VC1-VC3 or by considering the deviations in the later processing of the received LIDAR data.

In various aspects, the photo detector 906b shown in FIG. 9B may be a gated photodetector, as described above. Illustratively, the photodetector 906b may be configured to be sensitive to incoming light only for a certain amount of time after receiving a trigger signal. The trigger signal may be the gating signal Q. The precise gating of the photo detector 906b may be implemented, as the gating signal Q may provide precise timing (e.g., the photo detector may include an adjustable delay element similar to the delay elements 914b associated with each switch S1-S3), and in view of the fact that the length of the pulse generated by the respective branch or branches may be known. This configuration may allow measuring the light of the respective branch or sub-pixel only (influence by light originating from other branches or sub-pixels may be excluded, and light from light sources other than the LIDAR module may be minimized significantly).

In addition to the amplitude, also the branch delay times tBR1-tBR3 between “firing” a branch may be assessed, e.g. by toggling the gating signal Q and the peak seen in the detector signal. Typically, “larger branches” may take longer to fire compared to “smaller branches”, as the switches (e.g., the transistors) may require more time to turn on compared to smaller switches S1-S3 due to parasitic effects, e.g. in the semiconductor of the switch. The same may be true for the other components like the capacitors C1-C3 (the larger the capacitor the larger the parasitic inductance). The individual delay elements 914b DE1-DE3 may be provided to synchronize all switches. The delay time may be adjusted by the control 904b using the delay signals 916b DL1-DL3. The delay signals 916b may be set (in case of an analog signal) or calculated (in case of a digital signal) in such a way that the delay times tDE1-tDEn for each of the n branches (in the example shown in FIG. 9B n=3) may be as follows,

$${t}_{DEk} = {max}_{i = 1 … n} {t}_{BRi} - {t}_{BRk} , with k ∈ \{ 1 , … , n \}$$

This adjustment of the delay times may be achieved by an iterative approach, in which the branches are fired individually. The delay times tBR1-tBR3 may be measured, and the delay signals 916b may be (e.g., incrementally) adjusted.

In various aspects, the adjustment of charge voltages and delay times may be carried out on a regular basis. As an example, the adjustment may be carried out whenever an “update event” occurs. An update event may be triggered with every power-up, after a certain time (e.g., every 5 minutes after turn-on, and every 30 minutes after more than one hour of operation), or after a certain number of “shots” (e.g., every 5000 “shots”, illustratively 5000 toggling of signal line Q) of the respective sub-pixel, as examples.

A combination of multiple “update events” in a fashion of “whatever comes first” may be provided. After each update event, all counters and timers responsible to create update events may be reset.

In various aspects, as shown in FIG. 9C, an external photo detector 918c EDET (e.g., a photo detector outside the (sub-)pixel, or even outside the LIDAR module) may be used for calibration to improve linearity and timing of the branches BR1-BR3 (e.g., an adjustment of charge voltages and tuning of delay elements), and of the (internal) photodetector 906c DET1 (e.g., with regard to amplification, photodetector-internal delay element, determining the point in time when the photodetector becomes light sensitive, and time constant determining pulse length, illustratively the time duration for how long the photodetector remains sensitive).

For example, the external detector 918c EDET may be connected temporarily for the calibration purposes. In such configuration, an overall external control circuit 920c ECU (external to the sub-pixel, or to the LIDAR module) may be provided. The external control circuit 920c ECU may be configured to control the external photo detector 918c EDET and to read out the (analog) signal or (digital) measurement value ELM provided by the external photo detector 918c EDET. In addition, the external control circuit 920c ECU may be configured to control the LIDAR module, in particular the respective pixel PI1. As an example, the (remote) control of pixel PI1 may be carried out via bi-directional data communication ECOM with the pixel control 904c CTL (e.g., ECOM sending commands and calibration data to CTL and CTL responding accordingly). The data communication between the two circuits may be established through an internal communication interface INT1 and an external communication interface EINT.

In FIG. 9C, the communication ECOM is shown as a wired communication, but it is understood that it may also be implemented as a wireless communication.

The control circuits 904c, 918c on both sides, CTL and ECTL respectively, may communicate with the respective communication interface INT1 and EINT, via bi-directional digital data busses, ICOM and ECM respectively.

The calibration according to the configuration shown in FIG. 9C may be carried out using an iterative approach, as described above. In addition, the calibration may be carried out at multiple temperatures. In such case the temperature measured by the control 904c CTL (not shown), may be used to generate calibration data providing “perfect” calibration at multiple temperatures. All the generated calibration data may then be utilized during regular operation at any temperature using interpolation techniques (e.g., performed by a microcontroller as part of the control 904c CTL).

The calibration may be conducted at least once, e.g. during production, for example as part of the end of line testing and programming of the LIDAR module. Numerous ways may be provided to calibrate the sub-pixel(s), photo detector(s), pixel(s), or the entire LIDAR module, such as laser trimming, or writing to a non-volatile memory, e.g. a FLASH memory of components of the LIDAR module.

The above approach with the external photo detector 918c may be provided also for LIDAR modules not having built-in photo detectors. In this configuration, the calibration of the photodetectors may be dispensed with, and the rest of the above procedure may be applied.

In the following, exemplary circuitries and components that may be used to implement the approaches described above will be illustrated. The circuitries and components described in the following are provided to show exemplary ways to put into practice the principles described herein. It is understood that the circuitries and components are only exemplary, and other circuitries and components may be provided to implement the same functionalities.

The laser diode drive circuits described below may be used to generate laser pulses, and may be applied to the different approaches described herein. For the sake of representation, the laser diode drive circuits will be illustrated for the case of “additive electrical power modulation”, but it is understood that may be applied also the other approaches described above.

According to various aspects, the switching action of the switches may be very fast. The switches used may be electronic switches, e.g. transistors made of doped semiconductor material. In various aspects, the switches may be transistors of MOSFET (metal oxide field effect transistor) or jFET (junction field effect transistor) construction, e.g. including or being made of silicon (Si), silicon carbide (SiC), or gallium nitride (GaN).

As laser diodes or laser diode arrays may include a “common cathode”, a “common cathode circuit architecture” may be provided, in some aspects. In case of “common cathode” components, the cathode of the laser diode die may be electrically connected with a metal part of the component housing. The metal part of the component housing may be typically mounted to a grounded heatsink.

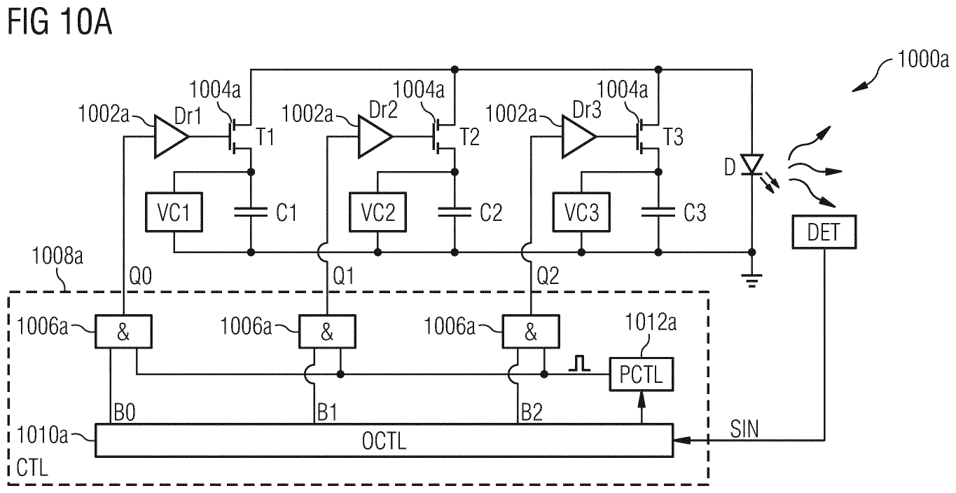

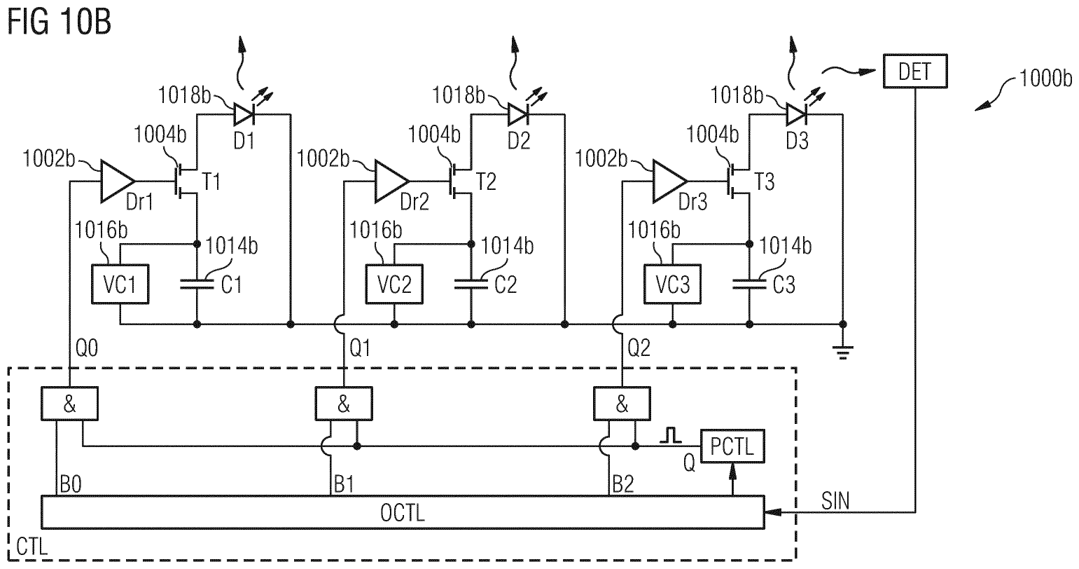

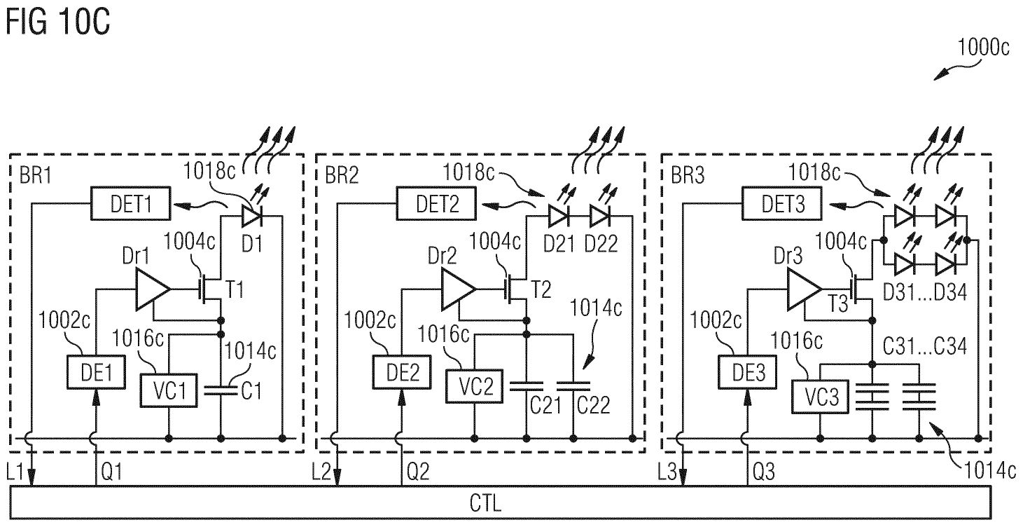

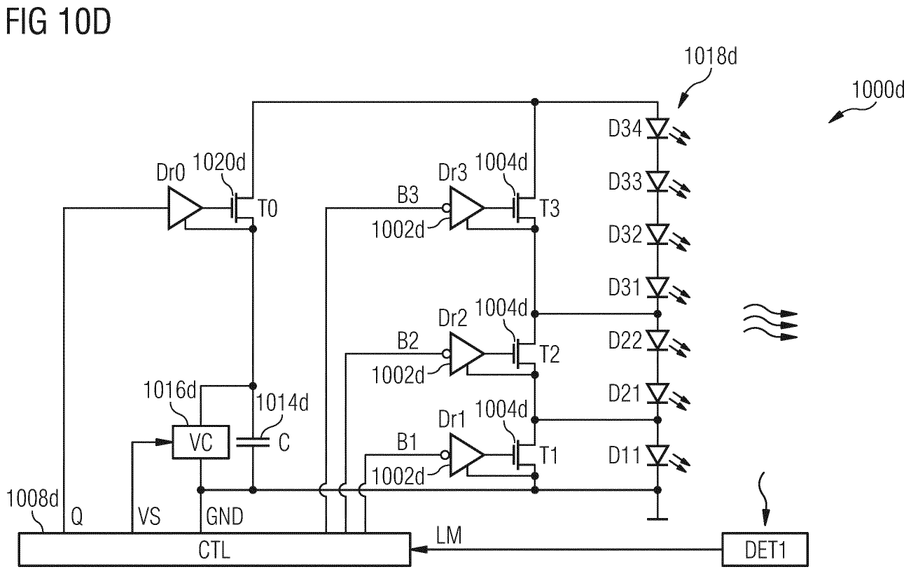

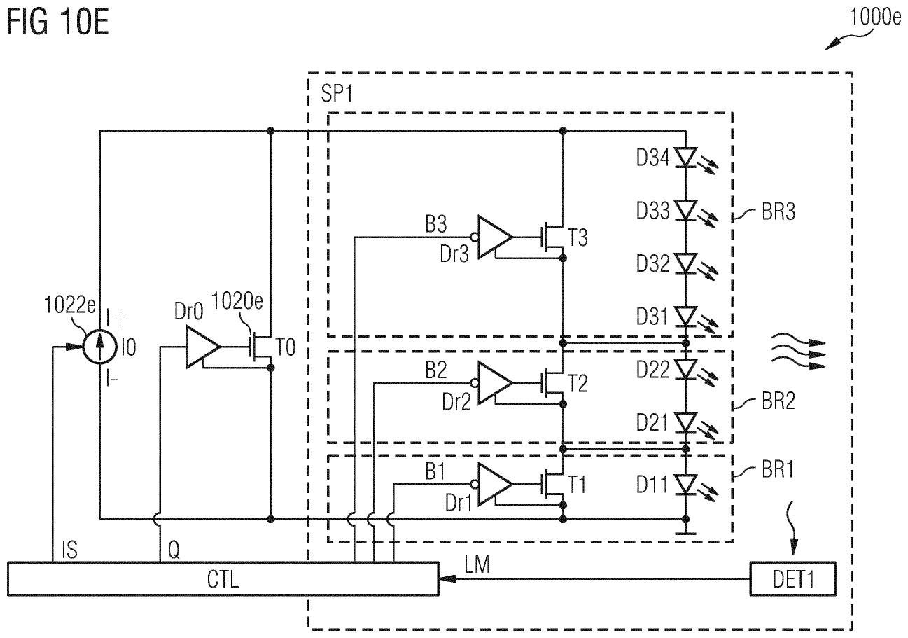

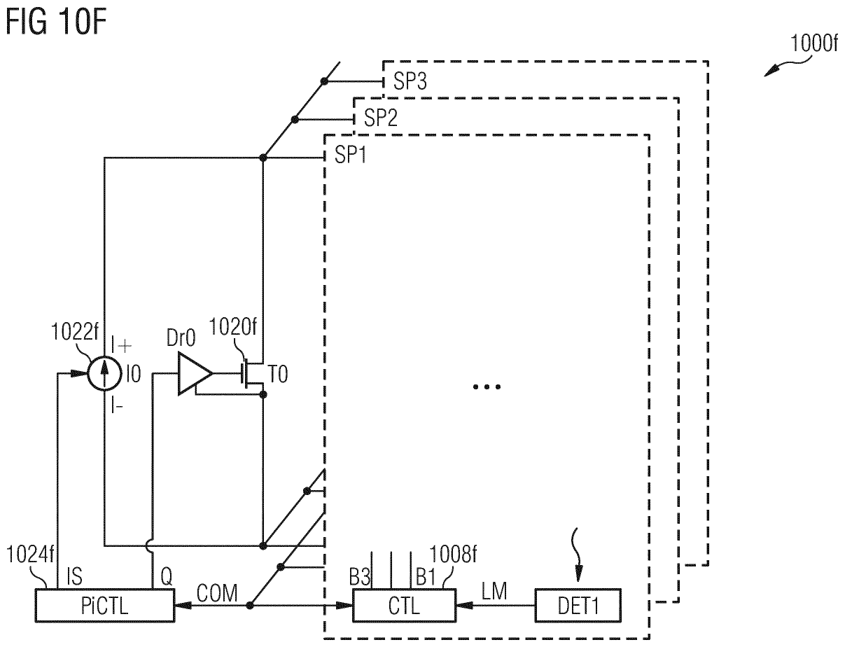

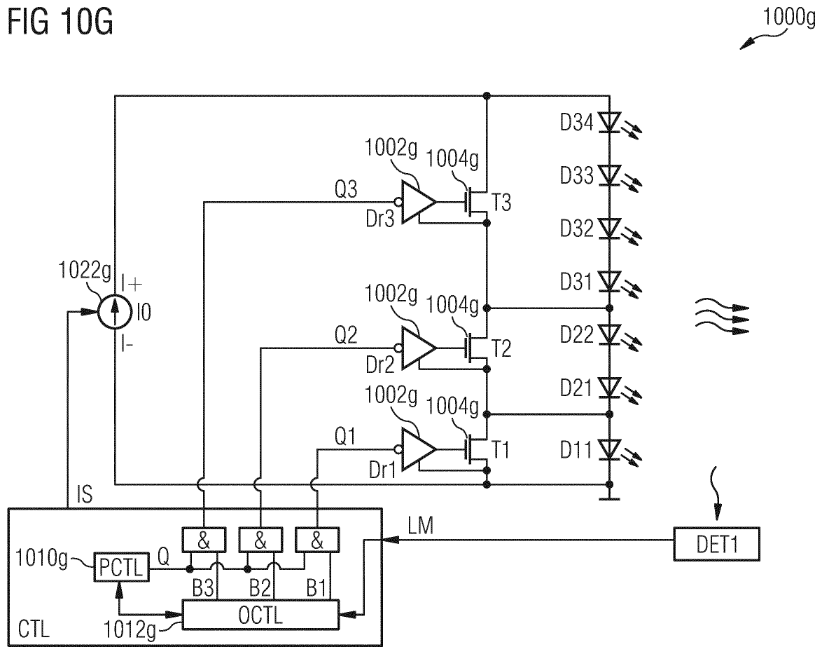

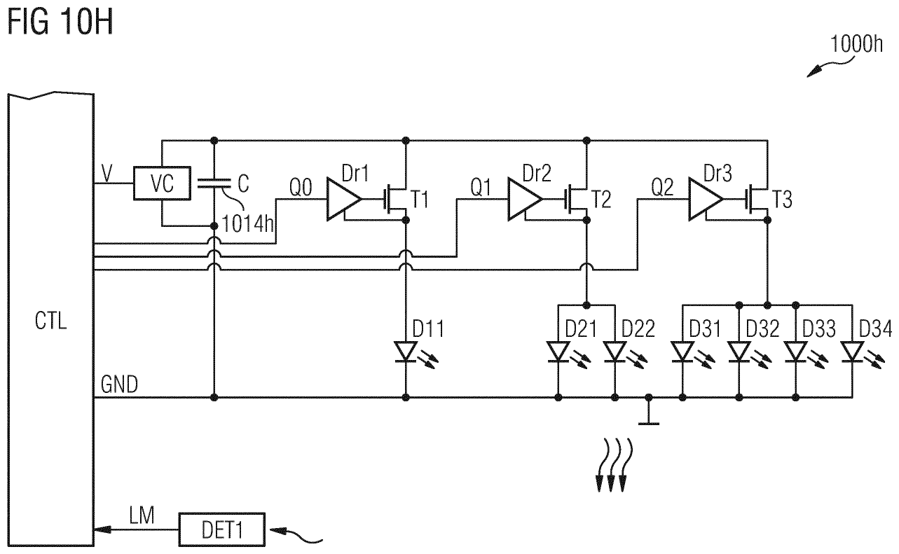

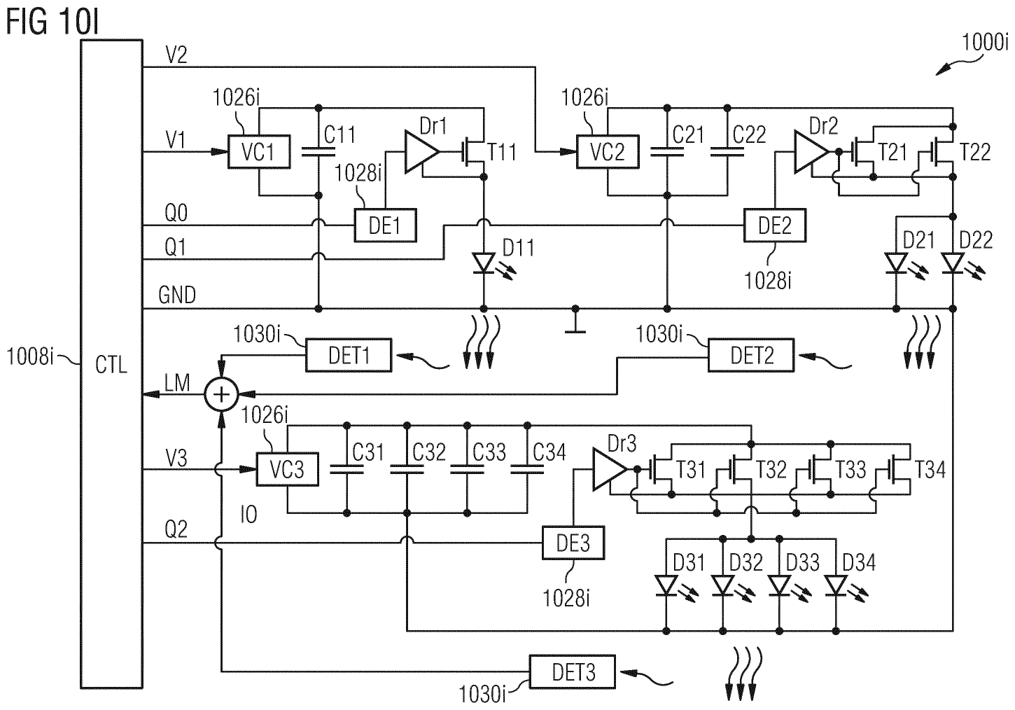

In the following figures FIG. 10A to FIG. 10G, exemplary realizations of a light emitting device (e.g., of the light emitting device 202) are illustrated. The description of the components already described above will be omitted, and the relevant components for the aspects described in the following will be illustrated. It is also understood that the configurations in FIG. 10A to FIG. 10G are exemplary in nature for illustrating various aspects of the electrical and optical approaches described herein. It is understood that other configurations may be provided (e.g., with alternative, additional, or less branches, components, etc.).

FIG. 10A shows a laser diode drive circuit 1000a in a schematic view according to various aspects. The laser diode drive circuit 1000a may be an exemplary implementation of a light emitting device, e.g. of the light emitting device 202.

In the configuration in FIG. 10A, the laser diode drive circuit 1000a may include high-side drivers 1002a Dr1-Dr3 to drive respective field-effect transistors (FETs) 1004a T1-T3 (as exemplary switches to control the discharge of the capacitors C1-C3). Illustratively, the laser diode drive circuit 1000a may provide a LIDAR emitter featuring laser pulses with 8 intensity levels using FETs and respective high-side drivers.

In the configuration in FIG. 10A, the signal switches S01-S03 may realized as AND gates 1006a. In FIG. 10A, the AND gates 1006a are shown as part of the control circuit 1008a CTL, which may include a pulse generation control circuit 1010a PCTL and an output power control circuit 1012a OCTL. A master control circuit MCTL (not shown) may control multiple control circuits 1008a CTL. The control may be provided using a bi-directional communication between the MCTL and the numerous control circuits 1008a CTLs.

FIG. 10B, FIG. 10C shows a light emitting device 1000b, 1000c in a schematic view according to various aspects. The light emitting device 1000b, 1000c may be an exemplary implementation of the light emitting device 202. The light emitting device 1000b, 1000c may be configured according to the approach of “additive optical power modulation”.

The light emitting device 1000b, 1000c may include three branches, each including a capacitor 1014b, 1014c C1/C2/C3, corresponding charging circuit 1016b, 1016c VC1/VC2/VC3, transistor 1004b, 1004c T1/T2/T3, and corresponding high-side driver 1002b, 1002c Dr1/Dr2/Dr3, and laser diode 1018b, 1018c D1/D2/D3. The light emitting device 1000b, 1000c may provide a LIDAR emitter featuring laser pulses with 8 intensity levels.

In various aspects, the branches may be sized in such a way that the light pulse generated by the second branch has twice the magnitude of that of first branch, the third branch generates a pulse of twice the magnitude of the second branch and so on. More energy may be stored and converted from branch to branch. This increased storing and conversion may be achieved by having double the number of capacitors (all of the same capacity and same charging voltage) connected in series, or in parallel, or connected in a combination of both serial and parallel connections. The same may be true for the laser diodes per branch. This implementation is shown in the light emitting device 1000c in FIG. 10C. In addition, in the configuration of the light emitting device 1000c in FIG. 10C, the different branches may have different number of laser didoes 1018c, e.g. the second branch may have twice as many laser diodes 1018c as the first branch (e.g., 2 instead of 1), the third branch may have twice as many laser diodes 1018c as the second branch (e.g., 4 instead of 2), etc.

The light emitting device 1000c may include three branches BR1-BR3 utilizing identical components for capacitors 1016c and laser diodes 1018c (e.g., the laser diodes may be part of a laser diode array) arranged in series and parallel connections forming effectively “larger” capacitors and laser diodes.

In various aspects, “effective transistors” 1004c may be provided, including identical “smaller transistors”, connected in series and/or parallel. In this configuration, care should be taken when selecting components, designing circuit and actual circuit layout, as transistors connected in series should equally share the voltage across them, and in case of paralleling transistors, current should be equally shared amongst the transistors. There may be two options for the implementation of the “smaller transistors”: either just multiple identical transistors where gate, drain and source terminals are connected together, or multiple identical transistors each with its own high-side drivers where the drain and source as well as the input to the high-side drivers are connected together. In both cases, connecting switches (illustratively, “smaller transistors”) in series may be cumbersome and error prone due to component tolerances in components that are not monolithically integrated. In addition, the parallel connection of the “smaller transistors” may cause issues, as precise timing/synchronization of the switches and their high-side drivers may be hard to achieve as long as the “smaller transistors” are not monolithically integrated or at least integrated in the same package (e.g., multi-die approach in a single component package).

FIG. 10D shows a light emitting device 1000d in a schematic view according to various aspects. The light emitting device 1000d may be an exemplary implementation of the light emitting device 202. The light emitting device 1000d may be configured according to the approach of “additive optical power modulation”. As an example, it may be configured to realize a binary power modulation. The light emitting device 1000d may include three branches with respective high-side drivers 1002d, transistors 1004d, and laser diodes 1018d.

In the configuration in FIG. 10D, the branches may share the same energy storage, e.g. the same capacitor 1014d. The capacitor 1014d C and the charge circuitry 1016d VC may be shared by all branches. In addition, the branches may share a same fast-switching power transistor 1020d T0 generating the pulse. Before the transistor 1020d T0 gets activated by the gating signal Q the (potentially slow) drivers 1002d Dr1-Dr2 may be turned on via the signal lines B0, . . . , B3. Then the respective transistors 1004d T1-T3 are short-circuiting the laser diode(s) 1018d of the respective branch. Prior to selecting the laser diodes 1018d that are supposed to contribute to the next light pulse, the charging voltage of the capacitor charging circuit 1016d VC may be set by the control 1008d CTL. The control of the charging circuit 1016d VC may be realized using the charge voltage set signal VS. Based on the number of the laser diodes 1018d contributing to the next pulse, the charge voltage may be increased, thereby increasing the amount of energy dumped into the laser diodes 1018d.

By way of illustration, the light emitting device 1000d may be analogous to a “gear shift converter” (GSC), which includes series-connected light emitting diodes arranged in a binary fashion, thereby creating branches. The LEDs of a branch may be short-circuited for periods of times by parallel-connected transistors. A more advanced “gear shift converter” may implement automatically switching between serial and parallel connection of LED strings, in order to increase LED utilization. A GSC circuitry may be not only suited for AC but also for DC input voltage, thereby enabling emergency lighting with automatic switching from AC mains to battery operation. However, the circuitry “around” the branches, its control as well as the purpose of the arrangement in a GSC is completely different from the circuits proposed, e.g. unrelated to LIDAR applications and to data communication in a LIDAR module. For a GSC, the goal may be to generate a low-cost lighting device operated from AC mains voltage for illumination purposes, for example, with a constant light output. In order to achieve low-cost, a linear regulator in series to the LED string, which is sub-divided in branches, may be used instead of a switch-mode power supply providing the LED current. The linear regulator comes with the drawback of dissipating power proportional to the LED current and to the difference of instantaneous line voltage and the LED string voltage. In order to minimize the power dissipation in the linear regulator, the string voltage is dynamically adjusted with the instantaneous line voltage by short-circuiting more or less branches of the LED string. The switching of the LED strings may lead to serious flickering of the light source. The LED string voltage may be smoothed by a parallel-connected capacitor for each branch and decoupling of the shorting action of the parallel-connected transistor by additional diodes.

In various aspects, the purpose of the arrangements described herein may be to create modulated light output for ranging and communication. The input supply (e.g., an input voltage, for example nominal 12 V in case of an automotive LIDAR system) may be in very good approximation constant for a “full switching cycle” of all power switches involved, thereby generating a single light pulse. The input supply may be assumed to be constant over many pulses. Differently than in a GSC, the light sources used in a LIDAR module described herein are not used to emit light for long periods of time. Thus, capacitors, especially large capacitors or any other sources of power (e.g., the current source described below) may be disconnected from the light emitting devices as soon as the pulse duration is reached, and the light emitting devices are off most of the time. On the contrary, in a GSC, it is the aim of the circuitry to have the light emitting devices emit light as long as possible, in order to reduce flickering, leading to visual irritation of living beings in the lit space.

FIG. 10E, FIG. 10F, FIG. 10G each shows a light emitting device 1000e, 1000f, 1000g in a schematic view according to various aspects. The light emitting device 1000e, 1000f, 1000g may be an exemplary implementation of the light emitting device 202. The light emitting device 1000e, 1000f, 1000g may be configured according to the approach of “additive optical power modulation”. As an example, it may be configured to realize a binary power modulation.

The light emitting device 1000e, 1000f, 1000g may include a common current source 1022e, 1022f utilized by all branches (e.g., via a fast-switching power transistor 1020e, 1020f). The advantage of a circuit arrangement configured as shown in FIG. 10E and FIG. 10F may be that the waveform of the light pulse may be very close to an ideal rectangular shape and the efforts needed to implement the current source (a description on how to construct it is provided below) are low, as there is only one current source 1022e, 1022f per sub-pixel (as it is the case in FIG. 10E, e.g. one current source per driving circuit) or per pixel (see FIG. 10F, e.g. one current source for a plurality of driving circuits).

Extending the concept to a very large number of pixels, which would be fired sequentially, and being supplied by a single current source may be limited by parasitic stray inductances of the electrical connections between the different pixels, leading to more and more non-rectangular sub-pulses and ringing within the circuit.

The light emitting device 1000f in FIG. 10F may include multiple sub-pixels (multiple driving circuits) SP1, SP2, SP3, each having its own control 1008f CTL. The multiple sub-pixels SP1, SP2, SP3 may form a pixel. The overall pixel may be controlled by a pixel control circuit 1024f PiCTL. The pixel control 1024f may be configured to command and communicate with the controls 1008f of the sub-pixels via a bi-directional data communication bus COM. The common current source 1022f may be utilized by all sub-pixels.

The light emitting device 1000g in FIG. 10G may provide the same functionality as the light emitting device 1000e requiring a component less. In the configuration in FIG. 10G, the fast-switching power transistor (and associated gate driver) may be dispensed with. In this configuration, all branch switches, namely the transistors 1004g T1-T3 and their respective high-side drivers 1002g Dr1-Dr3 may be fast-switching. Saving of the parallel switch T0 may be achieved by having all branch switches performing its function, illustratively short-circuiting of the current source 1022g as long as the sub-pixel (the driving circuit) is not supposed to emit light. All the switches 1004g may be conducting unless the associated laser diodes are supposed to emit light. In this configuration, the transistors 1004g themselves may be driven by the inverted signal of the respective gating signal Q1-Q3 derived by an AND operation of the respective branch signal B1-B3 and the output signal Q of the pulse control 1010g PCTL. As an example, the pulse control 1010g PCTL may be realized by a timer (mono-flop with a time constant equal to sub-pulse duration T_{Pi}, assuming the respective sub-pixel is sub-pixel i), triggered by the overall sub-pixel control 1012g OCTL. The pulse control 1010g PCTL may further include pulse shaping/pulse forming circuitry (e.g., Schmitt-triggers) to ensure improved signal quality for the generated signal Q.

FIG. 10H and FIG. 10I each shows a light emitting device 1000h, 1000i in a schematic view according to various aspects. The light emitting device 1000h, 1000i may be an exemplary implementation of the light emitting device 202.

The light emitting device 1000h in FIG. 10H may be configured in a similar manner as the light emitting device 1000d described in FIG. 10D. However, instead of a series-connection of branches that are shorted out (via parallel switches) in the case that they are not supposed to contribute to the light generation, in the light emitting device 1000h a parallel connection of branches is implemented, where only those branches that need to contribute to the light generation are connected (via series-connected switches) to the source (the capacitor 1014h).

The light emitting device 1000i in FIG. 10I may be an advanced versions of the light emitting device 1000h using a modular approach. In this configuration, only one kind of power component (capacitors Cxy, transistors Txy and laser diodes Dxy) may be used.

As noted above, when paralleling transistors, care should be taken to ensure proper current sharing among the devices, which for most FETs is not an issue due to their internal structure and temperature behavior. In addition, in the configuration in FIG. 10I, each branch may have its own capacitor charge circuitry 1026i VC1-VC3, delay elements 1028i DE1-DE3, and photo detector 1030i DET1-DET3. To reduce complexity, the output signals of all the photo detectors 1030i may be added before being provided to the control circuitry 1008i. Even though then the control circuitry 1008i only gets the sum of the measured light levels, the control circuitry 1008i has the knowledge of which branches were operating at any given point in time and the control circuitry 1008i may command which branches are contributing, thereby the control circuitry 1008i may be able to determine the parameters for the calculations (e.g., for assessing functionality, for example for functional safety, or for calibration purposes as described above).

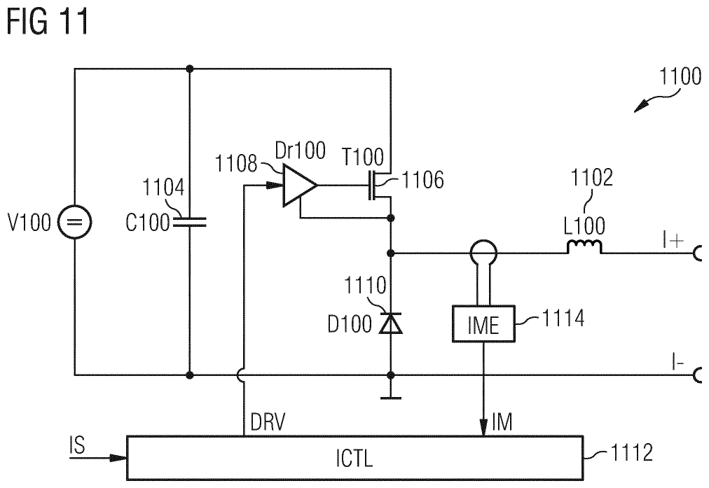

FIG. 11 shows a current source 1100 in a schematic view according to various aspects. The current source 1100 may be an exemplary implementation of the current source 1022e, 1022f described in relation to FIG. 10E and FIG. 10F.

The current source 1100 may include an inductor 1102 L100 of significant size which gets energized to a defined current level set by a (analog or digital) current set signal IS provided by the control CTL or the pixel control PiCTL.

A significant inductor size may be understood as the inductor having an inductance value large enough so that the inductor current during the pulse gets reduced only by a fraction, not reaching zero. Ideally the inductor current only decreases by 10% during the pulse.

Illustratively, the circuit formed by capacitor 1104 C100, transistor 1106 T100 and associated gate driver 1108 Dr100, inductor 1102 L100 and diode 1110 D100 is a buck converter as known in the art. The control circuitry 1112 ICTL of the current source 1100 may be configured to establish a control loop, with the aim that the output current I+ measured by the current measuring circuit 1114 IME providing the current measurement signal IM equals the set current provided by the current set signal IS.

The control circuit 1112 ICTL may be configured to generate a pulse width modulated signal at its output DRV. The control may be implemented using various known control approaches, like a PID control or a hysteretic control, as known in the art.

The switching frequency of the drive signal DRV may be on the order of about 10 kHz to a few 10 MHz, leading to the control loop being typically not able (due to its mediocre dynamic performance) to regulate the current in time spans of sub-pulses. Therefore the above-mentioned significant size of the inductor may be provided to keep the current approximately constant during a sub-pulse and also during an entire pulse.

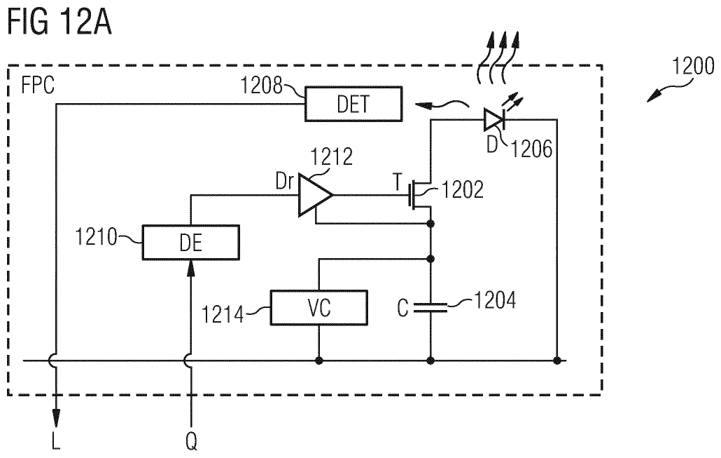

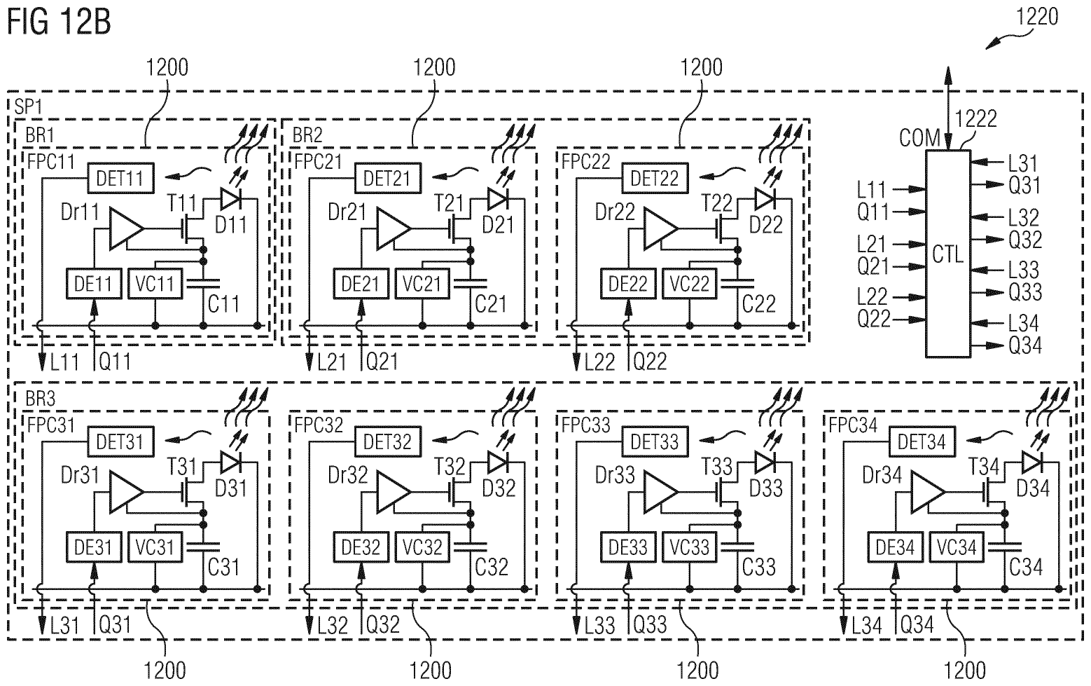

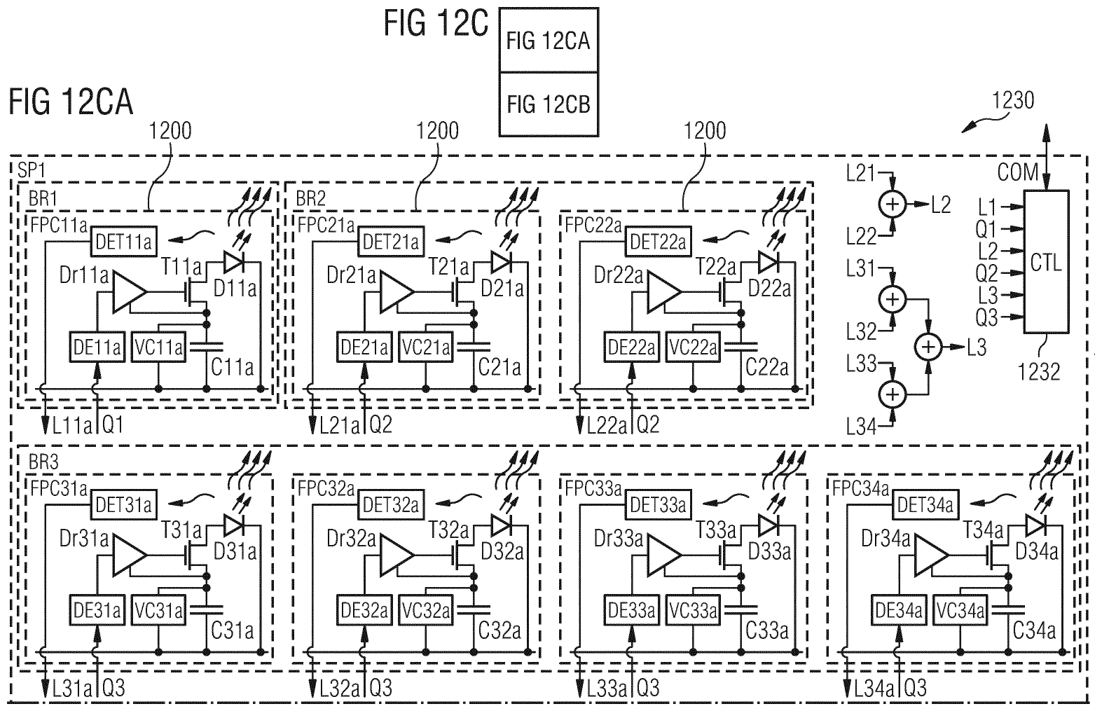

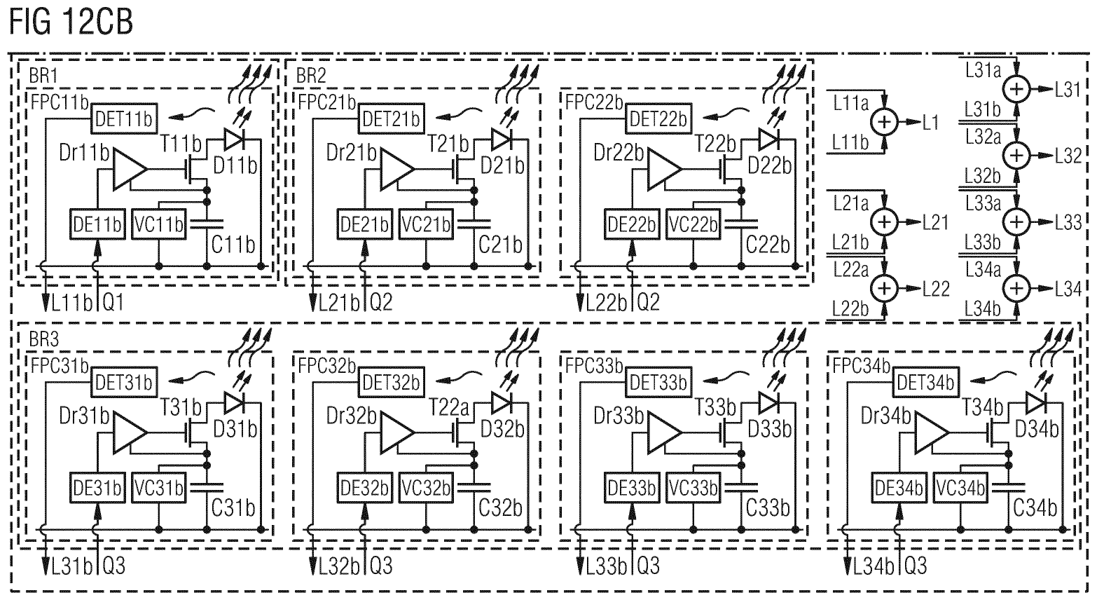

In the following, in relation to FIG. 12A to FIG. 12C, a modular approach for providing a light emitting device (e.g., as introduced in relation to FIG. 10I) will be described in further detail.

The modular approach mentioned in relation to FIG. 10I may be further detailed by defining a self-confined fundamental unit, having the following features:
configured to provide a (small) but well-defined laser light pulse;
supplied by power; and
configured to communicate with a branch/sub-pixel, by which it is controlled.

Such a unit may be referred to herein as the fundamental (light) pulse (emitting) cell FPC.

FIG. 12A shows a fundamental pulse cell 1200 in a schematic view according to various aspects.

The FPC 1200 may include, at a minimum an electronic switch/transistor 1202 T, a capacitor 1204 C, and a laser diode 1206 D. More components may optionally be present in the FPC 1200, such as a photo detector 1208 DET, delay element 1210 DE, gate driver 1212 Dr, and capacitor charge circuit 1214 VC.

FIG. 12B shows a light emitting device 1220 in a schematic view according to various aspects. The light emitting device 1220 may be a sub-pixel including three branches BR1-BR3 implementing a pulse source using the modular approach outlined above. The light emitting device 1220 may be an exemplary configuration of the light emitting device 202.

The light emitting device 1220 may include a plurality of (e.g., seven) fundamental pulse cells 1200 FPC11, . . . , FPC34, configured as described in relation to FIG. 12A. Each FPC 1200 may realize a contribution to a plurality of (e.g., seven) equidistant intensity levels that may be generated by the sub-pixel 1220 controlled by the control circuit 1222 CTL. The control circuit 1222 may receive the light level information for the next pulse (which may be buffered inside the control 1222 CTL using flip-flops) and the trigger signal or timing signal determining when to “fire” the pulse, over a bidirectional data communication COM, e.g. from a pixel controller (not shown).

As described above, a sub-pixel may include multiple branches depending on how granular the light levels should be provided. Each branch may include one or multiple fundamental pulse cells 1200, and all cells of a branch may be “fired” simultaneously (except for small timing differences due to parasitic effects caused by the layout, or manufacturing tolerances, which effects may be offset by adjusting the respective delay elements 1210). In this configuration, a single control line from the sub-pixel control 1222 CTL to each branch for “firing” the respective branch may suffice. In the case that an addressability of individual parts of a branch (e.g., for calibration) is to be provided, more signal lines Q may be implemented.

FIG. 12C shows a light emitting device 1230 in a schematic view according to various aspects. The light emitting device 1230 may be an exemplary configuration of the light emitting device 202. In the configuration in FIG. 12C, every single fundamental cell 1200 may be addressed individually. For the sake of representation, FIG. 12C is represented as FIG. 12CA and FIG. 12CB, it is however understood and described as a single figure FIG. 12C.

The light emitting device 1230 in FIG. 12C may include three branches using the same approach as the circuit 1220 in FIG. 12B. In the configuration in FIG. 12C, each branch may include twice the number of fundamental pulse cells 1200 as mathematically required (noted with the letters “a” and “b” in FIG. 12C, e.g. the first branch BR1 may include the cells FPC11a and FPC11b, etc.). By doubling the number of fundamental pulse cells 1200, the light output power of the entire arrangement may be doubled.

Using multiples of the minimal set of fundamental pulse cells 1200 may allow the use of fundamental pulse cells 1200 of a given technologically or economically optimal size. It may also allow highly-integrated arrangements, e.g. the integration of multiple sub-pixels, pixels or even the entire emitter into a single component package. Also, monolithic integration may be provided with this approach.

The light emitting device 1230 in FIG. 12C may implement a simple approach for reducing complexity. A single gating signal Q1-Q3 is utilized per branch. Similarly, all the outputs of photodetectors (analog or digital) may be summed up before being provided as cumulated signals/data L1-L3 to the control circuit 1232. The summation may be realized, for example, by each photo detector 1208 behaving as a current source (“photon-to-electron converter”) and all outputs of the photo detectors 1208 may be connected together thereby providing the sum as an analog value to the control circuit 1232.

Examples of optoelectronic integration in a single package and/or monolithic integration may include a die pixelated but not diced II-V in the middle of Si (in case of III-V-semiconductors), the die may be mounted on a Cu leadframe, or a Si-die with a plurality (illustratively, lots) of small III-V-single-laser diodes on top. A combination of both methods may also be provided, e.g. many III-V dies on a large Si-die where each III-V holds a number of individually addressable laser diodes. Laser diodes may be realized as VCSEL arrays. These VCSEL arrays may be diced on a plurality of small VCSEL arrays part of the arrangement or the VCSEL arrays may be a non-diced array or arrays being part of the described arrangement.

In the following, system implementations, including mechanical arrangements and thermal considerations will be described.

As described above, a light emitting device (e.g., the light emitting device 202) may include pixels, each pixel may include one or multiple sub-pixels, each sub-pixel may include one or multiple branches, and each branch may include of one or multiple fundamental pulse cells. The above configurations, for example as shown in FIG. 12B and FIG. 12C, may raise the question of how to geometrically arrange the individual parts of a LIDAR emitter.

Two main aspects may be considered with regard to how to arrange these parts: thermal and optical considerations, assuming that the electrical wiring of the parts is a hard boundary.

From an optical point of view, deterioration of optical properties of the primary and secondary optics may be more likely be found on the periphery than in the inner section of the optics. This may be provided by the design of the optics itself, and/or by the production process (e.g., molds may be typically made in such a way that imperfections like spots and the like are on the outside of the optical part rather than in the center) and quality control.

Considering this optical aspect, the “lower order” branches may be provided more to the inside in order to reduce the relative error. Let's consider, for explanation purposes, a non-transparent spot with the size of a laser diode, absorbing half of the light of the respective laser diode. In case the deterioration would impact branch 1, e.g. including a single laser diode, then in case the commanded light output would only come from branch 1, only 50% of the commanded light output would be available, whereas if branch 3, having 4 laser diodes, would be impacted by the spot and even considering light from branch 3 only, still 3.5/4=87.5% of the commanded light output would be available.

From a thermal point of view, the parts that are further to the inside of a structure typically get hotter (assuming that the parts are generating heat) than parts further to the outside. In case of an adaptive light level adaptation, the light level is rarely changing a lot in most applications, therefore the branches of higher order may be either “fired” every pulse or not “fired” for a long time, whereas the status of “lower order” branches may be fluctuating more often.

Considering that thermal issues (e.g., the risk of overheating) will more likely occur at high light output levels, the parts belonging to higher order branches may be arranged more to the outside (also in case of 2D arrangements there is more space toward the outside than towards the middle), whereas lower order branches may be arranged more the inside.

Considering these aspects from the other way round, then the “lowest bit” (illustratively, the branch 1 of each sub-pixel) may be on average “on” for only half of the pulses. Therefore this branch may be arranged in the center (where cooling is worst), as it may not be guaranteed that the higher order branches will not be “on” for very long periods of time and then potentially overheat if arranged in the center.

Thus, the derived rule makes sense from a thermal and an optical point of view.

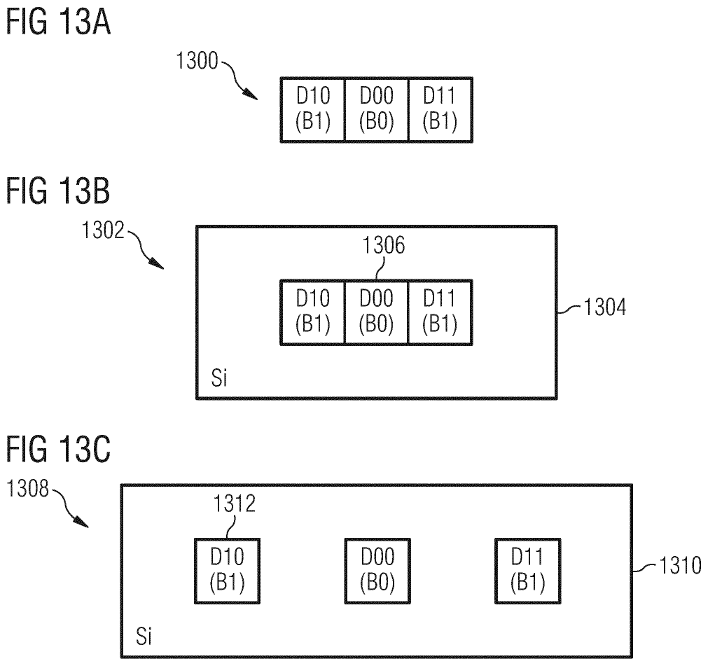

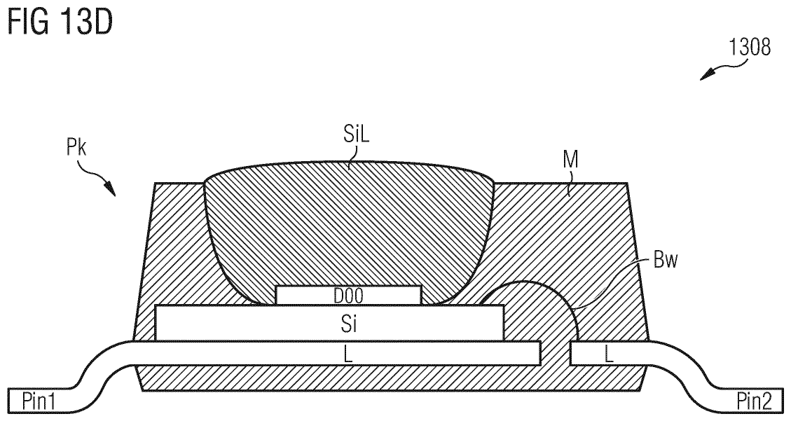

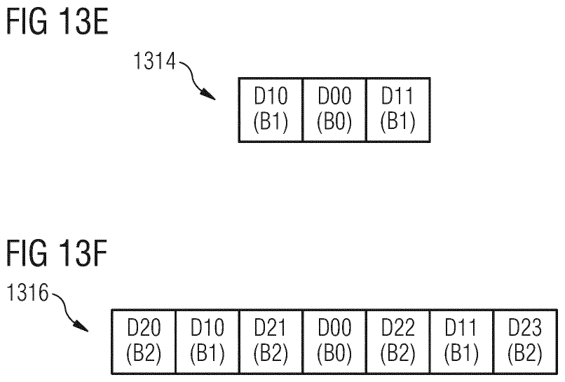

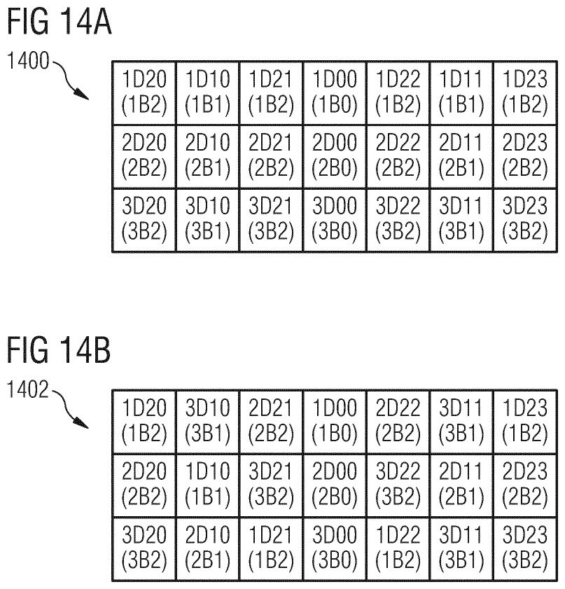

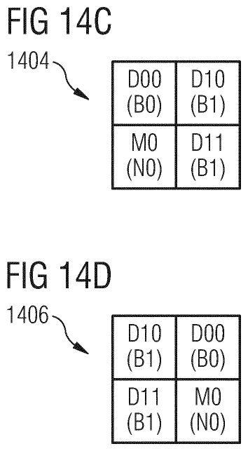

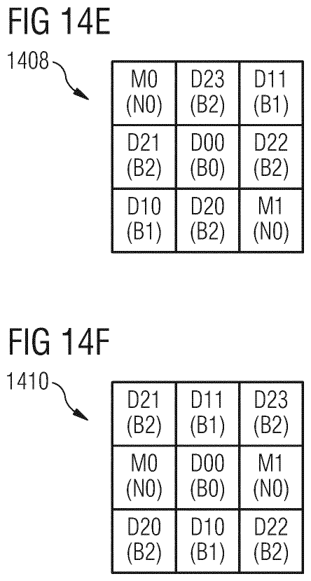

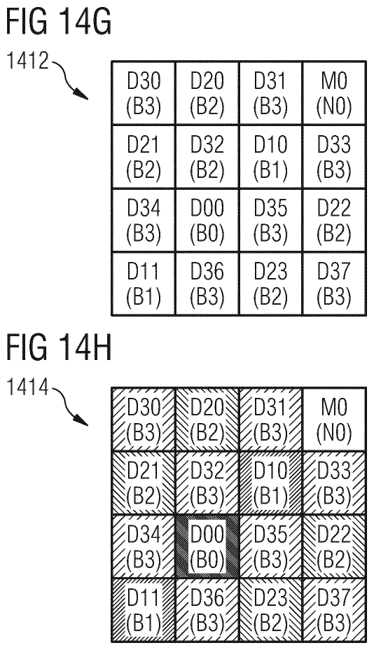

In various aspects, a “spiral rule” may be provided for arranging branches in a light emitting device. The “spiral rule” may include arranging the branches with increasing order from the inside to the outside (see FIG. 13A, FIG. 13E, and FIG. 14F, for example).

The rotational symmetry (the pattern may be rotational symmetric around the center) may also be advantageous from an optical point of view (all the branches, even if the individual laser diode are not exactly providing the same amount of light, may be in this case on average generating a beam by with least irregularities).

There may be another consideration. Either all parts of a single branch (of a specific sub-pixel) generate heat (all the electronics as well as all the laser diodes) or none of the parts. Therefore, the distances between the individual parts of a specific branch may be made as large as possible for best heat spreading. In various aspects, a “chess board rule” may be provided, based on these considerations (see FIG. 13F, FIG. 14G, and FIG. 14H, for example).

In case thermal considerations are to be weighted higher than optical consideration—which may be true for most applications and use cases—then the chess board rule takes precedence over the spiral rule. For those applications and use cases some examples are presented below in FIG. 13A to FIG. 13F and FIG. 14A to FIG. 14H. In FIG. 13A to FIG. 13F and FIG. 14A to FIG. 14H the disposition of diodes D (e.g., light emitting diodes, laser diodes, a stack of diodes, etc.) of different branches (B0, B1, B2, etc.) is illustrated to describe the above-mentioned “rules”. A diode of a branch may be noted as D followed by the number of the branch and the number of that diode within the branch, e.g. D10 may be the zero-th (the first) diode of the first branch, D11 may be the second diode of the first branch, etc. In the case of multiple “sub-pixels” (multiple driving circuits), the notation is preceded by the corresponding number of the sub-pixel (e.g., 1D10 is the zero-th (the first) diode of the first branch of the first sub-pixel, etc.). It is understood that the configurations in FIG. 13A to FIG. 14H are exemplary to illustrate the principles described above, and other configurations following the same considerations may be provided.

FIG. 13A shows a LIDAR emitter 1300 (a light emitting device) in a schematic view according to various aspects. The LIDAR emitter 1300 may be configured as a one dimensional array.

The LIDAR emitter 1300 may include a single pixel with a single sub-pixel having two branches (B1 and B2). The LIDAR emitter 1300 may thus include three laser diodes (D00, D10, D11) in total. Discrete electronics and a single optoelectronic laser component may be used, holding all three laser diodes on a single-die. Then according to the above rules the laser diodes may be connected in such a way that the diode D00 is the middle one, as shown in FIG. 13A.

FIG. 13B shows the mechanical arrangement of an integrated optoelectronic component 1302 in a schematic view according to various aspects (e.g., as the case when a VCSEL array is used).

The optoelectronic component 1302 may be integrated on a silicon die 1304 (having all the electronic circuitry except for the laser diodes embedded in it), and another smaller die 1036 made of III-V-semiconductor material carrying the three laser diodes may be bonded on top.

In FIG. 13B the area of each laser diode may be separated by a thin line from the area of the neighboring laser diode for illustration purposes.

The substrate 1304 may be soldered to a leadframe (not shown), for example made from copper or a copper alloy. This arrangement may be encapsulated, for example using injection molding by a light-absorbing plastic housing (not shown) except for the top part (where the laser diodes are) which may be filled with transparent silicone in a last step (not shown).

As the arrangement is used as laser transmitter line (1D-Array) forming a single pixel with two 2 branches, the arrangement may be similar to the one shown in FIG. 13A.

FIG. 13C and FIG. 13D each shows the mechanical arrangement of an integrated optoelectronic component 1308 in a schematic view according to various aspects. The optoelectronic component 1308 may include a silicon substrate 1310 carrying the multi laser diode die 1312, being used as laser transmitter line (1D-Array) with 2 branches. FIG. 13D is a cross-sectional view of the optoelectronic component 1308.

In case the three individual laser diodes (each as on own die, e.g. as the case with edge emitting laser diodes) are used in the design of the optoelectronic component 1308, then the layout may be changed in order to separate the dies from each other for better thermal spreading.

As the selection about which laser diode is assigned to which function (e.g., to which branch) may be made irrespective of the exact making of the optoelectronic component or module, an even more simplified configuration of the arrangement may be provided.

FIG. 13E and FIG. 13F illustrate the mechanical arrangement of an integrated optoelectronic component 1314, 1316 in a schematic view according to various aspects.

FIG. 13E and FIG. 13F may represent in a simplified manner the arrangements of the setups shown in FIG. 13B to FIG. 13D. FIG. 13E may represent in a simplified manner a mechanical arrangement of a laser transmitter line (1D-Array) having 2 branches. A mechanical arrangement as shown in FIG. 13F may be provided following the above-defined rules on how to arrange/select the laser diodes (for a single pixel consisting of a single sub-pixel which includes 3 branches).

In the following this kind of representation may be used. “D” may refer to the laser diode only. Each figure showing a “mechanical arrangement” may be understood as representing the mechanical arrangement of a laser diode, e.g. in a package or a module. The laser diodes may be arranged in a line (1D-Array) or rectangle (2D-Array). In case of 2D arrays the shape of a square may be provided for some application, for other applications a pronounced rectangular shape may be provided, considering the resolutions of the LIDAR module in both dimensions. “D” may also refer to a “sandwich” of laser diode and electronics as illustrated above.

FIG. 14A, FIG. 14B, FIG. 14C, FIG. 14D, FIG. 14E, FIG. 14F, FIG. 14G, FIG. 14H each shows the mechanical arrangement of a two-dimensional optoelectronic component 1402, 1404, 1406, 1408, 1410, 1412, 1414 in a schematic view according to various aspects. These optoelectronic components 1402, 1404, 1406, 1408, 1410, 1412, 1414 may be an exemplary implementation of a light emitting device or a part of a light emitting device.

By expanding the pixel of the LIDAR module described in FIG. 13F by an additional two sub-pixels, the parts may be arranged into an arrangement 1400 as shown in FIG. 14A. This “in-line arrangement” may provide improved optical performance (assuming the focus of a single primary and potentially also the secondary optics in the center of the array).

The arrangement 1400 may form a single pixel with three sub-pixels (with 3 branches each). The sub-pixel may be indicated by the leading digit, similar to the nomenclature above. Each sub-pixel may be arranged in a separate line. However, this arrangement does not obey the “chess board rule” (e.g., may be optimal from an optics but not from a thermal point of view). Therefore, the arrangement may be adapted as shown in the FIG. 14B (optimal from both optics and thermal point of view).

In the case of a single branch, the chess board rule may also apply, two examples for LIDAR modules having a single pixel with a single sub-pixel and only two branches are shown in FIG. 14C and FIG. 14D.

In various aspects, an “artificial branch” called MO holding all not-used spots (N0, N1, N2, . . . ) of the arrangement may be provided in order to make up a quadratic (or in general a rectangular) shaped array.

As for FIG. 14C and FIG. 14D, the FIG. 14E and FIG. 14F illustrate a single pixel, single sub-pixel arrangement with 3 branches.

FIG. 14G and FIG. 14H illustrate an option of an arrangement obeying the above rules in case of 4 branches.

In various aspects, coding schemes which take into consideration the above-mentioned rules may be provided. Such coding schemes may take into account that there are bits (those being created by higher order branches, using a lot of light) that are more robust than other bits.

In the present description, according to various aspects, methods realizing binary intensity modulation may be provided. The control setting the required amplitude for the next laser pulse may be implemented in a digital control, hence providing the set value in a binary way is just natural/the most trivial implementation, e.g. no coding into another digital format or even a digital to analog conversion of the set value may be needed. Using a binary-coded digital signal as the set value and for the command of the power stage can be implemented in a simple manner (low effort/low complexity/low cost). The set value may be combined with the trigger signal via AND gates (e.g., the set value may define which power switches/transistors get turned on by the trigger signal).

Compared with a modulation of the charging voltage of the pulse capacitor(s) the described method may provide a very high linearity, due to a simple summation of optical or electrical power, thus being not or effectively not dependent on non-linearities in the Phi-I-curve of the laser diode(s).

Due to its modular approach the integration of the circuit or a part of the circuit in a “component plus” (Laser diode (s) plus some additional components) may be provided (e.g., providing advantages in terms of cost, scalability to many “bits” of resolution, improved reliability, etc.).

Applying the “additive approach” may be energy-efficient, as for stronger pulses (higher amplitude) energy is summed up, rather than always consuming the same amount of energy (as it would be the case in a “subtractive approach” or in case of modulation of an in-series resistance). The approach may also ensure high dynamic performance. Regardless of whether pulses with high or low energy are generated the circuit always uses the same amount of time to “charge” and then deliver the pulse.

In the following, various aspects of this disclosure will be illustrated. The aspects may refer to the LIDAR module 100 described above.

Example 1 is a LIDAR module including: a light emitting device configured to emit a light signal in accordance with a combination of a plurality of partial signals; and one or more processors configured to: encode a sequence of symbols, wherein each symbol is associated with a respective combination of the plurality of partial signals, and control the light emitting device to combine the plurality of partial signals as a function of the encoded sequence of symbols to emit the light signal.

In Example 2, the LIDAR module of example 1 may optionally further include that the combination of the plurality of partial signals associated with a symbol includes a combination of a subset of the plurality of partial signals; and/or that the combination of the plurality of partial signals associated with a symbol includes a combination of all the partial signals of the plurality of partial signals.

In Example 3, the LIDAR module of example 1 or 2 may optionally further include that the sequence of symbols is configured to carry data to be transmitted. As an example, the data may include information to identify the LIDAR module. As another example, additionally or alternatively, the data may include information to characterize (e.g., distinguish) the emitted light signal.

In Example 4, the LIDAR module of any one of examples 1 to 3 may optionally further include that the plurality of partial signals include a plurality of partial light signals, and that the combination of the plurality of partial signals includes an optical combination of the plurality of partial light signals.

In Example 5, the LIDAR module of any one of examples 1 to 4 may optionally further include that the plurality of partial signals include a plurality of partial electrical signals, and that the combination of the plurality of partial signals includes an electrical combination of the plurality of partial electrical signals.

In Example 6, the LIDAR module of any one of examples 1 to 5 may optionally further include that the combination of the plurality of partial signals includes an additive combination of the plurality of partial signals and/or a subtractive combination of the plurality of partial signals.

In Example 7, the LIDAR module of any one of examples 1 to 6 may optionally further include that the emitted light signal includes one or more light pulses (e.g., one or more laser pulses), and that each light pulse of the one or more light pulses is associated with respective one or more symbols of the sequence of symbols.

In Example 8, the LIDAR module of example 7 may optionally further include that at least one light pulse of the one or more light pulses is associated with a respective one symbol of the sequence of symbols, and/or that at least one light pulse of the one or more light pulses is associated with a respective plurality of symbols of the sequence of symbols, and/or that the one or more light pulses include a plurality of light pulses, and a subset of the plurality of light pulses is associated with a respective one symbol of the sequence of symbols.

In Example 9, the LIDAR module of example 7 or 8 may optionally further include that a first light pulse of the one or more light pulses is associated with one or more first symbols of the sequence of symbols, a second light pulse of the one or more light pulses is associated with one or more second symbols of the sequence of symbols, and that the first light pulse has a first signal level different from a second signal level of the second light pulse.

In Example 10, the LIDAR module of any one of examples 7 to 9 may optionally further include that at least one light pulse of the one or more pulses includes a plurality of pulse portions, each pulse portion having a respective signal level, and that the signal levels of the plurality of pulse portions are defined by the one or more symbols associated with the at least one light pulse.

In Example 11, the LIDAR module of example 10 may optionally further include that the plurality of pulse portions define a shape of the at least one light pulse, and that the shape is associated with the one or more symbols associated with the at least one light pulse.

In Example 12, the LIDAR module of any one of examples 7 to 11 may optionally further include that at least one light pulse of the one or more pulses includes a first pulse portion having a first energy and a second pulse portion having a second energy, and that the first energy is complementary to the second energy with respect to a total energy of the at least one light pulse.

In Example 13, the LIDAR module of example 12 may optionally further include that the first energy being complementary to the second energy includes a result of a summation of the first energy with the second energy being substantially 100% of the total energy of the at least one light pulse.

In Example 14, the LIDAR module of any one of examples 7 to 13 may optionally further include that at least one light pulse of the one or more light pulses has a pulse shape selected from the list of shapes including: rectangular, quasi-rectangular, or Gaussian.

In Example 15, the LIDAR module of any one of examples 7 to 14 may optionally further include that at least one light pulse of the one or more pulses has a duration in the range from 1 ps to 1 ms, for example in the range from 10 ps to 10 μs, for example in the range from 100 ps to 100 ns, for example in the range from 200 ps to 25 ns.

In Example 16, the LIDAR module of any one of examples 7 to 15 may optionally further include that the one or more light pulses include a number of light pulses in the range from 1 to 100, for example in the range from 2 to 10.

In Example 17, the LIDAR module of any one of examples 1 to 16 may optionally further include that the emitted light signal has a total duration in the range from 1 ps to 100 ms, for example in the range from 10 ps to 1 ms, for example in the range from 100 ps to 10 μs, for example in the range from 200 ps to 2.5 μs.

In Example 18, the LIDAR module of any one of examples 1 to 17 may optionally further include that at least a portion of the sequence of symbols is uniquely associated with the LIDAR module and/or with the light emitting device.

In Example 19, the LIDAR module of example 18 may optionally further include that the at least one portion of the sequence of symbols includes a serial number of the LIDAR module and/or a serial number of the light emitting device.

In Example 20, the LIDAR module of any one of examples 1 to 19 may optionally further include that a signal level of the emitted light signal includes at least one of an amplitude or a power of the emitted light signal.

In Example 21, the LIDAR module of any one of examples 1 to 20 may optionally further include that the light emitting device includes a plurality of partial light sources, each partial light source being configured to emit a respective partial light signal.

In Example 22, the LIDAR module of example 21 may optionally further include that each partial light source of the plurality of partial light sources is configured to emit the respective partial light signal at a signal level different from the signal level of the other partial light signals emitted by the other partial light sources.

In Example 23, the LIDAR module of example 22 may optionally further include that at least one partial light source of the plurality of partial light sources is configured to emit twice the luminous flux of at least one other partial light source of the plurality of partial light sources.

In Example 24, the LIDAR module of example 22 or 23 may optionally further include that the plurality of partial light sources include a first partial light source, a second partial light source, and a third partial light source, that the second partial light source is configured to emit twice the luminous flux of the first partial light source, and that the third partial light source is configured to emit twice the luminous flux of the second partial light source.

In Example 25, the LIDAR module of any one of examples 22 to 24 may optionally further include that the control of the light emitting device to combine the plurality of partial signals includes the one or more processors being configured to control a combination of the partial light signals by controlling which partial light sources emit the respective partial light signal.

In Example 26, the LIDAR module of any one of examples 22 to 25 may optionally further include that the plurality of partial light sources include at least one light emitting diode.

In Example 27, the LIDAR module of any one of examples 22 to 26 may optionally further include that the plurality of partial light sources include at least one laser diode (e.g., a plurality of laser diodes, for example an array or a stack of laser diodes).

In Example 28, the LIDAR module of any one of examples 22 to 27 may optionally further include that the light emitting device further includes an emitter optics arrangement configured to receive the partial light signals, and to combine together the partial light signals to emit the light signal.

In Example 29, the LIDAR module of any one of examples 22 to 28 may optionally further include that the one or more processors are configured to generate a gating signal, the gating signal being representative of which partial light sources to activate as a function of the encoded sequence of symbols, and that the one or more processors are configured to control the plurality of partial light sources by using the gating signal.

In Example 30, the LIDAR module of example 29 may optionally further include that the one or more processors are configured to generate the gating signal by using a same clock signal as the clock signal determining a repetition rate of the light emitting device.

In Example 31, the LIDAR module of example 29 or 30 may optionally further include that each partial light source is associated with (e.g., connected to) a respective switch, and that the gating signal includes a respective instruction for each switch to connect or disconnect the associated partial light source from a power supply.

In Example 32, the LIDAR module of example 31 may optionally further include that at least one switch is realized as a logic gate. As an example, the logic gate may include an AND gate.

In Example 33, the LIDAR module of any one of examples 1 to 32 may optionally further include that the light emitting device includes a light source configured to emit light, and that light emitting device includes a beam-splitting device configured to split the light emitted by the light source into a plurality of partial light signals.

In Example 34, the LIDAR module of example 33 may optionally further include that the light emitting device further includes an optical arrangement configured to absorb or redirect one or more of the plurality of partial light signals as a function of the encoded sequence.

In Example 35, the LIDAR module of example 34 may optionally further include that the optical arrangement includes a controllable light absorbing device configured to receive the plurality of partial light signals, and that the control of the light emitting device to combine the plurality of partial signals includes the one or more processors being configured to control the light absorbing device as a function of the encoded sequence to control the combination of the partial light signals.

In Example 36, the LIDAR module of example 35 may optionally further include that the light absorbing device includes a plurality of segments, each segment being configured, in a first state, to absorb or redirect a partial light signal impinging onto that segment, and configured, in a second state, to transmit the partial light signal impinging onto that segment.

In Example 37, the LIDAR module of example 36 may optionally further include that the one or more processors are configured to control each segment of the plurality of segments to be in the respective first state or second state as a function of the encoded sequence of symbols.

In Example 38, the LIDAR module of example 36 or 37 may optionally further include that at least one segment is configured to be light-absorbing independently of its state.

In Example 39, the LIDAR module of any one of examples 36 to 38 may optionally further include that the one or more processors are configured to generate a gating signal representative of which segments to switch in the first state and which segments to switch in the second state, and that the one or more processors are configured to control the light absorbing device by using the gating signal.

In Example 40, the LIDAR module of any one of examples 36 to 39 may optionally further include that each segment of the plurality of segments has a same surface area as the other segments of the plurality of segments.

In Example 41, the LIDAR module of any one of examples 36 to 39 may optionally further include that at least a second segment of the plurality of segment has a second surface area greater than a first surface area of a first segment of the plurality of segments.

In Example 42, the LIDAR module of example 41 may optionally further include that the second surface area is at least two times greater than the first surface area.

In Example 43, the LIDAR module of any one of examples 36 to 42 may optionally further include that at least one segment has a rectangular shape, and/or that at least one segment has a circular shape, and/or that at least one segment has a ring shape.

In Example 44, the LIDAR module of any one of examples 36 to 43 may optionally further include that the plurality of segments include a number of segments in the range from 2 to 20, for example in the range from 4 to 16.

In Example 45, the LIDAR module of any one of examples 36 to 44 may optionally further include that the light absorbing device includes at least one of a liquid crystal device or a digital mirror device.

In Example 46, the LIDAR module of example 45 may optionally further include that the liquid crystal device includes one of a liquid crystal display or a liquid crystal polarization grating.

In Example 47, the LIDAR module of any one of examples 36 to 46 may optionally further include that the optical arrangement includes primary optics arranged optically upstream of the light absorbing device and configured to collect the light emitted by the light source.

In Example 48, the LIDAR module of any one of examples 36 to 47 may optionally further include that the optical arrangement includes secondary optics arranged optically downstream of the light absorbing device and configured to combine the partial light signals to provide the emitted light signal.

In Example 49, the LIDAR module of any one of examples 1 to 48 may optionally further include that the light emitting device includes a light source configured to emit the light signal, and a driving circuit configured to provide an electrical signal to the light source, and that a signal level of the emitted light signal is dependent on a signal level of the electrical signal provided to the light source.

In Example 50, the LIDAR module of example 49 may optionally further include that the electrical signal includes one of a current signal, a voltage signal, or a power signal.

In Example 51, the LIDAR module of example 50 may optionally further include that wherein the electrical signal is or includes one of a current pulse, a voltage pulse, or a power pulse.

In Example 52, the LIDAR module of any one of examples 49 to 51 may optionally further include that the driving circuit is configured such that the electrical signal is split into a plurality of partial electrical signals.

In Example 53, the LIDAR module of example 52 may optionally further include that the control of the light emitting device to combine the plurality of partial signals includes the one or more processors being configured to control the driving circuit to combine the plurality of partial electrical signals.

In Example 54, the LIDAR module of example 52 or 53 may optionally further include that the driving circuit includes an electrical energy source configured to generate an electrical signal, and a splitting circuit configured to split the electrical signal into the plurality of partial electrical signals. As examples, the electrical energy source may include at least one of a current source, a voltage source, or a power source.

In Example 55, the LIDAR module of example 54 may optionally further include that the splitting circuit is configured such that a first partial electrical signal and a second partial electrical signal of the plurality of partial electrical signals are in a first relationship with one another, and such that the second partial electrical signal and a third partial electrical signal of the plurality of partial electrical signals are in the first relationship with one another. As an example, the first relationship includes the first partial electrical signal having a first signal level two times less than a second signal level of the second partial electrical signal.

In Example 56, the LIDAR module of example 54 or 55 may optionally further include that the splitting circuit includes one or more transformers.

In Example 57, the LIDAR module of example 56 may optionally further include that at least one transformer of the one or more transformers has a winding ratio of 1:1, and/or at least one transformer of the one or more transformers has a winding ratio of 2:1:1.

In Example 58, the LIDAR module of any one of examples 54 to 57 may optionally further include that the splitting circuit includes one or more power splitters, each power splitter being associated with a respective partial electrical signal.

In Example 59, the LIDAR module of example 58 may optionally further include that each power splitter is associated with a respective adjustable phase and adjustable attenuation circuit configured to delay and/or attenuate the respective partial electrical signal.

In Example 60, the LIDAR module of any one of examples 54 to 59 may optionally further include that the splitting circuit includes a plurality of switches, each switch being configured to connect or disconnect an electrical path associated with one of the partial electrical signals, and that the one or more processors are configured to control the combination of the plurality of electrical signals by controlling the plurality of switches.

In Example 61, the LIDAR module of example 60 may optionally further include that the one or more processors are configured to generate a gating signal representative of which switches are to be activated to connect the respective electrical path, and that the one or more processors are configured to control the plurality of switches by using the gating signal.

In Example 62, the LIDAR module of any one of examples 49 to 61 may optionally further include that the driving circuit includes a plurality of electrical energy sources, each configured to generate a respective partial electrical signal.

In Example 63, the LIDAR module of example 62 may optionally further include that each electrical energy source is configured to provide the respective partial electrical signal having a signal level different from the other partial electrical signals provided by the other electrical energy sources.

In Example 64, the LIDAR module of example 63 may optionally further include that a first signal level associated with a first electrical energy source of the plurality of electrical energy sources and a second signal level associated with a second electrical energy source of the plurality of electrical energy sources are in a first relationship with one another, and that the second signal level associated with the second electrical energy source and a third signal level associated with a third electrical energy source of the plurality of electrical energy sources are in the first relationship with one another. As an example, the first relationship may include the first signal level being two times less than the second signal level.

In Example 65, the LIDAR module of any one of examples 62 to 64 may optionally further include that the plurality of electrical energy sources include at least one electrical energy storage element, and that the generation of the respective partial electrical signal includes a discharge of the electrical energy storage element.

In Example 66, the LIDAR module of example 65 may optionally further include that the at least one electrical energy storage element includes one of an inductor or a capacitor.

In Example 67, the LIDAR module of any one of examples 62 to 66 may optionally further include that the control of the light emitting device to combine the plurality of partial signals includes the one or more processors being configured to control the plurality of electrical energy sources to generate the respective partial electrical signal.

In Example 68, the LIDAR module of example 67 may optionally further include that the one or more processors are configured to generate a gating signal representative of which electrical energy sources to activate to emit the respective partial electrical signal, and that the one or more processors are configured to control the plurality of electrical energy sources by using the gating signal.

In Example 69, the LIDAR module of any one of examples 62 to 68 may optionally further include that each electrical energy source is associated with (e.g., connected with) a respective switch configured to connect or disconnect the associated electrical energy source to a respective electrical path.

In Example 70, the LIDAR module of example 69 may optionally further include that the one or more processors are configured to generate a gating signal representative of which switches to activate to connect the associated electrical energy source to the respective electrical path.

In Example 71, the LIDAR module of any one of examples 62 to 70 may optionally further include that the plurality of electrical energy sources are connected in series and/or in parallel with one another.

In Example 72, the LIDAR module of any one of examples 62 to 71 may optionally further include that the plurality of electrical energy sources include at least one of a current source, a voltage source, or a power source.

In Example 73, the LIDAR module of any one of examples 62 to 72 may optionally further include that the plurality of electrical energy sources include a plurality of electrical energy storage elements, and that the one or more processors are configured to control a discharge of a first part of the electrical energy storage elements during a first portion of the emitted light signal, and to control a discharge of a second part of the electrical energy storage elements during a second portion of the emitted light signal.

In Example 74, the LIDAR module of example 73 may optionally further include that the discharge of the first part of the electrical energy storage elements provides an electrical signal to the light source to emit a first light pulse or a first portion of a light pulse, and that the discharge of the second part of the electrical energy storage elements provides an electrical signal to the light source to emit a second light pulse or a second portion of the light pulse.

In Example 75, the LIDAR module of any one of examples 1 to 74 may optionally further include that the light emitting device includes a light source and a plurality of driving circuits, each driving circuit being configured to provide a respective electrical signal to the light source.

In Example 76, the LIDAR module of example 75 may optionally further include that at least one driving circuit is assigned to provide the respective electrical signal for a ranging operation associated with the emitted light signal.

In Example 77, the LIDAR module of any one of examples 1 to 76 may optionally further include that the sequence of symbols includes at least one error check symbol representative of error check information associated with the sequence. As an example, the error check symbol may include a parity symbol.

In Example 78, the LIDAR module of examples 75 and 77 may optionally further include that at least one driving circuit is assigned to provide the respective electrical signal for emitting the light signal including the error check symbol.

In Example 79, the LIDAR module of any one of examples 1 to 78 may optionally further include a photo detector configured to detect the emitted light signal.

In Example 80, the LIDAR module of example 79 may optionally further include that the photo detector is configured to provide the detected signal to the one or more processors, and that the one or more processors are configured to adjust the control of the light emitting device in accordance with the detected signal.

In Example 81, the LIDAR module of example 79 or 80 may optionally further include that the photo detector is configured to adjust a sensitivity level based on an expected signal level of the emitted light signal.

In Example 82, the LIDAR module of any one of examples 79 to 81 may optionally further include that the photo detector is configured to receive a trigger signal from the one or more processors, and is configured to be sensitive to incoming light for a predefined period of time after reception of the trigger signal. For example, the trigger signal may include a gating signal.

In Example 83, the LIDAR module of any one of examples 79 to 82 may optionally further include that the photo detector includes a wired or wireless communication channel with the one or more processors. In some aspects, the communication channel may be a unidirectional or a bidirectional communication channel.

In Example 84, the LIDAR module of any one of examples 1 to 83 may optionally further include that the one or more processors include at least one of: a microprocessor, a microcontroller, a discrete logic gate, a programmable logic, a field-programmable gate array (FPGA), and/or an application-specific integrated circuit (ASIC).

Example 85 is a method of emitting light in a LIDAR module, the method including: encoding a sequence of symbols, each symbol associated with a respective combination of a plurality of partial signals; and controlling the combination of the plurality of partial signals as a function of the encoded sequence of symbols to emit the light signal.

In Example 86, the method of example 85 may include one, or some, or all of the features of any one of example 1 to 84, where appropriate.

Example 87 is a LIDAR module including: a light emitting device configured to emit a light signal in accordance with a combination of a plurality of partial light signals; and one or more processors configured to: encode a sequence of symbols, each symbol associated with a respective combination of the plurality of partial light signals, and control the light emitting device to optically combine the plurality of partial light signals as a function of the encoded sequence of symbols to emit the light signal.

In Example 88, the LIDAR module of example 87 may include one, or some, or all of the features of any one of example 1 to 84, where appropriate.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

### LIST OF REFERENCE SIGNS

100a Light emitting device
100b Light emitting device
100c Light emitting device
102 DC source
104 Controllable resistor
106 Laser diode
108 Capacitor
108-1 First capacitor
108-2 Second capacitor
108-3 Third capacitor
110 Control circuit
112 Charging circuit
112-1 First charging circuit
112-2 Second charging circuit
112-3 Third charging circuit
114 Charging resistor
114-1 First charging resistor
114-2 Second charging resistor
114-3 Third charging resistor
116 MOSFET
118-1 First transistor
118-2 Second transistor
118-3 Third transistor
200 LIDAR module
202 Light emitting device
204 Light signal
206 One or more processors
208 Sequence of symbols
210 Light source
212 Driving circuit
300a Graph
300b Graph
300c Graph
300d Graph
300e Graph
302a Light signal
302b Light signal
304 Horizontal axis
306 Vertical axis
308a Light pulses
308b Light pulses
308a-1 First light pulse
308b-1 First light pulse
308a-2 Second light pulse
308b-2 Second light pulse
308a-3 Third light pulse
308b-3 Third light pulse
308a-4 Fourth light pulse
308a-n N-th light pulse
308b-n N-th light pulse
308e-1 First light pulse
308e-2 Second light pulse
308e-3 Third light pulse
308e-4 Fourth light pulse
310-1 First pulse portion
310-2 Second pulse portion
310-3 Third pulse portion
400 Light emitting device
402 Partial light sources
402-1 First partial light source
402-2 Second partial light source
402-3 Third partial light source
404 Partial light signal
404-1 First partial light signal
404-2 Second partial light signal
404-3 Third partial light signal
406 Light signal
408 Emitter optics arrangement
410 Driving circuit
410-1 First driving circuit
410-2 Second driving circuit
410-3 Third driving circuit
412-1 First laser diode
412-2 Second laser diode
412-3 Third laser diode
414 One or more processors
416 Gating signal
420c Graph
420d Graph
422c Light signal
422d Light signal
424 Horizontal axis
426 Vertical axis
428c Light pulses
428c-1 First light pulse
428c-2 Second light pulse
428c-3 Third light pulse
428c-4 Fourth light pulse
428c-5 Fifth light pulse
428c-6 Sixth light pulse
428d Light pulses
428d-1 First light pulse
428d-2 Second light pulse
430c-1 First graph
430d-1 First graph
430c-2 Second graph
430d-2 Second graph
430c-3 Third graph
430d-3 Third graph
432c-1 First gating signal
432d-1 First gating signal
432c-2 Second gating signal
432d-2 Second gating signal
432c-3 Third gating signal
432d-3 Third gating signal
434 Switches
434-1 First switch
434-2 Second switch
434-3 Third switch
436 Logic gates
436-1 First AND gates
436-2 Second AND gates
436-3 Third AND gates
500 Light emitting device
502 Light source
504 Laser diode
506 Driving circuit
508 Beam splitting device
510 Partial light signal(s)
512 One or more processors
514 Control signal
516 Light signal
518 Signal lines
518-0 Signal line
520 Optical arrangement
522 Primary optics
524 Light absorbing device
526 Secondary optics
530b Light absorbing device
530c Light absorbing device
530d Light absorbing device
530e Light absorbing device
530g Light absorbing device
530h Light absorbing device
530i Light absorbing device
532b Segments
532b-1 First segment
532b-2 Second segment
532b-3 Third segment
532b-4 Fourth segment
532c Segments
532c-1 First segment(s)
532c-2 Second segment(s)
532c-3 Third segment(s)
532c-4 Fourth segment(s)
532d Segments
532d-1 First segment
532d-2 Second segment
532d-3 Third segment
532e Segments
532e-1 First segment(s)
532e-2 Second segment(s)
532e-3 Third segment(s)
532e-4 Fourth segment
532g Segments
532g-0 Transparent segment
532g-1 First segment(s)
532g-2 Second segment(s)
532g-3 Third segment(s)
532g-4 Fourth segment
532h Segments
532h-0 Transparent segment
532h-1 First segment
532h-2 Second segment
532h-3 Third segment
532h-4 Fourth segment
532i Segments
532i-0 Transparent segment
532i-1 First segment(s)
532i-2 Second segment(s)
532i-3 Third segment(s)
532i-4 Fourth segment
534 Gating signal
600a Light emitting device
600b Light emitting device
600c Light emitting device
602a Light source
602b Light source
602c Light source
604a Driving circuit
604b Driving circuit
604c Driving circuit
606a One or more processors
606b One or more processors
606c One or more processors
608a Electrical energy source
608b Electrical energy source
608c Electrical energy source
610a Splitting circuit
610b Splitting circuit
610c Splitting circuit
612a One or more transformers
612b One or more transformers
614c One or more power splitters
616a Switches
616b Switches
616c Switches
618a Graph
620a Diode(s)
620b Diode
622c Dummy load
624c Adjustable phase and adjustable attenuation circuit
626c Power combiner
628a Signal lines
628b Signal lines
628c Signal lines
630a Gating signal line
630b Gating signal line
630c Gating signal line
700a Light emitting device
700b Light emitting device
700c Light emitting device
700d Light emitting device
700e Light emitting device
700f Light emitting device
700g Light emitting device
700h Light emitting device
702a Light source
702b Light source
702c Light source
702d Light source
702e Light source
702f Light source
702g Light source
702h Light source
704a Driving circuit
704b Driving circuit
704c Driving circuit
704d Driving circuit
704e Driving circuit
704f Driving circuit
704g Driving circuit
704h Driving circuit
706a Electrical energy source(s)
706b Electrical energy source(s)
706c Electrical energy source(s)
706d Electrical energy source(s)
706e Electrical energy source(s)
706f Electrical energy source(s)
706g Electrical energy source(s)
706h Electrical energy source(s)
708a One or more processors
708b One or more processors
708c One or more processors
708d One or more processors
708e One or more processors
708f One or more processors
708g One or more processors
708h One or more processors
710a Gating signal line
710b Gating signal line
710c Gating signal line
710d Gating signal line
710e Gating signal line
710f Gating signal line
710g Gating signal line
710h Gating signal line
712a Switches
712b Switches
712c Switches
712d Switches
712e Switches
712f Switches
712g Switches
712h Switches
714a Signal lines
714b Signal lines
714c Signal lines
714d Signal lines
714e Signal lines
714f Signal lines
714g Signal lines
714h Signal lines
716e Diode(s)
716f Diode(s)
718f Switch
720e Voltage source
720f Voltage source
720g Voltage source
720h Voltage source
722g Resistor(s)
722h Resistor(s)
724h Signal switch(es)
730i Time diagram
732i Light signal
734i Light pulse(s)
736j Residual gating signal
740k Time diagram
742k Light signal
744k-1 First light pulse
744k-2 Second light pulse
744k-3 Third light pulse
744k-4 Fourth light pulse
744k-5 Fifth light pulse
800a Light emitting device
802a Driving circuit
802e Driving circuit
802a-1 First driving circuit
802a-2 Second driving circuit
804a-1 One or more processors
804a-2 One or more processors
804e One or more processors
805a Voltage source
808e Pixel control
810b Timing diagram
810c Timing diagram
810d Timing diagram
810f Timing diagram
810g Timing diagram
810h Timing diagram
812b Light signal
812c Light signal
812d Light signal
812f Light signal
812g Light signal
812h Light signal
814b Light pulse(s)
814c Light pulse(s)
814d Light pulse(s)
814f Light pulse(s)
814g Light pulse(s)
814h Light pulse(s)
820f Timing diagram
900a Light emitting device
900b Light emitting device
900c Light emitting device
902a Driving circuit
902b Driving circuit
902c Driving circuit
904a One or more processors
904b One or more processors
904c One or more processors
906a Photo detector
906b Photo detector
906c Photo detector
908a Measured light level
910a Voltage source
910b Voltage source(s)
912a Control signal
912b Control signal
914b Delay element(s)
916b Delay signal(s)
918c External photo detector
920c External control circuit
1000a Laser diode drive circuit
1000b Light emitting device
1000c Light emitting device
1000d Light emitting device
1000e Light emitting device
1000f Light emitting device
1000g Light emitting device
1000h Light emitting device
1000i Light emitting device
1002a High-side driver(s)
1002b High-side driver(s)
1002c High-side driver(s)
1002d High-side driver(s)
1002g High-side driver(s)
1004a Field-effect transistor(s)
1004b Field-effect transistor(s)
1004c Field-effect transistor(s)
1004d Field-effect transistor(s)
1004g Field-effect transistor(s)
1006a AND gates
1008a Control circuit
1008d Control circuit
1008i Control circuit
1010a Pulse generation control circuit
1010g Pulse generation control circuit
1012a Output power control circuit
1014b Capacitor(s)
1014c Capacitor(s)
1014d Capacitor
1014h Capacitor
1016b Charging circuit(s)
1016c Charging circuit(s)
1018b Laser diode(s)
1018c Laser diode(s)
1018d Laser diode(s)
1020d Fast-switching power transistor
1020e Fast-switching power transistor
1020f Fast-switching power transistor
1022e Common current source
1022f Common current source
1022g Common current source
1024f Pixel control circuit
1026i Capacitor charge circuitry
1028i Delay element(s)
1030i Photo detector(s)
1100 Current source
1102 Inductor
1104 Capacitor
1106 Transistor
1108 Gate driver
1110 Diode
1112 Control circuit
1114 Current measuring circuit
1200 Fundamental pulse cell
1202 Transistor
1204 Capacitor
1206 Laser diode
1208 Photo detector
1210 Delay element
1212 Gate driver
1214 Capacitor charge circuit
1220 Light emitting device
1222 Control circuit
1230 Light emitting device
1232 Control circuit
1300 LIDAR emitter
1302 Integrated optoelectronic component
1304 Semiconductor die
1306 Die
1308 Integrated optoelectronic component
1310 Silicon substrate
1312 Die
1314 Integrated optoelectronic component
1316 Integrated optoelectronic component
1400 Optoelectronic component
1402 Optoelectronic component
1404 Optoelectronic component
1406 Optoelectronic component
1408 Optoelectronic component
1410 Optoelectronic component
1412 Optoelectronic component
1414 Optoelectronic component

What is claimed is:

1. A LIDAR module comprising:
a light emitting device configured to emit a light signal in accordance with a combination of a plurality of partial signals; and
one or more processors configured to:
encode a sequence of symbols, wherein each symbol of the sequence of symbols is associated with a respective combination of the plurality of partial signals, and
control the light emitting device to combine the plurality of partial signals as a function of the encoded sequence of symbols to emit the light signal,
wherein the combination of the plurality of partial signals comprises a subtractive combination of the plurality of partial signals.

2. The LIDAR module according to claim 1,
wherein the plurality of partial signals comprise a plurality of partial light signals, and
wherein the combination of the plurality of partial signals comprises an optical combination of the plurality of partial light signals.

3. The LIDAR module according to claim 1,
wherein the plurality of partial signals comprise a plurality of partial electrical signals, and
wherein the combination of the plurality of partial signals comprises an electrical combination of the plurality of partial electrical signals.

4. (canceled)

5. The LIDAR module according to claim 1,
wherein the emitted light signal comprises one or more light pulses, and
wherein each light pulse is associated with respective one or more symbols of the sequence of symbols.

6. The LIDAR module according to claim 5,
wherein at least one light pulse is associated with a respective one symbol of the sequence of symbols, and/or
wherein at least one light pulse is associated with a respective plurality of symbols of the sequence of symbols, and/or
wherein the one or more light pulses comprise a plurality of light pulses,
wherein a subset of the plurality of light pulses is associated with a respective one symbol of the sequence of symbols.

7. The LIDAR module according to claim 5,
wherein a first light pulse associated with one or more first symbols has a first signal level different from a second signal level of a second light pulse associated with one or more second symbols.

8. The LIDAR module according to claim 5,
wherein at least one light pulse comprises a plurality of pulse portions, each pulse portion having a respective signal level,
wherein the signal levels of the plurality of pulse portions are defined by the one or more symbols associated with the at least one light pulse.

9. (canceled)

10. The LIDAR module according to claim 1,
wherein the light emitting device comprises a plurality of partial light sources, each partial light source being configured to emit a respective partial light signal.

11. The LIDAR module according to claim 10,
wherein each partial light source of the plurality of partial light sources is configured to emit the respective partial light signal at a signal level different from the signal level of the other partial light signals emitted by the other partial light sources.

12. (canceled)

13. The LIDAR module according to claim 10,
wherein the light emitting device further comprises an emitter optics arrangement configured to receive the partial light signals, and to combine together the partial light signals to emit the light signal.

14. (canceled)

15. A method of emitting light in a LIDAR module, the method comprising:
encoding a sequence of symbols, each symbol being associated with a respective combination of a plurality of partial signals; and
controlling the combination of the plurality of partial signals as a function of the encoded sequence of symbols to emit the light signal,
wherein the combination of the plurality of partial signals comprises one of an additive combination of the plurality of partial signals, or a subtractive combination of the plurality of partial signals.

16. A LIDAR module comprising:
a light emitting device configured to emit a light signal in accordance with a combination of a plurality of partial signals; and
one or more processors configured to:
encode a sequence of symbols, wherein each symbol of the sequence of symbols is associated with a respective combination of the plurality of partial signals, and
control the light emitting device to combine the plurality of partial signals as a function of the encoded sequence of symbols to emit the light signal, wherein the combination of the plurality of partial signals comprises an additive combination of the plurality of partial signals.

17. The LIDAR module according to claim 16,
wherein the emitted light signal comprises one or more light pulses, and
wherein each light pulse is associated with respective one or more symbols of the sequence of symbols,
wherein at least one light pulse comprises a first pulse portion having a first energy and a second pulse portion having a second energy,
wherein the first energy is complementary to the second energy with respect to a total energy of the emitted light signal.

18. The LIDAR module of claim 16,
wherein the light emitting device comprises a plurality of partial light sources, each partial light source being configured to emit a respective partial light signal.

19. The LIDAR module of claim 18,
wherein the one or more processors are configured to generate a gating signal, the gating signal being representative of which partial light sources of the plurality of partial light sources to activate as a function of the encoded sequence of symbols, and
wherein the one or more processors are configured to control the plurality of partial light sources by using the gating signal.

20. The LIDAR module of claim 19,
wherein the one or more processors are configured to generate the gating signal by using a same clock signal as the clock signal determining a repetition rate of the light emitting device.

21. The LIDAR module of claim 19,
wherein each partial light source is coupled to a respective switch, and that the gating signal includes a respective instruction for each switch to connect or disconnect the associated partial light source from a power supply.

22. The LIDAR module of claim 18,
wherein each partial light source of the plurality of partial light sources is configured to emit the respective partial light signal at a signal level different from the signal level of the other partial light signals emitted by the other partial light sources, and at least one partial light source of the plurality of partial light sources is configured to emit twice the luminous flux of at least one other partial light source of the plurality of partial light sources.

23. The LIDAR module of claim 1,
wherein the light emitting device comprises a light source configured to emit light, and that a beam splitting device configured to split the light emitted by the light source into a plurality of partial light signals,
wherein the light emitting device further comprises an optical arrangement configured to absorb or redirect one or more of the plurality of partial light signals as a function of the encoded sequence.

24. The LIDAR module of claim 23,
wherein the optical arrangement comprises a controllable light absorbing device configured to receive the plurality of partial light signals, and that the control of the light emitting device to combine the plurality of partial signals includes the one or more processors being configured to control the light absorbing device as a function of the encoded sequence to control the combination of the partial light signals.
